(19) United States
(12) Patent Application Publication
(10) Pub. No.: US 2025/0258070 A1
(43) Pub. Date: Aug. 14, 2025

(54) LIQUID PROCESSING SYSTEM AND RELATED METHODS

(71) Applicant: GRAIL, Inc., Menlo Park, CA (US)

(72) Inventors: Cody WILLIAMS, Sunnyvale, CA (US); Derek JENKINS, San Francisco, CA (US); Nathan ELDRIDGE, Ashland, OR (US); Kent CHASE, Madison, WI (US); Lindsay FELDT, Madison, WI (US); John FINGERSON, Spring Green, WI (US)

(73) Assignee: GRAIL, Inc., Menlo Park, CA (US)

(21) Appl. No.: 19/046,942

(22) Filed: Feb. 6, 2025

Related U.S. Application Data
(60) Provisional application No. 63/551,827, filed on Feb. 9, 2024.

(51) Int. Cl. G01N 1/40; G01N 21/25; G01N 35/00

(52) U.S. Cl. CPC G01N 1/4077; G01N 21/251; G01N 35/00732

(57) ABSTRACT

In an automated liquid processing system, a first centrifuge performs a centrifuging cycle on a plurality of first inserts, a pairing robot to places first tubes, including pairs of first tubes, from the first inserts on a pairing platform, an excising station excises labels on the first tubes, captures an image of the excised first tubes, and determines, using an image analysis process, a height of a portion of the liquid within the first tubes. A first liquid handling station combines a portion of the liquid within first tubes, including pairs of first tubes, into a second tube. A second centrifuge performs a second centrifuging cycle, and a second liquid handling station aspirates liquid from the second tube and dispenses the liquid into an output container.

### CROSS REFERENCE TO RELATED APPLICATION

This application claims priority to U.S. Provisional Application No. 63/551,827, filed on Feb. 9, 2024, which is hereby incorporated by reference in its entirety.

### TECHNICAL FIELD OF THE INVENTION

This invention relates to an automated liquid processing system and related control methods and, more specifically, relates to an automated system for isolating subcomponents of liquids from liquid samples for downstream analysis and related control methods.

### BACKGROUND OF THE INVENTION

Isolating subcomponents of liquids, such as plasma from blood samples, can be a relatively time consuming and complicated process. When isolating plasma from blood samples, for example, large volumes of blood from patients are needed to produce a sufficient volume of isolated plasma for analysis. The problems are magnified when isolating specific components from the blood samples, such as extracting cell-free DNA (cfDNA) for analysis. Current systems provide plasma volumes on the order of hundreds of micrometers, which is a relatively small amount that may not be sufficient to also provide for a back-up volume of plasma, which may be needed due to failure of tubes or samples or to perform subsequent analysis. In addition, current systems are also manual or require regular manual intervention, which is labor intensive, time consuming, and generally inefficient. Further, current systems require relatively long processing times, on the order of days, with processes comprising hundreds of steps with limited throughput. For example, current systems may only be able to process a single tube at one time, before plasma is ready for analysis, which typically requires at least an additional 24 hours. This may make large-scale or population-scale analysis impossible. Still further, current systems centrifuge blood samples to separate red blood cells from plasma, but a buffy coat layer of blood may remain in between the red blood cells and plasma, which can reduce the usable volume of plasma obtained from the sample.

The present invention is directed to overcoming one or more of these above-referenced challenges with processing fluid samples.

### SUMMARY OF THE EMBODIMENTS

In one aspect, the present disclosure is directed to a method of processing liquid samples, the method comprising: receiving a plurality of liquid samples, each liquid sample being contained within a sample collection tube, and wherein the plurality of liquid samples include either or both of (i) two liquid samples from the same individual, or (ii) one liquid sample from an individual; centrifuging the plurality of liquid samples a first time to separate out a subcomponent of interest; imaging the plurality of liquid samples to determine a height of the subcomponent of interest in each sample collection tube; aspirating out the subcomponent of interest from the plurality of sample collection tubes and dispensing the aspirated subcomponent of interest into a plurality of processing tubes, wherein all of the aspirated subcomponent of interest for the same individual is deposited into one processing tube, such that the subcomponent of interest from the two liquid samples from the same individual are deposited into one processing tube, and the subcomponent of interest from the one liquid sample from the individual is deposited into one processing tube; centrifuging the plurality of liquid samples in the plurality of processing tubes a second time to further separate out the subcomponent of interest; and outputting the separated subcomponent of interest from each of the plurality of liquid samples in the plurality of processing tubes into a plurality of output containers.

In another aspect, the present disclosure is direct to an input module of an automated liquid processing system, the input module comprising: a scanner configured to scan and output identifying information of an insert, of a plurality of inserts, to be placed in the input module; a plurality of conveyor channels each extending from an input end to an output end and configured to receive one or more of the plurality of inserts; one or more conveyor belts, provided below the plurality of conveyor channels, and configured to convey the plurality of inserts from the input end to the output end of the plurality of conveyor channels; a plurality of sensors, each of the plurality of sensors being located at a region of the output end of each of the one or more conveyor channels, the plurality of sensors being configured to detect a presence of an insert, of the one or more inserts, at the output end of the one or more conveyor channels; and a controller including at least one memory that stores instructions for a control method of the input module, and at least one processor that executes the instructions to: receive the identifying information of a scanned insert, of the plurality of inserts, from the scanner; store the received identifying information in the at least one memory; determine, based on the received identifying information, whether the scanned insert is compatible with a centrifuge into which the insert is to be placed; receive, from a first sensor of the plurality of sensors, a notification that an insert, of the plurality of inserts, is detected at the output end of a first conveyor channel, of the plurality of conveyor channels; and output a notification, upon receiving the notification from the first sensor of the plurality of sensors that the insert is detected at the output end of the conveyor channel, that the detected insert is ready for transfer.

In still another aspect, the present disclosure is directed to a centrifuging module of an automated liquid processing system, the centrifuging module comprising: at least one scanner configured to scan and output identifying information of an insert, of a plurality of inserts; a plurality of centrifuges, each centrifuge configured to receive a predetermined number of inserts, of the plurality of inserts, and configured to perform a centrifuging cycle; one or more conveyor channels configured to receive and convey the plurality of inserts to an output end of the one or more conveyor channels; a gantry robot configured to pick up an insert, of the plurality of inserts, hold the insert in front of the at least one scanner, place the insert into and pick the insert up from the plurality of centrifuges, and place the insert onto one of the one or more conveyor channels; and a controller, including at least one memory that stores instructions for a control method of the centrifuging module, and at least one processor configured to execute the instructions to: instruct the gantry robot to pick up the insert, of the plurality of inserts, and to hold the insert in front of the at least one scanner; receive, from the at least one scanner, the identifying information of the scanned insert; instruct the gantry robot to place the insert into a centrifuge, of the plurality of centrifuges; instruct the centrifuge, of the plurality of centrifuges, to perform a centrifuging cycle; and upon completion of the centrifuging cycle, instruct the gantry robot to retrieve inserts, of the plurality of inserts, from the centrifuge and place the inserts onto one of the one or more conveyor channels.

In yet another aspect, the present disclosure is directed to a liquid handling module of an automated liquid processing system, the liquid handling module comprising: a pairing station including: a pairing robot configured to pick up a plurality of first tubes and to place the plurality of first tubes, in pairs of first tubes or as single first tubes; a pairing scanner configured to scan the plurality of first tubes; and at least one pairing platform having a plurality of pairing platform slots configured to receive the plurality of first tubes; an excising station configured to excise portions of one or more labels on outer surfaces of the plurality of first tubes; an imaging station configured to capture images of the plurality of first tubes following excision of the portions of the one or more labels; a liquid handling station configured to aspirate at least a portion of liquid within at least each pair of first tubes, of the plurality of first tubes, and to dispense the aspirated portion of the liquid to a second tube, of a plurality of second tubes; and a controller having at least one memory that stores instructions for control of the liquid handling module, and at least one processor configured to execute the instructions to: instruct the pairing robot to pick up the plurality of first tubes and to hold the first tubes in front of the pairing scanner; receive, from the pairing scanner, identifying information of each scanned first tube, of the plurality of first tubes picked up by the pairing robot; determine, based on the received identifying information of each scanned first tube, pairs of first tubes and single first tubes; instruct the pairing robot to place the pairs of first tubes and the single first tubes on a pairing platform, with first tubes of a pair of first tubes in adjacent slots of the plurality of slots on the pairing platform and single first tubes being placed next to an empty adjacent slot of the plurality of slots on the pairing platform; instruct the excising station to perform an excising process by which the portions of one or more labels on outer surfaces of the plurality of first tubes are removed; instruct the imaging station to perform an imaging process in which an image of one or more first tubes, of the plurality of first tubes, is captured; receive the captured image and perform an image analysis process, in which the captured image of the one or more first tubes is analyzed to determine at least a height of the portion of the liquid within the one or more first tubes; and instruct the liquid handling station to perform a liquid handling process, in which portions of the liquid from within pairs of the one or more first tubes are aspirated from the pairs of first tubes and dispensed into a same second tube, of the plurality of second tubes, so as to combine the portions of liquid from pairs of first tubes into the same second tube.

In another aspect, the present disclosure is directed to a centrifuging module of an automated liquid processing system, the centrifuging module comprising: at least one scanner configured to scan and output identifying information of an insert, of a plurality of inserts; a plurality of centrifuges, each centrifuge configured to receive a predetermined number of inserts, of the plurality of inserts, and configured to perform a centrifuging cycle; a tube transfer robot configured to pick up and place a plurality of tubes into an insert, of the plurality of inserts; a gantry robot configured to pick up an insert, of the plurality of inserts, hold the insert in front of the at least one scanner, and place the insert into a centrifuge, of the plurality of centrifuges; a conveyor system configured to convey the plurality of inserts within the centrifuging module; and a controller, including at least one memory that stores instructions for a control method of the centrifuging module, and at least one processor configured to execute the instructions to: receive, from the at least one scanner, identifying information of an insert, of the plurality of inserts; store the received identifying information; instruct the tube transfer robot to pick and up and place tubes, of the plurality of tubes, into an insert, of the plurality of inserts; instruct the gantry robot to pick up an insert, of the plurality of inserts, that is filled with tubes, and to place the filled insert into a centrifuge, of the plurality of centrifuges; instruct a centrifuge, of the plurality of centrifuges, to perform a centrifuging cycle; and upon completion of a centrifuging cycle of a centrifuge, instruct the gantry robot to retrieve inserts, of the plurality of inserts, from the centrifuge and place the inserts onto the conveyor system.

In still another aspect, the present disclosure is directed to a batching module of an automated liquid processing system, the batching module comprising: a scanner configured to scan and output identifying information of a tube, of a plurality of tubes; a tube transfer robot configured to pick up a tube, of the plurality of tubes, and hold it in front of the scanner; a liquid handling station including: a turntable having a plurality of portions, each portion including a plurality of tube slots, and each portion being configured to rotate through (a) a loading position, in which a plurality of tubes are placed into the plurality of tube slots, (b) a liquid handling position, in which liquid within the tubes is aspirated, and (c) a disposal position, in which the tubes are disposed from the turntable, wherein the tube transfer robot is further configured to place the plurality of tubes on the turntable; a liquid handling spanner configured to aspirate liquid within at least one tube, of a plurality of tubes, and to dispense the liquid into one or more output containers, the liquid handling spanner having: a plurality of aspirator tip mounting portions on which a plurality of aspirator tips are configured to be mounted; a plurality of flowmeters configured to measure a flow of liquid into each aspirator tip mounted to the plurality of aspirator tip mounting portions; and a connector configured to connect to a suction source; a liquid dispensing platform on which at least one output container, of a plurality of output containers, is loaded for receiving liquid from the plurality of aspirator tips; and a controller having at least one memory that stores instructions for control of the batching module, and at least one processor configured to execute the instructions to: receive identifying information of a scanned tube, of the plurality of tubes; store the received identifying information to register or track the tube as the tube enters the batching module; and instruct the liquid handling station to perform a liquid handling process including: instruct the liquid handling spanner to move to a position over the plurality of tubes in the turntable; instruct the liquid handling spanner to perform a suction process to aspirate at least a portion of the liquid within the plurality of tubes and to hold the aspirated portion of the liquid therein; instruct the liquid handling spanner to move to a position over the output container on the liquid dispensing platform; and instruct the liquid handling spanner to dispense the aspirated portion of the liquid into the at least one output container.

In yet another aspect, the present disclosure is directed to an automated liquid processing system comprising: a first scanner configured to scan and output identifying information of a first insert, of a plurality of first inserts to be placed in the automated liquid processing system; one or more first conveyor channels configured to receive and convey one or more of the plurality of first inserts from an input end to an output end of the one or more first conveyor channels; one or more first conveyor channel output sensors, at the output end of each of the one or more first conveyor channels, configured to output a notification when a first insert is detected at the output end of the one or more first conveyor channels; at least one second scanner configured to scan and output identifying information of a first insert, of the plurality of first inserts transferred from the output ends of the one or more first conveyor channels; a plurality of first centrifuges, each first centrifuge of the plurality of first centrifuges configured to receive a predetermined number of first inserts, of the plurality of first inserts, and configured to perform a first centrifuging cycle; one or more second conveyor channels configured to receive and convey the plurality of first inserts to an output end of the one or more second conveyor channels; one or more second conveyor channel output sensors, at the output end of each of the one or more second conveyor channels, configured to output a notification when a first insert is detected at the output end of the one or more second conveyor channels; a first gantry robot configured to pick up a first insert, of the plurality of first inserts, hold the first insert in front of the at least one second scanner, place the first insert into and pick the first insert up from one of the plurality of first centrifuges, and place the first insert onto the one or more second conveyor channels; a pairing station including: a pairing robot configured to pick up a plurality of first tubes from a first insert, of the plurality of first inserts, at the output end of the one or more second conveyor channels, and to place the plurality of first tubes, in pairs of first tubes or as single first tubes, and at least one pairing platform having a plurality of pairing platform slots configured to receive the plurality of first tubes, and a pairing scanner configured to scan and output identifying information of the plurality of first tubes picked up by the pairing robot, prior to placement of the plurality of first tubes on the at least one pairing platform; an excising station configured to excise at least portions of labels on outer surfaces of the plurality of first tubes; an imaging station configured to capture images of the plurality of first tubes; a first liquid handling station configured to aspirate a portion of a liquid within at least each pair of first tubes, of the plurality of first tubes, and to dispense the aspirated portion of the liquid to a second tube, of a plurality of second tubes, so as to combine the portions of liquid within pairs of first tubes in the same second tube; at least one third scanner configured to scan and output identifying information of a second insert, of a plurality of second inserts; a plurality of second centrifuges, each second centrifuge configured to receive a predetermined number of second inserts, of the plurality of second inserts, and configured to perform a centrifuging cycle; a first tube transfer robot configured to pick up and place the plurality of second tubes into a second insert, of the plurality of second inserts; a second gantry robot configured to pick up a second insert, of the plurality of second inserts, hold the second insert in front of the at least one third scanner, and place the second insert into a second centrifuge, of the plurality of second centrifuges; a conveyor system configured to receive the plurality of second inserts from the second gantry robot and to convey the second inserts in a loop, between a loading position, an insert pick up position, an insert placing position, and an unloading position; a fourth scanner configured to scan and output identifying information of a second tube, of the plurality of second tubes; a second tube transfer robot configured to pick up a second tube, of the plurality of second tubes, from a second insert in the unloading position of the conveyor system, and hold it in front of the fourth scanner; and a second liquid handling station configured to aspirate a portion of a liquid within a second tube, of the plurality of second tubes, and to dispense the aspirated portion of the liquid to an output container, of a plurality of output containers.

In another aspect, the present disclosure is directed to a method for controlling an input module of an automated liquid processing system, the method comprising: receiving, from a scanner, identifying information of a scanned insert, of a plurality of inserts, to be input into the automated liquid processing system; storing the received identifying information in at least one memory; determining, based on the received identifying information, whether the scanned insert is compatible with a centrifuge of the automated liquid processing system into which the insert is to be placed; receiving, from an output sensor of one or more output sensors located at an end region of one or more conveyor channels, which are configured to carry the plurality of inserts input into the automated liquid processing system, a notification that an insert is detected in an output end of a conveyor channel, of one or more conveyor channels; and outputting a notification, upon receiving the notification from the output sensor that the insert is detected at the output end of the conveyor channel, that the insert is ready for transfer.

In still another aspect, the present disclosure is directed to a controller of an input module of an automated liquid processing system, the controller including at least one memory that stores instructions for a control method of the automated liquid processing system, and at least one processor that executes the instructions to: receive, from a scanner of the input module, identifying information of a scanned insert, of a plurality of inserts, to be input into the automated liquid processing system; store the received identifying information in the at least one memory; determine, based on the received identifying information, whether the scanned insert is compatible with a centrifuge of the automated liquid processing system into which the insert is to be placed; receive, from an output sensor of one or more output sensors located at an end region of one or more conveyor channels of the input module, which are configured to carry the plurality of inserts input into the automated liquid processing system, a notification that an insert is detected in an output end of a conveyor channel, of one or more conveyor channels; and output a notification, upon receiving the notification from the output sensor that the insert is detected at the output end of the conveyor channel, that the insert is ready for transfer.

In yet another aspect, the present disclosure is directed to a method for controlling a centrifuging module of an automated liquid processing system, the method comprising: instructing a gantry robot to pick up an insert, of a plurality of inserts, and to hold the insert in front of at least one scanner; receiving, from the at least one scanner, identifying information of a scanned insert; instructing the gantry robot to place the insert into a centrifuge, of a plurality of centrifuges; instructing a centrifuge, of the plurality of centrifuges, to perform a centrifuging cycle; and upon completion of the centrifuging cycle of the centrifuge, instructing the gantry robot to retrieve inserts, of the plurality of inserts, from the centrifuge and place the inserts onto one or more conveyor channels.

In another aspect, the present disclosure is directed to a controller of a centrifuging module of an automated liquid processing system, the controller including at least one memory that stores instructions for a control method of the automated liquid processing system, and at least one processor that executes the instructions to: instruct a gantry robot of the centrifuging module to pick up an insert, of a plurality of inserts, and to hold the insert in front of at least one scanner of the centrifuging module; receive, from the at least one scanner, identifying information of a scanned insert; instruct the gantry robot to place the insert into a centrifuge, of a plurality of centrifuges of the centrifuging module; instruct a centrifuge, of the plurality of centrifuges, to perform a centrifuging cycle; and upon completion of the centrifuging cycle of the centrifuge, instruct the gantry robot to retrieve inserts, of the plurality of inserts, from the centrifuge and place the inserts onto one or more conveyor channels.

In still another aspect, the present disclosure is directed to a method for controlling a liquid handling module of an automated liquid processing system, the method comprising: instructing a pairing robot of a pairing station of the liquid handling module to pick up a plurality of first tubes and to hold each first tube in front of a pairing scanner of the pairing station; receiving, from the pairing scanner, identifying information of each scanned first tube, of the plurality of first tubes picked up by the pairing robot; determining, based on the received identifying information of each scanned first tube, pairs of first tubes and single first tubes; performing, using an excising station of the liquid handling module, an excising process by which at least portions of labels on the plurality of first tubes are excised; performing, using an imaging station of the liquid handling module, an imaging process in which an image of one or more first tubes, of the plurality of first tubes, is captured; performing an image analysis process, in which the captured image of the one or more first tubes is analyzed to determine at least a height of a portion of the liquid within the one or more first tubes; and performing, using a liquid handling station of the liquid handling module, a liquid handling process, in which the portion of the liquid within the one or more first tubes is aspirated from a pair of first tubes or from a single first tube, and is dispensed into a second tube, of a plurality of second tubes, so as to combine the portions of liquid from pairs of first tubes into the same second tube.

In yet another aspect, the present disclosure is directed to a controller of a liquid handling module of an automated liquid processing system, the controller including at least one memory that stores instructions for a control method of the automated liquid processing system, and at least one processor that executes the instructions to: instruct a pairing robot of a pairing station of the liquid handling module to pick up a plurality of first tubes and to hold each first tube in front of a pairing scanner of the pairing station; receive, from the pairing scanner, identifying information of each scanned first tube, of the plurality of first tubes picked up by the pairing robot; determine, based on the received identifying information of each scanned first tube, pairs of first tubes and single first tubes; perform, using an excising station of the liquid handling module, an excising process by which at least portions of labels on the plurality of first tubes are excised; perform, using an imaging station of the liquid handling module, an imaging process in which an image of one or more first tubes, of the plurality of first tubes, is captured; perform an image analysis process, in which the captured image of the one or more first tubes is analyzed to determine at least a height of a portion of the liquid within the one or more first tubes; and perform, using a liquid handling station of the liquid handling module, a liquid handling process, in which the portion of the liquid within the one or more first tubes is aspirated from a pair of first tubes or from a single first tube, and is dispensed into a second tube, of a plurality of second tubes, so as to combine the portions of liquid from pairs of first tubes into the same second tube.

In another aspect, the present disclosure is directed to a method for controlling a centrifuging module of an automated liquid processing system, method comprising: receiving, from at least one scanner of the centrifuging module, identifying information of an insert, of a plurality of inserts; storing the received identifying information; instructing a tube transfer robot of the centrifuging module to pick and up and place tubes, of a plurality of tubes, into an insert, of the plurality of inserts; instructing a gantry robot of the centrifuging module to pick up an insert, of the plurality of inserts, that is filled with tubes, and to place the filled insert into a centrifuge, of a plurality of centrifuges; instructing the centrifuge, of the plurality of centrifuges, to perform a centrifuging cycle; and upon completion of the centrifuging cycle of the centrifuge, instructing the gantry robot to retrieve inserts, of the plurality of inserts, from the centrifuge and place the inserts onto a conveyor system of the centrifuging module.

In still another aspect, the present disclosure is directed to a controller of a centrifuging module of an automated liquid processing system, the controller including at least one memory that stores instructions for a control method of the automated liquid processing system, and at least one processor that executes the instructions to: receive, from at least one scanner of the centrifuging module, identifying information of an insert, of a plurality of inserts; store the received identifying information in the at least one memory; instruct a tube transfer robot of the centrifuging module to pick and up and place tubes, of a plurality of tubes, into an insert, of the plurality of inserts; instruct a gantry robot of the centrifuging module to pick up an insert, of the plurality of inserts, that is filled with tubes, and to place the filled insert into a centrifuge, of a plurality of centrifuges; instruct the centrifuge, of the plurality of centrifuges, to perform a centrifuging cycle; and upon completion of the centrifuging cycle of the centrifuge, instruct the gantry robot to retrieve inserts, of the plurality of inserts, from the centrifuge and place the inserts onto a conveyor system of the centrifuging module.

In yet another aspect, the present disclosure is directed to a method for controlling a batching module of an automated liquid processing system, the method comprising: receiving, from a scanner of the batching module, identifying information of each of a plurality of tubes; storing the received identifying information to register or track the plurality of tubes as each tube enters the batching module; and instructing a liquid handling station of the batching module to perform a liquid handling process including: instructing a liquid handling spanner of the liquid handling station to move to a position over the plurality of tubes placed in a turntable of the liquid handling station; instructing the liquid handling spanner to aspirate at least a portion of the liquid within the plurality of tubes and to hold the aspirated portion of the liquid therein; instructing the liquid handling spanner to move to a position over at least one output container on a liquid dispensing platform of the batching module; and instructing the liquid handling spanner to dispense the liquid into the at least one output container.

In another aspect, the present disclosure is directed to a controller of a batching module of an automated liquid processing system, the controller including at least one memory that stores instructions for a control method of the automated liquid processing system, and at least one processor that executes the instructions to: receive, from a scanner of the batching module, identifying information of each of a plurality of tubes; store, in the at least one memory, the received identifying information to register or track the plurality of tubes as each tube enters the batching module; and instruct a liquid handling station of the batching module to perform a liquid handling process including: instructing a liquid handling spanner of the liquid handling station to move to a position over the plurality of tubes placed in a turntable of the liquid handling station; instructing the liquid handling spanner to aspirate at least a portion of the liquid within the plurality of tubes and to hold the aspirated portion of the liquid therein; instructing the liquid handling spanner to move to a position over at least one output container on a liquid dispensing platform of the batching module; and instructing the liquid handling spanner to dispense the liquid into the at least one output container.

In still another aspect, the present disclosure is directed to a method for controlling an automated liquid processing system, the method comprising: receiving identifying information of a first insert, of a plurality of first inserts to be input into the automated liquid processing system, from a first scanner; storing the received identifying information of a scanned first insert in at least one memory; determining, based on the received identifying information of the scanned first insert, whether the scanned first insert is compatible with a first centrifuge, of a plurality of first centrifuges of the automated liquid processing system, into which the first insert is to be placed; receiving, from a first conveyor channel output sensor, of one or more first conveyor channel output sensors of the automated liquid processing system, a notification that a first insert, of the plurality of first inserts, is detected in an output end of a first conveyor channel, of one or more first conveyor channels of the automated liquid processing system; instructing, upon receiving the notification from the first conveyor channel output sensor that the first insert is detected at the output end of the one or more first conveyor channels, a first gantry robot of the automated liquid processing system to pick up a first insert, of the plurality of first inserts, and to hold the first insert in front of at least one second scanner; receiving, from the at least one second scanner, identifying information of the scanned first insert; storing the received identifying information of the scanned first insert in the at least one memory; instructing the first gantry robot to place the scanned first insert into a first centrifuge, of the plurality of first centrifuges; instructing a first centrifuge, of the plurality of first centrifuges, to perform a centrifuging cycle; upon completion of the centrifuging cycle of the first centrifuge, instructing the first gantry robot to retrieve the first inserts, of the plurality of first inserts, from the first centrifuge and place the first inserts onto one or more second conveyor channels of the automated liquid processing system; instructing, upon receiving the notification from a second conveyor channel output sensor that a first insert is detected at the output end of the one or more second conveyor channels, a pairing robot of the automated liquid processing system to pick up a plurality of first tubes from the first insert at the output end of the one or more second conveyor channels, and to hold the first insert in front of a pairing scanner of the automated liquid processing system; receiving, from the pairing scanner, identifying information of each scanned first tube, of the plurality of first tubes picked up by the pairing robot; determining, based on the received identifying information of each scanned first tube, pairs of first tubes and single first tubes; placing the pairs of tubes and the single first tubes on a pairing platform of the automated liquid processing system, with first tubes of a pair of first tubes in adjacent slots of the plurality of slots on the pairing platform and single first tubes being placed next to an empty adjacent slot of the plurality of slots on the pairing platform; performing an excising process by which portions of labels on the plurality of first tubes from the pairing platform are excised; performing an imaging process in which an image of one or more first tubes, of the plurality of first tubes, is captured; performing an image analysis process, in which the captured image of the one or more first tubes is analyzed to determine at least a height of a portion of the liquid within the one or more first tubes; performing a first liquid handling process, in which the portion of the liquid within the one or more first tubes is aspirated from a pair of first tubes or from a single first tube, and is dispensed into a second tube, of a plurality of second tubes, so as to combine the portions of liquid from pairs of first tubes into the same second tube; receiving, from at least one third scanner of the automated liquid processing system, identifying information of a second insert, of a plurality of second inserts; storing the received identifying information of the scanned second insert in the at least one memory; instructing a second tube transfer robot of the automated liquid processing system to pick up and place second tubes, of the plurality of second tubes, into a second insert, of the plurality of second inserts; instructing a second gantry robot of the automated liquid processing system to pick up a second insert, of the plurality of second inserts, that is filled with second tubes, and to place the filled second insert into a second centrifuge, of a plurality of second centrifuges of the automated liquid processing system; instructing a second centrifuge, of the plurality of second centrifuges, to perform a second centrifuging cycle; and upon completion of the second centrifuging cycle of the second centrifuge, instructing the second gantry robot to retrieve second inserts, of the plurality of second inserts, from the second centrifuge and place the second inserts onto a conveyor system of the automated liquid processing system; receiving identifying information of a scanned second tube from a fourth scanner of the automated liquid processing system; storing the received identifying information of the scanned second tube in the at least one memory; and performing a second liquid handling process, in which the portion of the liquid within the second tubes is aspirated from the second tubes, and is dispensed into a plurality of output containers.

In yet another aspect, the present disclosure is directed to a controller of an automated liquid processing system, the controller including at least one memory that stores instructions for a control method of the automated liquid processing system, and at least one processor that executes the instructions to: receive identifying information of a first insert, of a plurality of first inserts to be input into the automated liquid processing system, from a first scanner; store the received identifying information of a scanned first insert in at least one memory; determine, based on the received identifying information of the scanned first insert, whether the scanned first insert is compatible with a first centrifuge, of a plurality of first centrifuges of the automated liquid processing system, into which the first insert is to be placed; receive, from a first conveyor channel output sensor, of one or more first conveyor channel output sensors of the automated liquid processing system, a notification that a first insert, of the plurality of first inserts, is detected in an output end of a first conveyor channel, of one or more first conveyor channels of the automated liquid processing system; instruct, upon receiving the notification from the first conveyor channel output sensor that the first insert is detected at the output end of the one or more first conveyor channels, a first gantry robot of the automated liquid processing system to pick up a first insert, of the plurality of first inserts, and to hold the first insert in front of at least one second scanner; receive, from the at least one second scanner, identifying information of the scanned first insert; store the received identifying information of the scanned first insert in the at least one memory; instruct the first gantry robot to place the scanned first insert into a first centrifuge, of the plurality of first centrifuges; instruct a first centrifuge, of the plurality of first centrifuges, to perform a centrifuging cycle; upon completion of the centrifuging cycle of the first centrifuge, instruct the first gantry robot to retrieve the first inserts, of the plurality of first inserts, from the first centrifuge and place the first inserts onto one or more second conveyor channels of the automated liquid processing system; instruct, upon receiving the notification from a second conveyor channel output sensor that a first insert is detected at the output end of the one or more second conveyor channels, a pairing robot of the automated liquid processing system to pick up a plurality of first tubes from the first insert at the output end of the one or more second conveyor channels, and to hold the first insert in front of a pairing scanner of the automated liquid processing system; receive, from the pairing scanner, identifying information of each scanned first tube, of the plurality of first tubes picked up by the pairing robot; determine, based on the received identifying information of each scanned first tube, pairs of first tubes and single first tubes; place the pairs of tubes and the single first tubes on a pairing platform of the automated liquid processing system, with first tubes of a pair of first tubes in adjacent slots of the plurality of slots on the pairing platform and single first tubes being placed next to an empty adjacent slot of the plurality of slots on the pairing platform; perform an excising process by which portions of labels on the plurality of first tubes from the pairing platform are excised; perform an imaging process in which an image of one or more first tubes, of the plurality of first tubes, is captured; perform an image analysis process, in which the captured image of the one or more first tubes is analyzed to determine at least a height of a portion of the liquid within the one or more first tubes; perform a first liquid handling process, in which the portion of the liquid within the one or more first tubes is aspirated from a pair of first tubes or from a single first tube, and is dispensed into a second tube, of a plurality of second tubes, so as to combine the portions of liquid from pairs of first tubes into the same second tube; receive, from at least one third scanner of the automated liquid processing system, identifying information of a second insert, of a plurality of second inserts; store the received identifying information of the scanned second insert in the at least one memory; instruct a second tube transfer robot of the automated liquid processing system to pick up and place second tubes, of the plurality of second tubes, into a second insert, of the plurality of second inserts; instruct a second gantry robot of the automated liquid processing system to pick up a second insert, of the plurality of second inserts, that is filled with second tubes, and to place the filled second insert into a second centrifuge, of a plurality of second centrifuges of the automated liquid processing system; instruct a second centrifuge, of the plurality of second centrifuges, to perform a second centrifuging cycle; and upon completion of the second centrifuging cycle of the second centrifuge, instruct the second gantry robot to retrieve second inserts, of the plurality of second inserts, from the second centrifuge and place the second inserts onto a conveyor system of the automated liquid processing system; receive identifying information of a scanned second tube from a fourth scanner of the automated liquid processing system; store the received identifying information of the scanned second tube in the at least one memory; and perform a second liquid handling process, in which the portion of the liquid within the second tubes is aspirated from the second tubes, and is dispensed into a plurality of output containers.

In another aspect, the present disclosure is directed to a label excising station, comprising: a pair of blades spaced apart from one another and located opposite from one another; a pair of blade actuators, wherein each blade of the pair of blades is rotatably mounted on one of the pair of blade actuators; and a platform positioned below the pair of blades, wherein the platform is configured to receive a sample collection tube, wherein the platform is configured to move between a first position and a second position, wherein in the first position, the platform is spaced relatively further away from the pair of blades, and wherein in the second position, the platform is spaced relatively closer to the pair of blades.

In still another aspect, the present disclosure is directed to a method of excising a label from a sample collection tube, the method comprising: placing the sample collection tube on a platform; moving a pair of blade actuators so as to position blades rotatably mounted on the pair of actuators apart from one another a distance approximately equal to a width of the sample collection tube; and moving the platform towards the blades so that the sample collection tube is pushed upwards between the blades mounted on the pair of actuators while the blades contact opposing sides of the sample collection tube.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1A is a schematic drawing of an automated liquid processing system, in accordance with the present invention.

FIG. 1B is a schematic drawing of a top view of the processing portions of the automated liquid processing system shown in FIG. 1A.

FIG. 2 is a schematic drawing of connections between a plurality of modules, a controller, and a user interface of the automated liquid processing system shown in FIGS. 1A and 1B, and connectivity between these portions and a laboratory information management system (LIMS) controller.

FIG. 3 is a schematic drawing of a first module of the automated liquid processing system shown in FIGS. 1A, 1B, and 2.

FIG. 4 is a schematic drawing of a top view of the processing portion of the first module shown in FIG. 3.

FIG. 5 is a schematic drawing of a detail view of a conveyor belt of the first module shown in FIGS. 3 and 4.

FIG. 6 is a schematic drawing of a detail view of an input opening of the first module shown in FIGS. 3 and 4.

FIG. 7 is a schematic drawing of a first insert for use with the first module shown in FIGS. 3 and 4.

FIG. 8 is a schematic drawing of a second module of the automated liquid processing system shown in FIGS. 1A, 1B, and 2.

FIG. 9 is a schematic drawing of a top view of the processing portion of the second module shown in FIG. 8.

FIG. 10 is a schematic drawing of a portion of a gantry robot of the second module shown in FIGS. 8 and 9, holding a first insert.

FIG. 11 is a schematic drawing of a third module of the automated liquid processing system shown in FIGS. 1A, 1B, and 2.

FIG. 12 is a schematic drawing of a top view of the processing portion of the third module shown in FIG. 11.

FIG. 13 is a schematic drawing of a detail view of a portion of a pairing station of the third module shown in FIGS. 11 and 12.

FIG. 14 is a schematic drawing of an effector of the pairing robot of the pairing station of the third module shown in FIGS. 11 and 12.

FIG. 15 is a schematic drawing of a detail view of an excising station of the third module shown in FIGS. 11 and 12.

FIG. 16 is a schematic drawing of a detail view of an imaging station of the excising station shown in FIG. 15.

FIG. 17 is a schematic drawing of a detail view of a user interface of a controller optionally used during an imaging analysis process, following imaging by the imaging station shown in FIG. 16.

FIG. 18 is a schematic drawing of a detail view of an end effector of one of the pairing robots of the pairing station of the third module shown in FIGS. 11 and 12.

FIG. 19 is a schematic drawing of the first turntable and a decapping station of the third module shown in FIGS. 11 and 12.

FIG. 20 is a schematic drawing of a detail view of a third module tip rack hotel used to supply third module aspirator tips to the third module liquid handling station shown in FIGS. 11 and 12.

FIG. 21 is a schematic drawing of third module aspirator tip racks holding the third module aspirator tips from the third module tip rack hotel shown in FIG. 20.

FIG. 22A and FIG. 22B are schematic drawings of the third module aspirator tip racks carrying the third module aspirator tips on the third module aspirator tip conveyor belt, within the third module shown in FIGS. 11 and 12.

FIG. 23 is a schematic drawing of spacing between the third module aspirator tips within the third module liquid handling station.

FIG. 24 is a schematic drawing of spacing between the third module aspirator tips within the third module liquid handling station.

FIG. 25A is a schematic drawing of a hopper, a step feeder, and a second tube conveyor, for supplying second tubes to the third module liquid handling station, and FIG. 25B is a schematic drawing of a second tube.

FIG. 26 is a schematic drawing of a gripping and marking device of the third module shown in FIGS. 11 and 12.

FIG. 27A and FIG. 27B are schematic drawings of the end effector of the second tube transfer robot.

FIG. 28 is a schematic drawing of the second turntable of the third module shown in FIGS. 11 and 12.

FIG. 29 is a schematic drawing of a detail view of the third module liquid handling station shown in FIGS. 11 and 12.

FIG. 30A and FIG. 30B are schematic drawings of first tubes and exemplary flow rates and Z-speeds for withdrawal of liquid from the first tubes using the third module liquid handling station shown in FIGS. 11 and 12.

FIG. 31 is a schematic drawing of the second turntable of the third module shown in FIGS. 11 and 12.

FIG. 32 is a schematic drawing of a fourth module of the automated liquid processing system shown in FIGS. 1A, 1B, and 2.

FIG. 33 is a schematic drawing of a top view of the processing portion of the fourth module shown in FIG. 32.

FIG. 34 is a schematic drawing of a top view of a pallet conveyor of the fourth module shown in FIGS. 32 and 33.

FIG. 35 is a schematic drawing of a second insert, into which the second tubes 1010 are placed within the fourth module shown in FIGS. 32 and 33.

FIG. 36 is a schematic drawing of a fifth module of the automated liquid processing system shown in FIGS. 1A, 1B, and 2.

FIG. 37 is a schematic drawing of a top view of the processing portion of the fifth module shown in FIG. 36.

FIG. 38 is a schematic drawing of a detail view of the liquid handling station of the fifth module shown in FIGS. 36 and 37.

FIG. 39 is a schematic drawing of a detail view of deep well plates (DPWs) on plate shuttles in the fifth module shown in FIGS. 36 and 37.

FIG. 40 is a schematic drawing of a detail view of tray handling in the fifth module shown in FIGS. 36 and 37.

FIG. 41 is a schematic detail view of a capping and decapping device of the fifth module shown in FIGS. 36 and 37.

FIG. 42A is a schematic diagram showing consumable supply storage in the third module and the fifth module of the automated liquid processing system shown in FIGS. 1A, 1B, and 2.

FIG. 42B is a schematic diagram showing consumable disposal containers of the third module and the fifth module of the automated liquid processing system shown in FIGS. 1A, 1B, and 2.

FIG. 43 is a schematic drawing of a disposal container provided within the automated liquid processing system shown in FIGS. 1A, 1B, and 2.

FIG. 44 is a schematic drawing of a disposal scale provided within the third module and the fifth module of the automated liquid processing system shown in FIGS. 1A, 1B, and 2.

FIG. 45 is a schematic drawing of an automated plasma isolation process, as an example of an automated liquid isolation process performed by the automated liquid processing system shown in FIGS. 1A, 1B, and 2.

FIGS. 46A and 46B show a flowchart of a first module control method performed by the controller of the automated liquid processing system shown in FIGS. 1A, 1B, and 2.

FIGS. 47A and 47B show a flowchart of a control method for the second module performed by the controller of the automated liquid processing system shown in FIGS. 1A, 1B, and 2.

FIGS. 48A and 48B show a flowchart of a control method for the pairing station of the third module, the control method being performed by the controller of the automated liquid processing system shown in FIGS. 1A, 1B, and 2.

FIG. 49 shows a flowchart of a control method for the excising station of the third module, the control method being performed by the controller of the automated liquid processing system shown in FIGS. 1A, 1B, and 2.

FIG. 50 is a flowchart of a control method for the imaging station of the third module, the control method being performed by the controller of the automated liquid processing system shown in FIGS. 1A, 1B, and 2.

FIGS. 51A, 51B, 51C, 51D, and 51E show a flowchart of a control method for the liquid handling station of the third module, the control method being performed by the controller of the automated liquid processing system shown in FIGS. 1A, 1B, and 2.

FIGS. 52A, 52B, and 52C show a flowchart of a control method for the fourth module, the control method being performed by the controller of the automated liquid processing system shown in FIGS. 1A, 1B, and 2.

FIGS. 53A, 53B, 53C, and 53D show a flowchart of a control method for the fifth module, the control method being performed by the controller of the automated liquid processing system shown in FIGS. 1A, 1B, and 2.

### DETAILED DESCRIPTION

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments,” or “in one aspect” or “in some aspects” as used herein does not necessarily refer to the same embodiment or aspect, and the phrase “in another embodiment” or “in another aspect” as used herein does not necessarily refer to a different embodiment or aspect. It is intended, for example, that claimed subject matter include combinations of exemplary embodiments in whole or in part.

### I. Overview of Automated Liquid Processing System

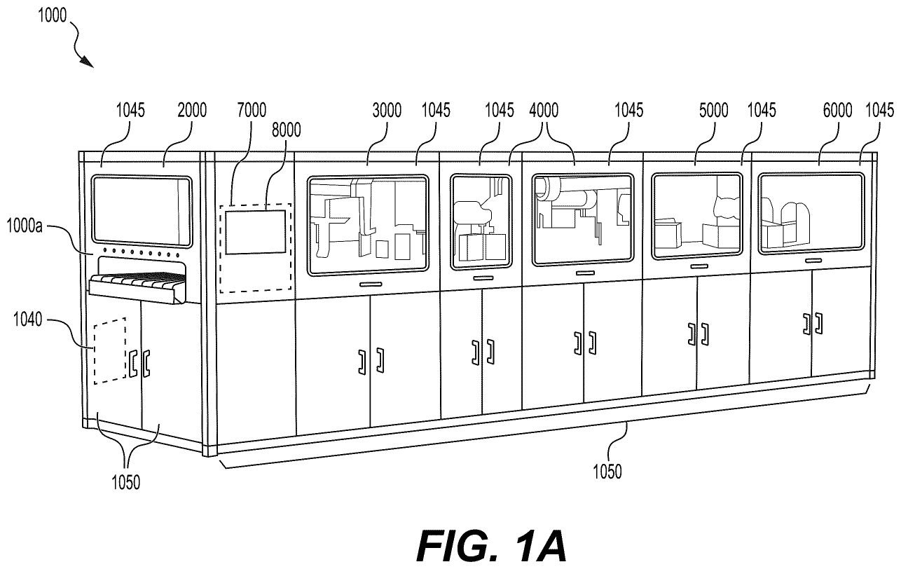

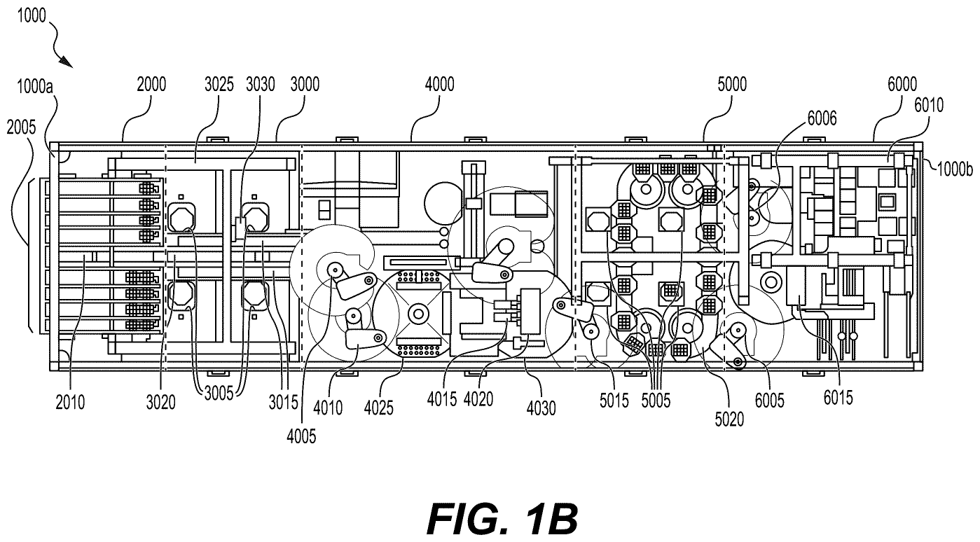

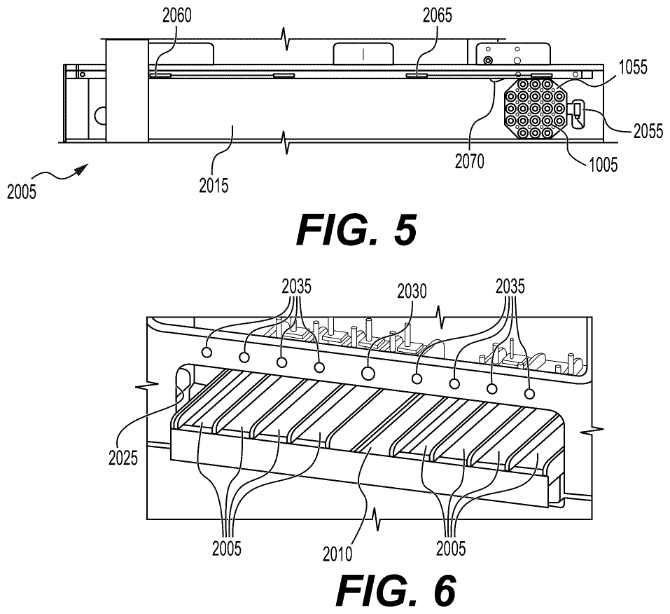

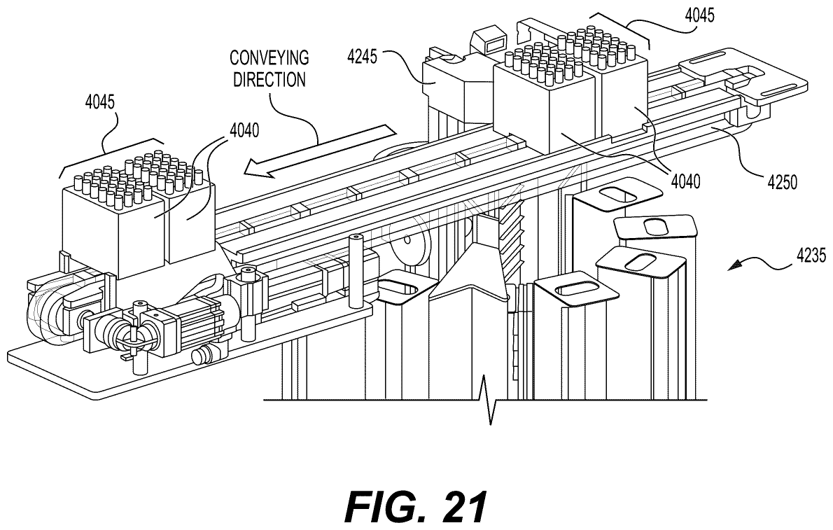

FIG. 1A is a schematic drawing of an automated liquid processing system 1000, in accordance with the present invention. The automated liquid processing system 1000 is configured to receive and process first tubes 1005 (FIG. 5) containing a liquid, to isolate one or more subcomponents of the liquid, to transfer the isolated subcomponent(s) of the liquid to second tubes 1010 (FIG. 21), to process the second tubes 1010 to further isolate the subcomponent(s), and to transfer the twice-isolated subcomponent(s) into one or more output containers 1030 (FIG. 37), for subsequent processing. In further descriptions, isolating “a” subcomponent is described for brevity, although it is within the scope of the invention to use the automated liquid processing system 1000 to isolate one or more subcomponents. As an example, the automated liquid processing system 1000 may be configured to receive and process blood tubes, as first tubes 1005, containing blood, isolate plasma from the blood (and/or e.g., red blood cells, buffy coat, or other blood components), as the one or more subcomponents, transfer the isolated plasma to tubes of a different size, e.g., 15 mL tubes, as second tubes 1010, process the second tubes to isolate the plasma a second time, and transfer the twice-isolated plasma to one or both of micronic tubes 1015 on micronic tube rack 1020 and deep well plates (DWPs) 1025, as output containers 1030. The example of ‘blood tubes,’ ‘15 mL tubes,’ ‘DWPs’ 1025, and ‘micronic tubes’ 1015, ‘blood samples,’ and ‘isolated plasma’ may also be referenced herein, although it is within the scope of the invention to use the automated liquid processing system 1000 to receive other types of liquid containers in place of the first tubes 1005, the second tubes 1010, and/or the output containers 1030, to process other types of liquids. As an example, any suitable type of liquid sample (e.g., a biological liquid sample) may be used in conjunction with automated liquid processing system 1000, such as a urine sample, a saliva sample, a tissue sample, a bone marrow sample, other bodily fluids, etc. Further, although plasma is referenced as the subcomponent to be isolated, other portions of a liquid sample may be isolated using automated liquid processing system 1000 alone or in conjunction with the plasma.

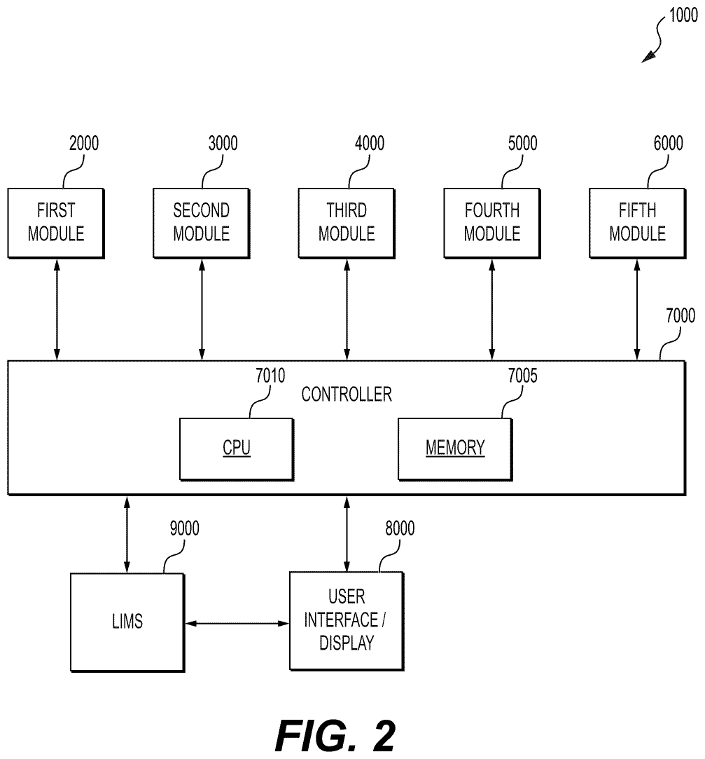

The automated liquid processing system 1000 includes at least a first module 2000 at a first end 1000a, the first module 2000 being configured to receive the first tubes 1005, a second module 3000 adjacent to the first module 2000, the second module 3000 being configured to centrifuge the received first tubes 1005 to isolate the subcomponent (e.g., plasma), a third module 4000 adjacent to the second module 3000, the third module 4000 being configured to pair the first tubes 1005 with the isolated subcomponent (e.g., plasma), to excise labels on the first tubes 1005, to image the first tubes 1005, to perform liquid handling to transfer the isolated subcomponent of liquid into second tubes 1010, and to add a label to the second tubes 1010, a fourth module 5000 adjacent to the third module 4000, the fourth module 5000 being configured to centrifuge the second tubes to isolate the subcomponent (e.g., plasma) a second time, and a fifth module 6000, adjacent to the fourth module 5000 and at a second end 1000b of the automated liquid processing system 1000, the fifth module 6000 being configured to batch and output the twice-isolated subcomponent (e.g., plasma) into one or more output containers 1030 (e.g., micronic tubes 1015, micronic tube racks 1020, and/or DWPs 1025). The automated liquid processing system 1000 may also include a controller 7000 for controlling one or more modules and/or one or more subcomponents of the modules, and a user interface 8000, or a display, through which an operator may also perform such control. The controller 7000 may also serve as an interface between controllers of other systems, such as a laboratory information management system (LIMS) controller 9000 (FIG. 2).

As disclosed herein, controller 7000 may be used to facilitate communications between itself, the user interface 8000, the first to fifth modules, one or more databases, and any other suitable system or device through a wired or wireless network connection. Any communication protocol/device may be used, including without limitation a modem, an Ethernet connection, a network card (wireless or wired), an infrared communication device, a wireless communication device, and/or a chipset (such as a Bluetooth™ device, an 802.11 device, a WiFi device, a WiMax device, cellular communication facilities, etc.), a near-field communication (NFC), a Zigbee communication, a radio frequency (RF) or radio-frequency identification (RFID) communication, a PLC protocol, a 3G/4G/5G/LTE based communication, and/or the like. For example, controller 7000 may communicate with another system or device with the same platform, a regular user device without the same platform (e.g., a regular smartphone), a remote server, a physical device of a remote loT local network, a wearable device, a user device communicably connected to a remote server, etc.

As discussed in more detail below, the controller 7000 may continually or intermittently communicate with LIMS controller 9000 to ensure first tubes 1005 are acceptable for inputting into the first module 2000, to monitor one or more of the modules for error notifications, to verify incoming consumables 1035 and the identifying information, for example, barcodes, of those consumables 1035, and to verify outputs from each of the modules based on identifying information on first tubes 1005 and consumables 1035.

Although first module 2000, second module 3000, third module 4000, fourth module 5000, and fifth module 6000 are described together in terms of automated liquid processing system 1000, any one module may be a stand-alone module, separate from the other modules of automated liquid processing system 1000, and may be configured to receive inputs and/or output outputs from another system component or from a user. Therefore, within the scope of the invention, the modules may not be directly adjacent. In other aspects, automated liquid processing system 1000 may only include a subset of modules. In still other aspects, each module described herein may be included in automated liquid processing system 1000 so that the modules are operatively coupled to one another such that the outputs of one module are received as the inputs of the subsequent module until an output is output from fifth module 6000 and thus form automated liquid processing system 1000.

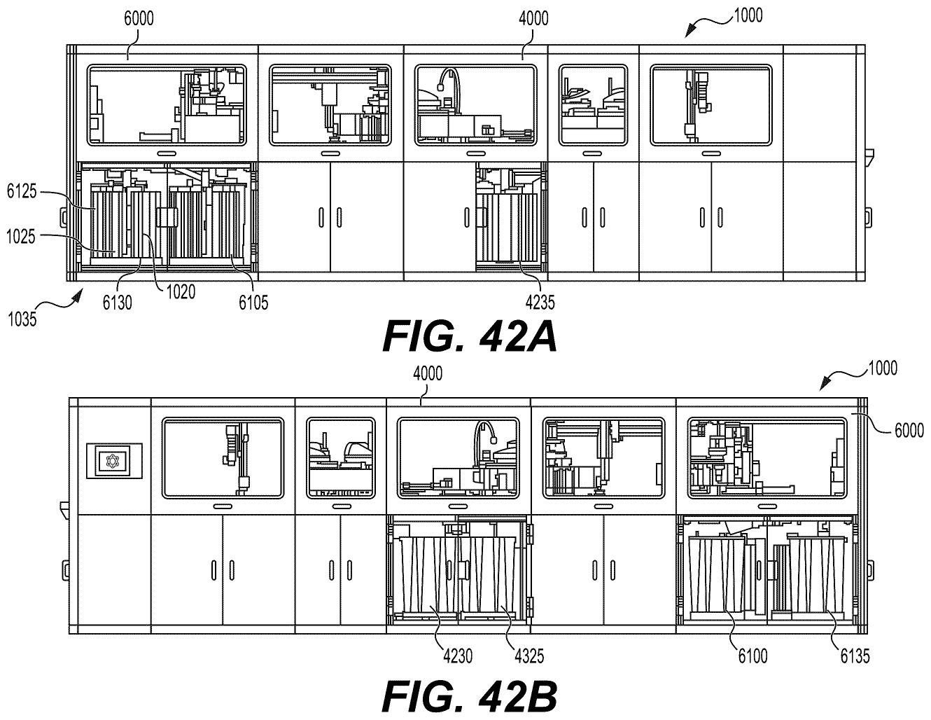

An electrical power supply connection 1040 may be provided within any of the first to fifth modules, or on multiple modules, and in the embodiment shown in FIG. 1A, the electrical power supply connection 1040 is included as part of the first module 2000. In some embodiments, each of the modules may have an electrical power supply connection 1040 to power the components therein. One or more disposal containers, scales, alarms, venting, temperature and humidity sensors may also be provided within one or more of the first to fifth modules, as described in more detail below with reference to FIGS. 42A and 42B. Further, each module may have at least one upper door 1045 and at least one lower door 1050, which an operator may open to input and/or retrieve disposed items or consumables 1035 or to perform inspection, maintenance, or repairs at any point within the automated liquid processing system 1000. In the embodiment shown in FIG. 1A, the upper door 1045 and the lower doors 1050 of the first module 2000 may face the first end 1000a of the automated liquid processing system 1000, and the upper door 1045 and lower doors 1050 of the second to fifth modules face a front side of the automated liquid processing system 1000. However, the doors of the modules may face directions other than those shown.

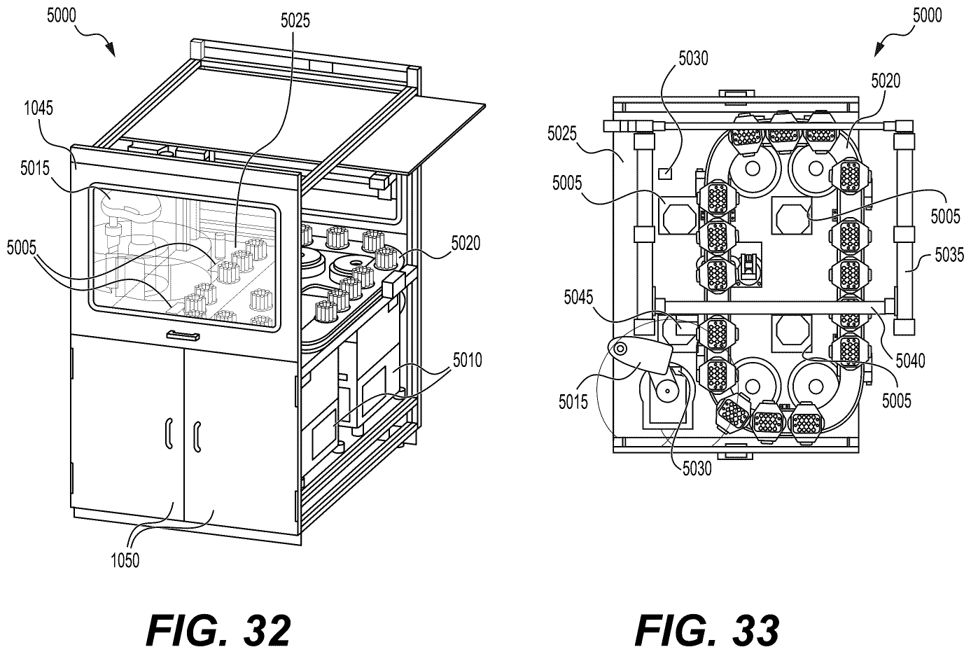

FIG. 1B is a schematic drawing of a top view of the processing portions of the automated liquid processing system 1000 shown in FIG. 1A (i.e., with the roof of the automated liquid processing system 1000 removed). FIG. 1B shows the first module 2000, including a plurality of first module conveyor channels 2005 and a first module return channel 2010. FIG. 1B also shows the second module 3000 including openings 3005 to a plurality of second module centrifuges 3010 (FIG. 8), second module conveyor belts 3015, a second module return channel 3020, and a second module gantry robot 3025 with a second module gantry robot end effector 3030. FIG. 1B further shows the third module 4000, including a pairing robot 4005, an excising robot 4010, a third module liquid handling station 4015, a third module liquid handling spanner 4020, a first turntable 4025, and a second turntable 4030. FIG. 1B also shows the fourth module 5000, including openings 5005 to a plurality of fourth module centrifuges 5010 (FIG. 32), a fourth module robot 5015, and a fourth module pallet conveyor system 5020. Lastly, FIG. 1B shows the fifth module 6000, including a fifth module turntable load robot 6005, a fifth module turntable unload robot 6006, a fifth module gantry robot 6010, and a fifth module liquid handling station 6015. These and other features are described in more detail below.

FIG. 2 is a schematic drawing of connections between the first to fifth modules, the controller 7000, and the user interface 8000 of the automated liquid processing system 1000 shown in FIGS. 1A and 1B, and connectivity between these portions and the LIMS controller 9000. Each of the first to fifth modules may be operably connected to the controller 7000, and the controller 7000 may be operably connected to the user interface 8000 and to the LIMS controller 9000. In the embodiment shown in FIG. 2, the controller 7000 is separate from the LIMS controller 9000, however, these may be incorporated as part of the same controller. In addition, the user interface 8000 may be operably connected to the LIMS controller 9000. By virtue of these connections, the methods or processes performed within each of the first to fifth modules of the automated liquid processing system 1000 may be automated, and updates regarding the status of the system may be provided to an operator and/or to the LIMS controller 9000. In addition, the operator may intervene, if needed, for example, to stop, modify, inspect, or otherwise interact with one or more processes if, for example, an error notification is issued by the controller 7000.

The controller 7000 may include at least one memory 7005, including program storage and data storage for various data files and information to be stored, processed, and/or communicated by the controller 7000. The controller 7000 may also include a central processing unit (CPU) 7010, in the form of one or more processors that are configured to execute the program instructions stored in the memory 7005 of the controller 7000. The controller 7000 may control end-to-end functions of the automated liquid processing system 1000, and/or may control the functions of one or more individual modules 2000, 3000, 4000, 5000, 6000.

The user interface 8000 may provide notifications to an operator relating to one or both of alarms or error notifications. The user interface 8000 may allow an operator to set one or more components of the first to fifth modules to an automated mode or a manual mode, and may provide a user with control over the components of the first to fifth modules. In addition, an operator may be able to access information stored by controller 7000 in the memory 7005, during the processing of samples, e.g., to determine a location of a specific sample in the process, that is, a location in a specific module using, for example, the user interface 8000. The user display is a human-machine interface. The user interface 8000 may be understood to be a graphical user interface, with unique displays relating to the first to fifth modules of the automated liquid processing system 1000.

Functions of and interactions between the modules, controller, LIMS controller, and/or user interface with be described herein in further detail.

### II. First Module

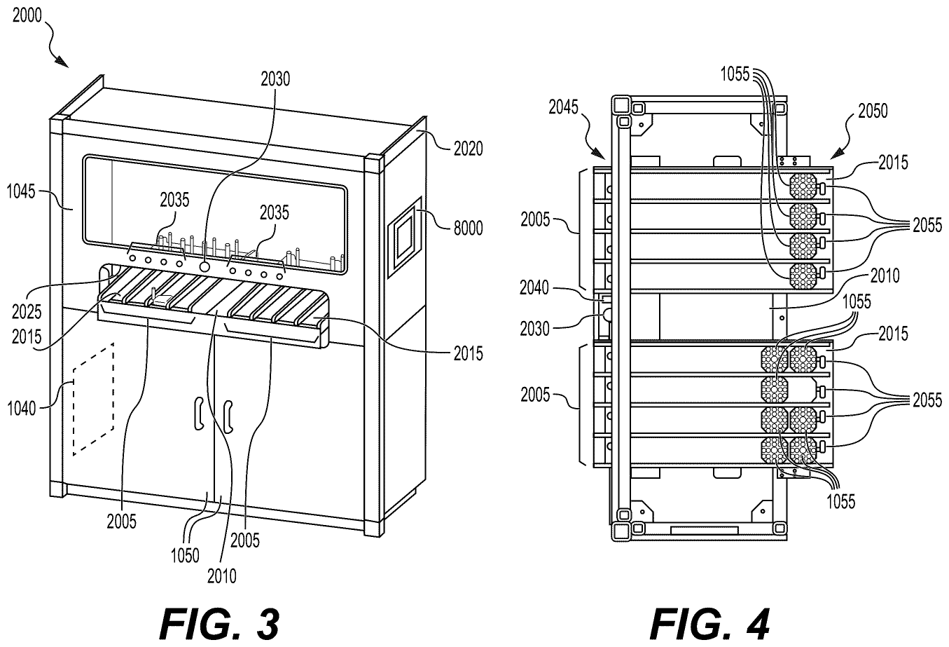

The first module 2000 will be described further with reference to FIGS. 3 to 7. As noted above, the first module 2000 is configured to receive one or more first tubes 1005. The first module 2000 may also be referred to as an input module. To facilitate the receipt of one or more first tubes 1005, the first module 2000 includes the plurality of first module conveyor channels 2005, as well as one or more first module return channels 2010 (only one first module return channel 2010 is depicted in FIG. 3, although more may be included).

FIG. 3 is a schematic drawing of a first module 2000 of the automated liquid processing system 1000, and in particular, shows the plurality of first module conveyor channels 2005, including two first module conveyor belts 2015, and the first module return channel 2010, as well as a first module frame 2020, the upper door 1045 and the lower doors 1050 of the first module 2000, the user interface 8000, an input opening 2025, an input indicator light 2030, indicator lights 2035 for the first module conveyor channels 2005, and the electrical power supply connection 1040. FIG. 4 is a schematic drawing of a top view of the first module 2000 shown in FIG. 3 (with the roof of first module 2000 removed), and shows the first module conveyor belts 2015, the first module return channel 2010, a first module scanner 2040 located toward an input end 2045 of the first module, and a plurality of first inserts 1055 located toward an output end 2050 of each first module conveyor channel 2005. FIG. 4 also shows an output sensor 2055 at the back end of each first module conveyor belt 2015. Each first module conveyor belt 2015 may extend across multiple, e.g., four, conveyor channels 2005, with one first module conveyor belt 2015 being located on one side of the first module return channel 2010, and the other first module conveyor belt 2015 being located on the other side of the first module return channel 2010. In other aspects, each conveyor channel 2005 may have its own distinct conveyor belt 2015. In some embodiments, the first module conveyor belts 2015 may be configured to continuously rotate. In other embodiments, the first module conveyor belts 2015 may rotate based on signals output by the controller 7000. Although two conveyor belts 2015 and eight conveyor channels 2005 are shown, with a single first module return channel 2010 located centrally between them, in FIGS. 3 and 4, any suitable number of channels and conveyor belts and/or arrangement of channels and conveyor belts may be used. In some aspects, for example, the number of first module conveyor channels 2005, first module conveyor belts 2015, and/or first module return channels 2010 incorporated in the first module 2000 may depend, at least in part, on the maximum intended processing volume of liquid samples through the system.

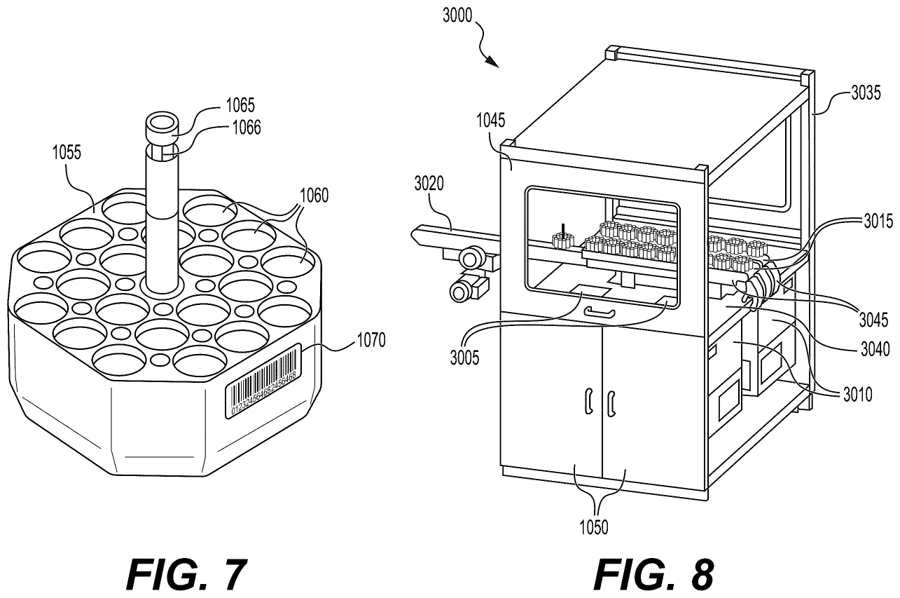

FIG. 5 is a schematic drawing of a detail view of one of the first module conveyor channels 2005, and shows a first insert 1055, with a plurality of first tubes 1005 therein, located at the output end 2050 of the first module conveyor channel 2005, as well as the output sensor 2055. FIG. 5 also shows a high level sensor 2060, a low level sensor 2065, and an insert hold back protrusion 2070 in the first module conveyor channel 2005. FIG. 6 is a schematic drawing of a detail view of the input opening 2025 of the first module 2000, and shows the indicator lights 2035, the input indicator light 2030, a first module scanner push button of the first module 2000, the first module conveyor channels 2005, and the first module return channel 2010. FIG. 7 is a schematic drawing of a first insert 1055 to be input into the first module 2000, and in particular, shows a plurality of slots 1060 for receiving the first tubes 1005, a projection 1065 to facilitate handling of the first insert 1055, and a first insert label 1070.

The first module conveyor channels 2005 are configured to receive one or more first inserts 1055 through the input opening 2025. The first inserts 1055 include the plurality of slots 1060 that are configured to hold the first tubes 1005 and, in the embodiment shown in FIGS. 3 to 7, the first inserts 1055 have 20 slots 1060, although any suitable number of slots 1060 may be included. Further, the size, shape, and arrangement of slots 1060 may depend, at least in part, on the size of the first tubes 1005 that slots 1060 are configured to receive. The first inserts 1055 may also have one or more first insert labels 1070 with identifying information, for example, a label adhered to the first insert 1055 with a unique barcode for each first insert 1055. The identifying information is not limited to a barcode, and may be a quick-response (QR) code (or other two-dimensional barcode or data matrix, referred to collectively as a “QR code” herein), alphanumeric symbols, sequences, identification chips, colors, or any other suitable label for identification.

The first inserts 1055 may receive one or more first tubes 1005 that contain liquid samples, e.g., blood samples from patients, and other first tubes 1005 that are placeholders, devoid of any liquid samples for processing, also referred to as “dummy tubes.” The dummy tubes 1005 may be input into the automated liquid processing system 1000 for the purpose of balancing during spin cycles of the second module centrifuges 3010, as described in more detail below. Each of the first tubes 1005, including the dummy tubes 1005, may also have labels with identifying information, for example, a label (not shown) adhered to each first tube 1005 with a unique barcode. The identifying information is not limited to a barcode, and may be a QR code, alphanumeric symbols, sequences identification chips, colors, or any other suitable label for identification. Of the first tubes 1005 that contain blood samples from patients, there may be pairs of first tubes 1005 that contain blood samples from the same patient.

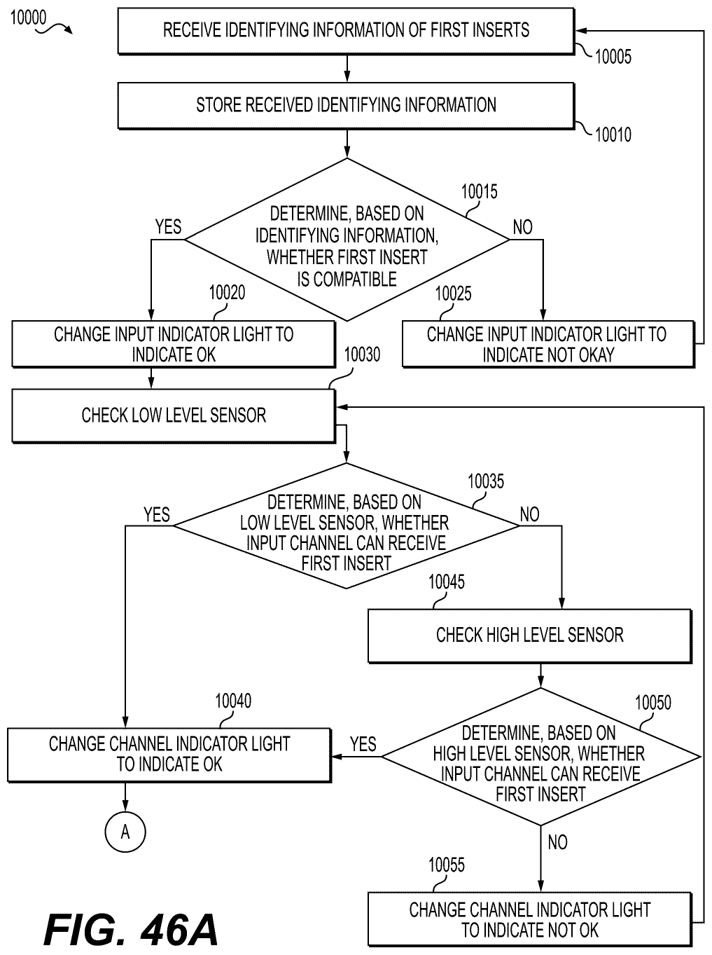

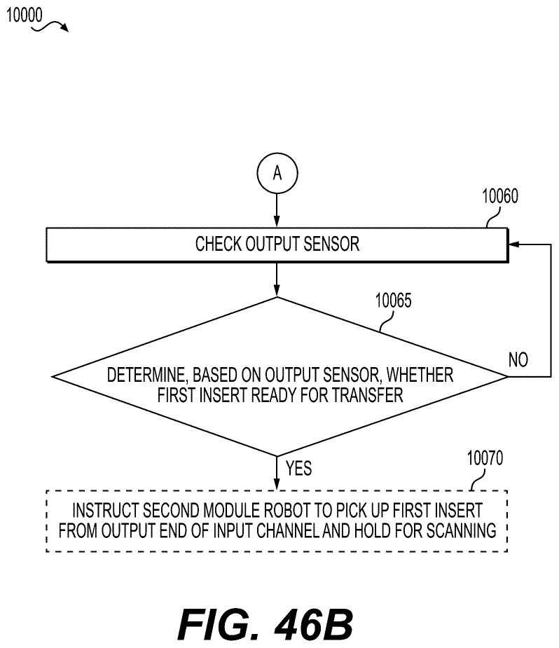

Before being placed on a first module conveyor belt 2015, each first insert 1055 may be scanned by the first module scanner 2040. An operator may initiate the scanning process by pressing the first module scanner push button, or another suitable actuator, which may also serve as the input indicator light 2030. Alternatively, the first module scanner 2040 may be on, while the automated liquid processing system 1000 remains on, and ready to scan a first insert 1055 held under a scanner light (not shown) of the first module scanner 2040. The first module scanner 2040 may communicate the identifying information of the one or more scanned first inserts 1055 to the controller 7000, and the controller 7000 may receive and store the identifying information of the scanned first insert 1055 in the memory 7005 of the controller 7000. The controller 7000 may also determine whether the first insert 1055 may be input into the first module 2000 and may be configured to change the input indicator light 2030 depending on the determination, as described in more detail below with reference to FIGS. 46A and 46B. That is, the controller 7000 may determine if a first insert 1055 is compatible by, for example, comparing the identifying information of the scanned first insert 1055 to a manifest listing expected or allowed first inserts 1055 and their corresponding identifying information. In addition or alternatively, determining compatibility may include confirming that the first insert 1055 may be used with the second module centrifuges 3010. As a specific example, if the first insert 1055 is compatible, the controller 7000 may turn on the input indicator light 2030, to indicate that the first insert 1055 may be put into the first module 2000. If the first insert 1055 is not compatible, the controller 7000 may turn off the input indicator light 2030, to indicate that the first insert 1055 may not be put into the first module 2000. In some embodiments, a color of the input indicator light 2030 may be changed, for example, from green, indicating the first insert 1055 may be input into the first module 2000, to red, indicating the first insert 1055 may not be input into the first module 2000, instead of turning the input indicator light 2030 on and off. In other aspects, other suitable visual indicators other than lights may be used, for example, a display may show a first alphanumeric message or symbol if the first insert 1055 may not be input into the first module 2000 and a second alphanumeric message or symbol if the first insert 1055 may be input into the first module 2000. In still other aspects, suitable audio or haptic feedback may be utilized to indicate whether a user may input the first insert 1055 into the first module 2000. A first insert 1055 may be rejected by the controller 7000 if, for example, the first module scanner 2040 cannot read or detect an identifying label, e.g., a barcode, on the first insert 1055, because it would not be possible to track the first insert 1055 through the automated liquid processing system 1000 if it does not have a readable identifying label, e.g., barcode.

After scanning of the first inserts 1055 and confirming they may be input into the automated liquid processing system 1000, the first inserts 1055 may be placed into one of the first module conveyor channels 2005, onto one of the first module conveyor belts 2015. Each first module conveyor channel 2005 may have an indicator light 2035 or other suitable indicator that indicates whether it can receive a first insert 1055. This determination of whether a first module conveyor channel 2005 may receive a first insert 1055 may be made by the controller 7000, as part of the first module control method described below with reference to FIGS. 46A and 46B. In the embodiment shown in FIGS. 3 to 7, an indicator light 2035 is located above each of the first module conveyor channels 2005, however the indicator light 2035 may be at other locations related to the first module conveyor channels 2005, and/or indicators may appear on the user interface 8000, instead of or in addition to indicator lights 2035. For example, in some embodiments, a green indicator light 2035 above one of the first module conveyor channels 2005 may indicate that first inserts 1055 may be placed in that first module conveyor channel 2005, and a red indicator light 2035 may indicate that first inserts 1055 may not be placed in that first module conveyor channel 2005. The high level sensor 2060 and the low level sensor 2065 of each first module conveyor channel 2005 may be used to determine whether a first insert 1055 may be placed in each first module conveyor channel 2005. That is, if the low level sensor 2065 does not detect a first insert 1055 at a location in the first module conveyor channel 2005 corresponding to that of the low level sensor 2065, the low level sensor 2065 may be configured to output a notification to the controller 7000 that the first module conveyor channel 2005 has room to receive additional first inserts 1055. If the low level sensor 2065 does detect a first insert 1055 at the location in the first module conveyor channel 2005 corresponding to that of the low level sensor 2065, then the high level sensor 2060 may be checked to determine whether a first insert 1055 at a location in the first module conveyor channel 2005 corresponding to that of the high level sensor 2060. If the high level sensor 2060 detects a first insert, the high level sensor 2060 may be configured to output a notification to the controller 7000 that the first module conveyor channel 2005 is full and cannot receive any additional first inserts 1055 until at least the high level sensor 2060 no longer detects a first insert 1055 at that location.

In some aspects, the first module 2000 may be configured such that multiple first inserts 1055 may be received and maintained within a single conveyor channel 2005 until the first module conveyor channel 2005 is completely full, or a predetermined number of first inserts 1055 have been received in a single conveyor channel 2005. The first inserts 1055 may be held within the single conveyor channel 2005 until the second module 3000 is ready to receive one or more of the first inserts 1055. This is shown, for example, in FIG. 4. For example, if only the low level sensor 2065 detects the presence of a first insert 1055 in a given first module conveyor channel 2005, then an indicator may indicate that the first module conveyor channel 2005 is able to accept another first insert 1055. However, if the high level sensor 2060 detects the presence of a first insert 1055 in a given first module conveyor channel 2005, then an indicator may indicate that the first module conveyor channel 2005 is unable to accept another first insert 1055.

After one or more first inserts 1055 are placed in one of the first module conveyor channels 2005, the first inserts 1055 may be conveyed on the first module conveyor belts 2015, from the input end 2045 toward the output end 2050. In some aspects, an insert hold back protrusion 2070 may be included. The insert hold back protrusion 2070 in each first module conveyor channel 2005 may be spring-loaded and configured to protrude into a path of first inserts 1055 in the first module conveyor channel 2005, and on the first module conveyor belt 2015, to prevent first inserts 1055 that have passed the insert hold back protrusion 2070 from regressing or moving back toward the input end 2045.

Each of the first module conveyor channels 2005 may also have an output sensor 2055 at the output end 2050 configured to detect the presence of a first insert 1055 at the output end 2050. When the output sensor 2055 detects the presence of a first insert 1055, a notification may be sent to the controller 7000 to indicate that a first insert 1055 is ready for transfer to the second module 3000. The controller 7000 may also use these notifications to control the second module by communicating to the second module gantry robot 3025 to pick up the first inserts 1055 and bring them to the second module 3000. Alternatively, if the first module 2000 is a stand-alone module, the first inserts 1055 may be output to an operator.

With reference to FIG. 7, each of the first inserts 1055 may have a projection 1065 in a center region thereof, and a squared gripping neck 1066, below a top portion of the projection 1065, which may be grasped by the second module gantry robot end effector 3030. The squared gripping neck 1066 may facilitate grasping of the first insert 1055, while avoiding rotation of the first insert 1055 after it is grasped by the second module gantry robot 3025. Although a squared gripping neck is shown and described in reference to FIG. 7, any suitable shaped gripping neck may be used. In some aspects, one or more notches may be present on the gripping neck, which may also facilitate grasping of the first insert 1055. Although the projection 1065 of the first insert 1055 in FIG. 7 is at a center of the first insert 1055, the projection 1065 may be at other locations on the first insert 1055. In addition, although the first insert 1055 in FIG. 7 has one projection 1065, more than one projection 1065 may be provided on the first insert 1055. Further, although a projection 1065 with a squared gripping neck 1066 is depicted, any other suitable mechanism to facilitate grasping may be included as part of the first insert 1055, for example, a handle, a hook, a loop, etc. Projection 1065 may be compatible with robotic end effectors throughout the automated liquid processing system 1000 to facilitate the movement of first insert 1055 through the automated liquid processing system 1000. The first inserts 1055 also are depicted as having an octagonal outer circumferential shape. However, inserts having other outer circumferential shapes may be used, including circular-shaped, oval-shaped, rectangle-shaped, square-shaped, and other polygonal-shaped inserts. The shape of the first insert 1055 may be determined at least in part based on the type of centrifuge included in the second module 3000, such that the first tubes 1005 received in the first module 2000 do not need to be placed in a different container or adapter prior to being placed within the second module centrifuges 3010. In other words, the first inserts 1055 may be selected based on their compatibility with the second module centrifuges 3010.

The first module 2000 also may include the first module return channel 2010, shown in FIGS. 3, 4, and 6, through which empty first inserts 1055 returned from the second module 3000 may be returned to an operator through the input opening 2025 of the first module 2000. Although one, centrally located first module return channel 2010 is depicted, the first module return channel 2010 may be located in any suitable position relative to the first module conveyor channels 2005, or more than one first module conveyor channels 2005 may be included.

### III. Second Module

The second module 3000 of the automated liquid processing system 1000 will be described with reference to FIGS. 8 to 10. As noted above, the second module 3000 is configured to centrifuge the received first tubes 1005 to isolate plasma. The second module 3000 may also be referred to as a centrifuging module.

FIG. 8 is a schematic drawing of the second module 3000, and shows a second module frame 3035, a second module deck 3040, two openings 3005 in the second module deck 3040 to allow access to the second module centrifuges 3010, two second module centrifuges 3010 below the second module deck 3040, two second module conveyor channels 3045, including the second module conveyor belts 3015, the second module return channel 3020, which may be continuous and/or configured to operably align with the first module return channel 2010, and the upper door 1045 and the lower doors 1050 of the second module 3000.

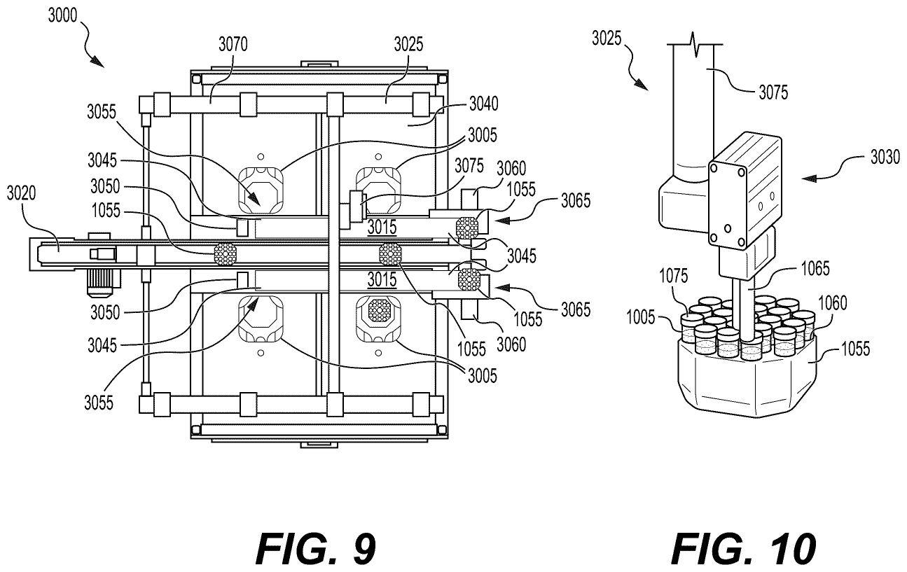

FIG. 9 is a schematic drawing of a top view of the second module 3000, with the roof of the second module 3000 removed. FIG. 9 shows the second module deck 3040 with the openings 3005 to allow access to each of the second module centrifuges 3010. The second module 3000 also includes the second module conveyor channels 3045, including second module conveyor belts 3015, second module scanners 3050 at upstream ends 3055 of each of the second module conveyor channels 3045, an insert sensor 3060 at an output end 3065 of the second module conveyor channels 3045, and the second module return channel 3020. The second module 3000 further includes the second module gantry robot 3025, including a second module gantry robot frame 3070 and a second module gantry robot arm 3075. FIG. 9 depicts first inserts 1055 on the second module conveyor belts 3015, the second module return channel 3020, and in one of the second module centrifuges 3010.

FIG. 10 is a schematic drawing of a portion of the second module gantry robot 3025 holding a first insert 1055. In particular, FIG. 10 shows the second module gantry robot arm 3075, which extends down from the second module gantry robot frame 3070, shown in FIG. 9, and a second module gantry robot end effector 3030 connected to an end of the second module gantry robot arm 3075, the second module gantry robot end effector 3030 holding the projection 1065 of the first insert 1055. In addition, FIG. 10 shows a first tube 1005 with a first tube cap 1075, within a slot 1060 of the first insert 1055.

Based on receipt of instructions from the controller 7000, the second module gantry robot arm 3075 is configured to move to the output ends 2050 of the first module conveyor channels 2005 of the first module 2000, and, using the second module gantry robot end effector 3030, to pick up a first insert 1055, e.g., by grasping projection 1065. Then, the second module gantry robot arm 3075 is configured to hold the first insert 1055 in front of one of the second module scanners 3050. The second module scanners 3050 are configured to read identifying information, such as a barcode on a stuck-on label, on each of the first inserts 1055, and output the identifying information to the controller 7000. In addition to storing the information output by the second module scanners 3050, the controller 7000 may store, as information associated with the first insert 1055, the specific second module centrifuge 3010 into which each first insert 1055 is to be placed, coordinating the subsequent placement of the first insert 1055 into a specific second module centrifuge 3010 within the second module gantry robot 3025. By this arrangement, the controller 7000 may be capable of tracking the first inserts 1055 through the second module 3000. In some aspects, this arrangement may allow the controller 7000 to monitor performance of each of the second module centrifuges 3010, e.g., in case blood samples in first tubes 1005 in a specific first insert 1055 are determined, based on image analysis performed in the third module 4000, to be insufficiently separated into layers from the spin cycle performed in the second module 3000.

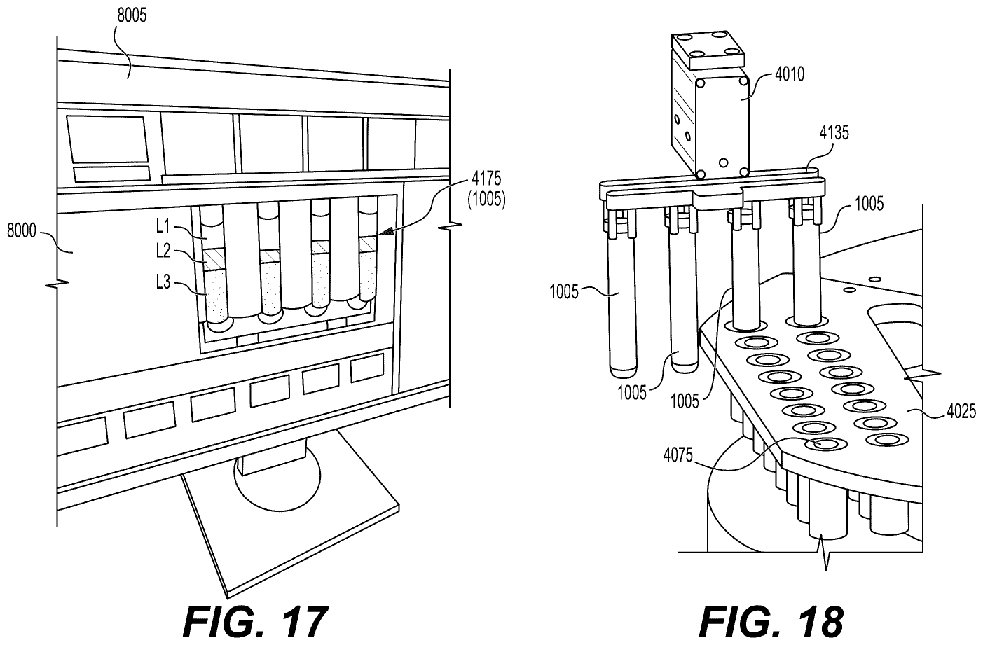

After scanning, the first insert 1055 may then be placed into one of the openings 3005 to the second module centrifuges 3010. In some aspects, each of the second module centrifuges 3010 may be configured to hold one first insert 1055. In other aspects, each second module centrifuge 3010 may hold a plurality of first inserts 1055 per spin cycle. As one example, each second module centrifuge 3010 may be configured to hold up to four first inserts 1055. Once a second module centrifuge 3010 is filled, and in this example, is filled with four first inserts 1055, the second module centrifuge 3010 may be configured to perform a spin cycle to isolate one or more components of a liquid sample within the first tubes 1005. In the event that the first tubes 1005 contain blood samples, centrifugation may result in isolation of plasma within the first tubes 1005. More specifically, the spin cycle may cause relatively less dense portions of blood in the first tubes 1005 to move upward within the first tubes 1005, and relatively more dense portions of blood to move downward within the first tubes 1005. As a result of a spin cycle by the second module centrifuges 3010, blood in the first tubes 1005 may separate into a lower red blood cell layer L3 and an upper plasma layer L1 (FIG. 17). In addition, a buffy coat red layer L2 may remain in between the lower red blood cell layer L3 and the upper plasma layer L1, the buffy coat red layer L2 containing contents of white blood cells and platelets (FIG. 17).

A timer (not shown) may be used to control and, in some aspects, to stagger start times of spin cycles of the four second module centrifuges 3010. This may promote efficient and/or continuous processing of first tubes 1005 in first inserts 1055, and regular or continuous flow of the first inserts 1055 downstream, to the third module 4000. The second module centrifuges 3010 may be operably coupled to and configured to communicate to the controller 7000 when a spin cycle has started and when a spin cycle has completed. Other mechanisms may be used to control the operation of the second module centrifuges 3010. As one example, each second module centrifuge 3010 may be configured to detect when the liquid samples within the first tubes 1005 placed in the second module centrifuge 3010 are sufficiently separated, stop the spin cycle, and communicate this information to the controller 7000. Although four centrifuges 3010 are depicted in FIG. 9, any suitable number of centrifuges may be included. In some aspects, for example, the number of centrifuges 3010 incorporated in the second module 3000 may depend, at least in part, on the maximum intended processing volume of liquid samples through the system.

Following the spin cycle, controller 7000 may receive a signal from one or more centrifuges 3010, and, in response, controller 7000 may communicate to the second module gantry robot end effector 3030 to pick up the first inserts 1055 from one or more of the second module centrifuges 3010, and to place the first inserts 1055 on one of the second module conveyor belts 3015 of the second module conveyor channels 3045. The first inserts 1055 may then be then conveyed toward the third module 4000. The second module conveyor belts 3015 may be indexing conveyor belts, although other types of conveyor belts may be used. Insert sensors 3060 near or at output ends 3065 of the second module conveyor channels 3045 may be configured to detect first inserts 1055 ready to exit the second module 3000 and ready to enter the third module 4000. Alternatively, if the second module 3000 is a stand-alone module, the first inserts 1055 may be received from or input by an operator, and/or the first inserts 1055 may be output to an operator.

After the first tubes 1005 are removed from the first inserts 1055 by a pairing robot 4005 of the third module 4000, as discussed in more detail below, the emptied first inserts 1055 may be returned to the second module return channel 3020 for disposal or for reuse for receipt of more first tubes 1005. In some aspects, the second module return channel may be continuous and/or configured to operably align with the first module return channel 2010. In such cases, the number or arrangement of second module return channel(s) 3020 may correspond to the number or arrangement of the first module return channel(s) 2010. In the figures included herein, the first module 2000 includes one central first module return channel 2010, and thus the second module 3000, too, includes one central second module return channel 3020.

### IV. Third Module

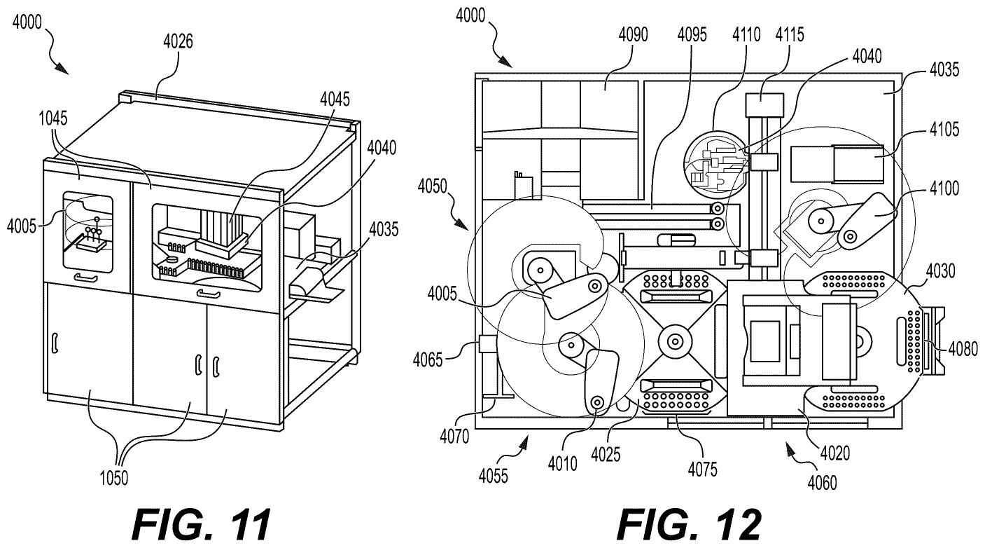

The third module 4000 will be described with reference to FIGS. 11 to 30. As noted above, the third module 4000 is configured to pair the first tubes 1005 containing the isolated component (e.g., plasma), excise labels on the first tubes 1005, image the first tubes 1005, perform liquid handling to transfer the subcomponent(s) of liquid into second tubes 1010, and add a label to the second tubes 1010. The third module 4000 may also be referred to as a pooling module.

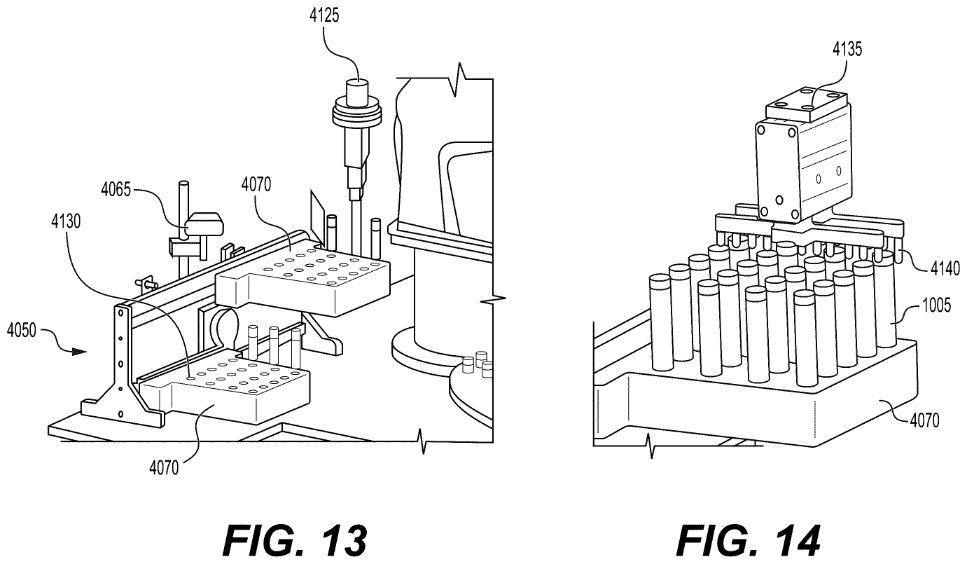

FIG. 11 is a schematic drawing of the third module 4000, and shows a third module frame 4026, a third module deck 4035, the pairing robot 4005, a third module aspirator tip rack 4040 containing a plurality of third module aspirator tips 4045, and the upper doors 1045 and lower doors 1050 of the third module 4000. FIG. 12 is a schematic drawing of a top view of the third module 4000, with the roof removed, and shows the third module deck 4035, a pairing station 4050, an excising station 4055, and a liquid handling station 4060. FIG. 12 also shows the pairing robot 4005, a pairing scanner 4065, and pairing platforms 4070 of the pairing station 4050, and the excising robot 4010 of the excising station 4055. In addition, FIG. 12 shows the first turntable 4025 in between the excising station 4055 and the liquid handling station 4060, the second turntable 4030 downstream (to the right in FIG. 12) of the liquid handling station 4060, each of the first turntable 4025 and the second turntable 4030 being subdivided into portions, e.g., quarters, that rotate between the different positions, with each portion of the first turntable 4025 having a group of slots 4075, and each portion of the second turntable 4030 having a group of slots 4080. FIG. 12 also shows a third module liquid handling spanner 4020 of the liquid handling station 4060. Further, FIG. 12 shows a hopper 4090 for supplying second tubes 1010 to the liquid handling station 4060, a second tube conveyor 4095 for conveying the second tubes 1010, a second tube transfer robot 4100, and a decapping and marking device 4105. Still further, FIG. 12 shows an opening 4110 in the third module deck 4035 through which third module aspirator tips 4045 are supplied to the liquid handling station 4060, a third module aspirator tip rack conveyor 4115 that moves the supplied third module aspirator tips 4045 to the liquid handling station 4060, and an opening 4120 in the third module deck 4035 through which the third module aspirator tips 4045 (FIGS. 1, 20-24, 29, and 31) are to be disposed. FIG. 13 is a schematic drawing of a detail view of a portion of the pairing station 4050, and shows the pairing scanner 4065, a pairing robot end effector 4125, the pairing platforms 4070 of the pairing station 4050, and slots 4130 of the pairing platforms 4070.

### A. Pairing Station of Third Module

With reference to FIGS. 11 to 13, the pairing robot 4005 is configured to pick up and remove the first tubes 1005 from the first inserts 1055 at the ends of the second module conveyor channels 3045 (shown in FIGS. 8 and 9), and to hold the first tubes 1005 in front of the pairing scanner 4065. The pairing scanner 4065 is configured to read identifying information on each first tube 1005 and to communicate the identifying information to the controller 7000 for a verification process to identify first tubes 1005, including paired first tubes 1005 that contain blood samples from the same patient, unpaired first tubes 1005 that contain one blood sample from one patient, and dummy tubes 1005, which do not contain a blood sample, and with which unpaired first tubes 1005 are coupled.

The verification process may include the controller 7000 storing the received identifying information of each first tube 1005 in a database, and retrieving data associated with the identifying information, for example, a patient identifier, a patient name and/or a patient date of birth, from the memory 7005, and retrieving data associated with any previously scanned first tubes 1005. The verification process may then include comparing the data of one first tube 1005 with the data of the previously scanned first tubes 1005, and, based on the comparison, the controller 7000 may instruct the pairing robot 4005 to place the first tube 1005 removed from the first insert 1055 in a slot 4130 on one of the pairing platforms 4070 that is adjacent to a paired first tube 1005 or that has an open adjacent slot 4130 for receiving the paired first tube 1005. In a case in which the data of one first tube 1005 matches data of a previously scanned first tube 1005, the controller 7000 may instruct the pairing robot 4005 to place the one first tube 1005 in the slot 4130 adjacent to the previously scanned first tube 1005 having the matching data. And, in a case in which the data of the one first tube 1005 does not match data of any previously scanned first tubes 1005, the controller 7000 may instruct the pairing robot 4005 to place the first tube 1005 into a slot 4130 that has an empty adjacent slot 4130 (that is, the unmatched first tube 1005 is placed by itself into one slot 4130 of a pair of slots 4130 on the pairing platform 4070). This would leave an empty adjacent slot 4130 available for later receiving a subsequent first tube 1005 for which the data matches that of the one first tube 1005.

The first tube 1005 placed into the slot 4130 with an adjacent empty slot 4130 may be designated by the controller 7000 as an “unpaired first tube,” and may remain so designated unless and until another first tube 1005 is scanned and confirmed to have matching data. In a case in which a first tube 1005 with matching data is subsequently scanned, the controller 7000 may change the designation of the first-placed first tube 1005 to “paired first tube.” In some embodiments, following subsequent tube handling, the controller 7000 may instruct the pairing robot 4005 to place first tubes 1005 on a sequestration tray (not shown) if the first tube 1005 is identified but not expected by controller 7000 or a first tube 1005 having been placed in the pairing platform 4070 is missing its corresponding pair after the its first insert 1055 has been emptied. The sequestration tray may be located next to the pairing platforms 4070 and/or next to the first turntable 4025. This verification process may ensure that any unexpected or unpaired first tubes 1005 are identified for sequestration and/or identified for downstream processing, particularly splitting of isolated plasma in the fifth module 6000. Also as part of the verification process, the controller 7000 may also identify dummy tubes 1005 among the first tubes 1005 picked up from a first insert 1055, and the controller 7000 may instruct the pairing robot 4005 to place the dummy tubes 1005 in a dummy tube bin (not shown) for disposal or reuse following the tube handling process.

The slots 4130 of the pairing platforms 4070 may be arranged in a grid, for example, a 4 by 5 grid of slots, such as shown in the accompanying figures. Although a 4 by 5 grid is shown in the exemplary embodiments, any suitable even number of slots may be used. A first tube 1005 of each pair of first tubes 1005 may be placed in an outer slot 4130, and another first tube 1005 of a pair of first tubes 1005 may be placed in an inner slot 4130, inside of and adjacent to the outer slot containing the first tube 1005. Unpaired first tubes 1005 may be placed in the outer slots 4130, with no accompanying, paired first tube 1005 being placed adjacent to those unpaired first tubes 1005. The locations of the paired first tubes 1005 and the unpaired first tubes 1005 in the pairing platforms 4070 may also be stored, e.g., in memory 7005, as information associated with the first tubes 1005. Next, the first tubes 1005 are ready to be moved to the excising station 4055.

### B. Excising Station of Third Module

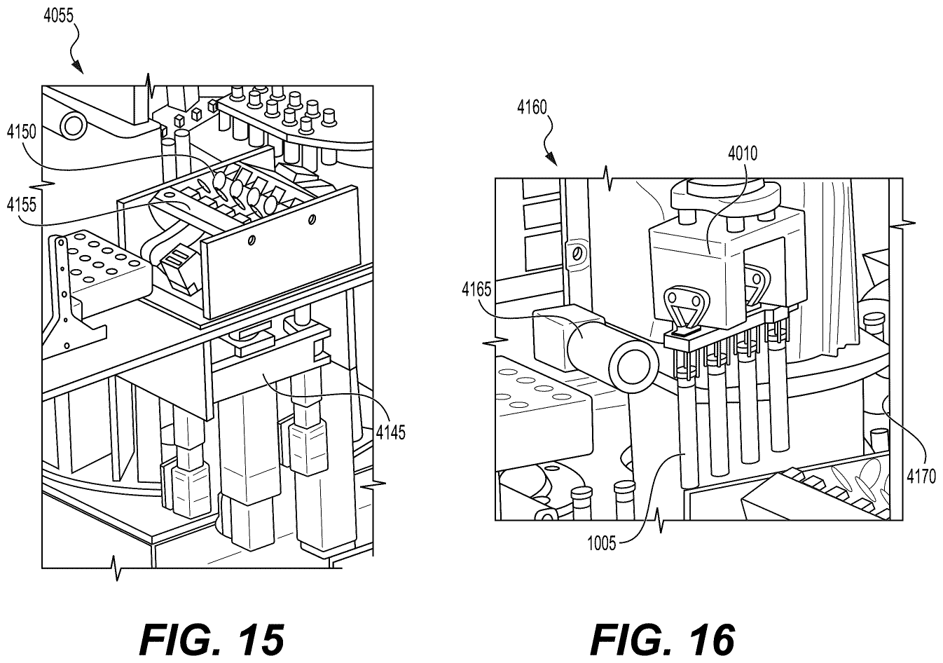

Aspects of the excising station are shown in FIG. 12, described above, and in FIG. 14 and FIG. 15, and the excising process will be described with reference to these figures. FIG. 14 is a schematic drawing of an excising robot end effector 4135, including tube grips 4140 for grasping first tubes 1005 from one of the pairing platforms 4070. FIG. 15 is a schematic drawing of a detail view of the excising station 4055, showing a lift 4145, a plurality of blades 4150, and a plurality of blade actuators 4155 of the excising station 4055.

During the excising process, the excising robot 4010 is configured to pick up a subset of first tubes 1005 from the pairing platform 4070 (FIG. 14), and place the first tubes 1005 on the lift 4145 of the excising station 4055 (FIG. 15). The lift 4145 may also be referred to as an excising platform. In the embodiment shown in FIGS. 12, 14, and 15, the excising robot 4010 is capable of picking up a row of the first tubes 1005, e.g., a row of four first tubes of the 4 by 5 grid at a time, however, the excising robot 4010 may be configured for picking up a lesser or a greater number of first tubes 1005. In other aspects, the number of first tubes 1005 that the excising robot 4010 is configured to pick up may or may not correspond to the number of first tubes 1005 in a row of the pairing platform 4070. To pick up the first tubes 1005 four at a time, the excising robot end effector 4135 may have four sets of tube grips 4140, e.g., with each set containing four tube grips 4140. The tube grips 4140 may move from a spaced-apart position, which allows for the excising robot end effector 4135 to lower the tube grips 4140 around upper ends of the first tubes 1005 on the pairing platforms 4070, and a gripping position, in which the tube grips 4140 move toward each other to thereby grip the upper ends of the first tubes 1005 on the pairing platforms 4070. In other aspects, the tube grips 4140 may not move relative to one another and instead may be capable of flexing outward relative to one another in order to friction fit around a first tube 1005 as the tube grips 4140 are moved down onto a top portion of a first tube 1005. In some aspects, each set of tube grips 4140 may include one or more force or pressure sensors (not shown), or feedback sensors, that may be configured to detect the presence of a first tube 1005, e.g., when the tube grips 4140 are moved to the gripping position. In a case in which the force sensor does not detect the presence of a first tube 1005 in a given set of tube grips 4140, the excising robot 4010 may issue a notification to the controller 7000. As an example, a first tube 1005 may correctly not be present if an unpaired first tube 1005 has been placed in the pairing platform 4070 and no paired first tube 1005 has been added (i.e., there is an empty slot 4130). As another example, a first tube 1005 may not be present in a case in which a first tube 1005 breaks. In these instances, the excising robot 4010 may output the notification to the controller 7000 that no first tube 1005 is present, and the controller 7000 may either store this information in the memory 7005, determine whether there should or should not be a first tube 1005 present, or outputs a notification to an operator, e.g., via the user interface 8000, to check the third module 4000 for a broken or dropped first tube 1005.

The blade actuators 4155 may moveably support the blades 4150, and in particular, may be configured to move, e.g., rotate, the blades 4150 from a first position, in which the blades 4150 are relatively spaced apart from each other (that is, the blades 4150 are spaced at a first distance), to a second position, in which the blades 4150 are relatively closer together (that is, the blades 4150 are spaced at a second distance smaller than the first distance). In the embodiment shown in FIG. 15, the excising station 4055 may include eight blades 4150, including four sets of two blades 4150 facing each other, and eight blade actuators 4155, one blade actuator 4155 for each of the blades 4150. A greater or lesser number of blades 4150 may be used in the excising station 4055, and the number of blades 4150 (and corresponding number of blade actuators) may be based on a number of first tubes 1005 supported by the lift 4145 and/or picked up at a time and transferred by the excising robot 4010.

Once the four first tubes 1005 have been placed on the lift 4145, the blade actuators 4155 may move, e.g., rotate, the blades 4150 from the first position to the second position. In being moved by the blade actuators 4155 to the second position, the blades 4150 may move to a fixed point, so that a distance between each pair of blades 4150 is controlled, to ensure sufficient contact with the first tubes 1005 to scrape off labels on the first tubes 1005, if present, without causing damage or compromising the integrity of the first tubes 1005. In some aspects, the blades 4150 may be spaced apart from each other in the second position a distance that is approximately equal to, or slightly less than, a width of a first tube 1005. Then, the lift 4145 may move the four first tubes 1005 upward, so that the length of each of the first tubes 1005 passes through a corresponding pair of the blades 4150. The lift 4145 may include a force sensor (not shown), or a feedback sensor, such that if a force counteracting the upward movement of the lift 4145 exceeds a predetermined limit, the sensor outputs a notification to the controller 7000, which may stop the excision process, move, e.g., rotate, the blade actuators 4155 so that the blades 4150 are in the first position, stop the lifting of the first tubes 1005, and/or issue a notification to an operator to check the blades 4150 and/or the blade actuators 4155. This may help to protect against the breaking of one or more first tubes 1005. As examples, if the blade actuators 4155 move, e.g., rotate, the blades 4150 too far inward, or too close to an opposing blade 4150 of a pair of blades 4150, the blades 4150 may exert an excessive force on the lift 4145 as it moves upward, so the sensor outputs the notification. In some cases, the controller 7000 will output a notification to an operator to check the blade actuators 4155 and/or blades 4150 for calibration issues or for damage.

Although it is described above that the lift 4145 pushes the first tubes 1005 up through the pairs of blades 4150 to excise portions of labels on the first tubes 1005, in other aspects, the lift 4145 may alternatively move the first tubes 1005 down relative to the pairs of blades 4150, with the angles of the pairs of blades 4150 adjusted accordingly. In yet other embodiments, the first tubes 1005 may remain stationary on the lift 4145, and the blade actuators 4155 may be configured to move the pairs of blades 4150 up or down relative to the first tubes 1005 to excise portions of labels on the first tubes 1005. In still other embodiments, both the pairs of blades 4150 and the first tubes 1005 may be moved in opposite directions relative to one another in order to excise portions of labels on the first tubes 1005.

Each first tube 1005 passes through a pair of two blades 4150, the blades 4150 being on opposing sides of the first tube 1005. The blades 4150 may be razors, and may be disc-shaped or any other suitable shape, so long as they have at least one sharp edge. In a case in which the blades 4150 are disc-shaped, the blades 4150 may be rotated periodically, in order to inhibit excessive wear on a particular point on the blades 4150. Alternatively, in the case in which the blades 4150 are disc-shaped, the blades 4150 may be spun (that is, continuously rotated) about a center thereof, which may also inhibit excessive wear on a particular point on the blades 4150.

As each first tube 1005 passes through the blades 4150, material, such as labels, on opposing sides of an exterior surface of the first tube 1005, if present, may be scraped off, creating a “window” through the first tube 1005. As a result, a level or a height of each separated layer of liquid in the first tubes 1005 may be visible through the so-formed window, for use in a subsequent imaging process. More specifically, building on the example of blood samples noted above, the window of each first tube 1005 may allow for visualizing a height of a plasma layer L1, a height of a red blood cell layer L3, and a height of a buffy coat red layer L2 in between the plasma layer L1 and the red blood cell layer L3, these layers resulting from the first spin carried out in the second module 3000. More generally, the window created on opposing surfaces of each first tube 1005 may allow for visualizing the liquid within each first tube 1005 and whether a component of that liquid has sufficiently been isolated.

In some embodiments, a suction source (not shown), such as a vacuum, may be located under the excising station 4055, to suction scraped material, such as labels, downward and away from the blades 4150 and the lift 4145. This may help to prevent debris from building up in the excising station 4055, so that the excising station 4055 can process the next set of first tubes 1005 picked up by the excising robot 4010.

As noted above, the excising robot end effector 4135 may include a force sensor, and if the sensor does not detect a force when the excising robot 4010 retrieves the first tubes 1005 from the excising station 4055, a notification may be send to the controller 7000 to indicate a first tube 1005 is missing. This may happen, for example, if a first tube 1005 breaks during the excising process.

After the excising process, the first tubes 1005 may be ready for imaging.

### C. Imaging Station of Third Module

An imaging station 4160 and the imaging and imaging analysis processes will be described with reference to FIGS. 16 and 17. FIG. 16 is a schematic drawing of a detail view of the imaging station 4160 of the third module 4000, and shows an imaging device 4165, a backdrop 4170, and the excising robot 4010 holding first tubes 1005 in between the imaging device 4165 and the backdrop 4170. FIG. 17 is a schematic drawing of a detail view of an exemplary user interface 8000 of the controller 7000, which can optionally be shown during the imaging analysis process.

During the imaging process, the excising robot 4010 may be configured to pick up the four first tubes 1005 from the lift 4145 and move the first tubes 1005 in between the imaging device 4165, such as a camera, and the backdrop 4170. The backdrop 4170 may be a plain back-lit backdrop. The excising robot 4010 may be configured to hold the four first tubes 1005 so that the windows where any label has been removed are facing and aligned with the imaging device 4165 and the backdrop 4170, such that, from the viewpoint of the imaging device 4165, the liquid within each of the four first tubes 1005, e.g., the levels of the layers of the blood sample, are visible. Then, the imaging device 4165 may be configured to capture an image 4175 (FIG. 17) of the first tubes 1005, and output the captured image to the controller 7000 for an image analysis.

Although FIGS. 16 and 17 and the accompanying text describe the excising robot 4010 being configured to pick up and image four first tubes 1005 at a time, any suitable number of first tubes 1005 may be imaged at a time. For example, one, two, three, or more than four first tubes 1005 may be imaged at a time.

In some aspects, imaging device 4165 and/or an associated sensor may be configured to detect whether the windows of the first tubes 1005 are aligned with the imaging device 4165 prior to, during, or following the image capture. For example, a light, e.g., a light emitting diode (LED), may be shone in the direction of the first tubes 1005 in line with the imaging device 4165. One or more sensors on an opposite side of the first tubes 1005 may be configured to detect whether the light passes through the first tubes 1005, which would indicate that the windows of the first tubes 1005 are accurately positioned. Alternatively, if the one or more sensors do not detect light having passed through one or more of the first tubes 1005, this would indicate that the window of at least one of the first tubes 1005 is not aligned with the imaging device 4165. If this occurs, then the misalignment may be communicated to the controller 7000, which may reposition the excising robot 4010, control the excising robot 4010 to rotate one or more of the first tubes 1005, and/or send an alert to an operator that one or more of the first tubes 1005 in the imaging station 4160 of the third module 4000 is not aligned.

FIG. 17 shows the captured image 4175 output by the imaging device 4165 on the user interface 8000 via a display 8005. The output of the image analysis may or may not be displayed on the user interface 8000 via a display 8005. In FIG. 17, the layers of the liquid in the first tubes 1005 captured in the image are shown using different types of fill. As an example in which the liquid is blood, in each first tube 1005 in the image, the plasma is shown as the top layer L1 with no fill, the buffy coat red layer L2 is below the plasma layer L1 with hatching fill, and the red blood cell layer L3 is shown below the buffy coat red layer L2, with dot fill. During the image analysis process, for each first tube 1005, the controller 7000 may be configured to analyze the captured image 4175 and identify a height of each of the layers of the blood, and store this information in the memory 7005.

The image analysis may also include running a program, using the controller 7000, which may be configured to evaluate an amount of red within the plasma layer L1 of the imaged first tubes 1005 in the case of blood samples. If a plasma layer L1 of a given first tube is too red, this may mean that the blood sample is homolycized, and in that case, the image analysis may be configured to output a notification that the first tube 1005, and its pair, should be sequestered, as the blood sample may not be of sufficient quality for processing downstream of the automated liquid processing system 1000. The sequestration of the first tube 1005, and its pair, may also occur if the image analysis is unable to properly identify the layer interfaces, previously described, expected in the first tube 1005.

To perform the color analysis, the program may include comparing the portion of the image 4175 showing the plasma layer L1 to a color chart or to a color value, stored in the memory 7005, and assessing a redness level of the plasma layer L1 compared to the color chart or to the color value. For example, in a case in which a color chart is used, the shade of red on the color chart that is closest to the shade of red in the image corresponding to the plasma layer L1 may be identified. The result of this comparison may be termed a “hemolysis grade,” and if the shade of red of the plasma layer L1 is too dark (or too severe), the sample may be identified as failing the imaging analysis. The hemolysis grade may be used to identify a quantity of hemoglobin per mL (for example, X g of hemoglobin per mL of plasma), using the color chart as a guide. The value of X may be predetermined and modified as needed. The program used to measure the hemolysis grade may be a trained software program, trained using previously-acquired images of first tubes 1005, specifically showing plasma layers L1, and the color chart.

In a case in which the image analysis cannot be completed because of labels remaining on the exterior of the first tube 1005, for example, the image analysis program may send a notification to the controller 7000 indicating the first tube 1005 is not usable or to check the blades 4150 of the excising station 4055, as they may be worn and not sufficiently contacted the first tubes 1005 to scrape off the material and form the window.

The image analysis may also provide confirmation of the presence of one or more dummy tubes 1005, in a case in which no liquid levels are detected in one or more of the first tubes 1005 of a captured image 4175, or only a clear dummy liquid is detected. The image analysis similarly may confirm the presence of unpaired first tubes 1005, in a case in which a captured image 4175 includes less than four first tubes 1005 (that is, there is an empty space in one or more of the spaces where a first tube 1005 should be). The image analysis may also confirm presence of first tubes 1005 and proper removal of first tubes 1005 from the pairing platform 4070. If a captured image 4175 is missing an expected first tube 1005, the image analysis may be configured to output a notification that a first tube 1005 was not properly transferred from the pairing platform 4070.

Following image analysis, the first tubes 1005 may be ready for transfer to the third module liquid handling station 4015.

### D. Liquid Handling Station of Third Module

The third module liquid handling station 4015 and liquid handling process will be described with reference to FIGS. 18 to 30.

### 1. Loading of First Turntable of Third Module

FIG. 18 is a schematic drawing of a detail view of the excising robot end effector 4135 placing the first tubes 1005 in pairs on the first turntable 4025 of the third module 4000, after an image 4175 of the first tubes 1005 has been captured. That is, after the imaging device 4165 captures the image 4175, the excising robot 4010 may be configured to move the four first tubes 1005 (or the number of first tubes 1005 held by the excising robot 4010 if not four) to the first turntable 4025, and to place the first tubes 1005, two at a time, into two adjacent slots 4075 on a portion of the first turntable 4025 that is in a loading position. The slots 4075 on the first turntable may be arranged in a 2 by X configuration, with X being an integer. In the embodiment shown in FIG. 18, the slots 4075 are in a 2 by 8 configuration, such that 8 pairs of first tubes 1005 can be placed in the portion of the first turntable 4025. The number of slots 4075 provided on the first turntable 4025 may be based, at least in part, on an overall size of the first turntable 4025, and the portion thereof, on a size of the first tubes 1005, and/or on the maximum intended processing volume of liquid samples through the system. After the first tubes 1005 have been loaded into the first turntable 4025, they may be ready for decapping.

### 2. Decapping of First Tubes

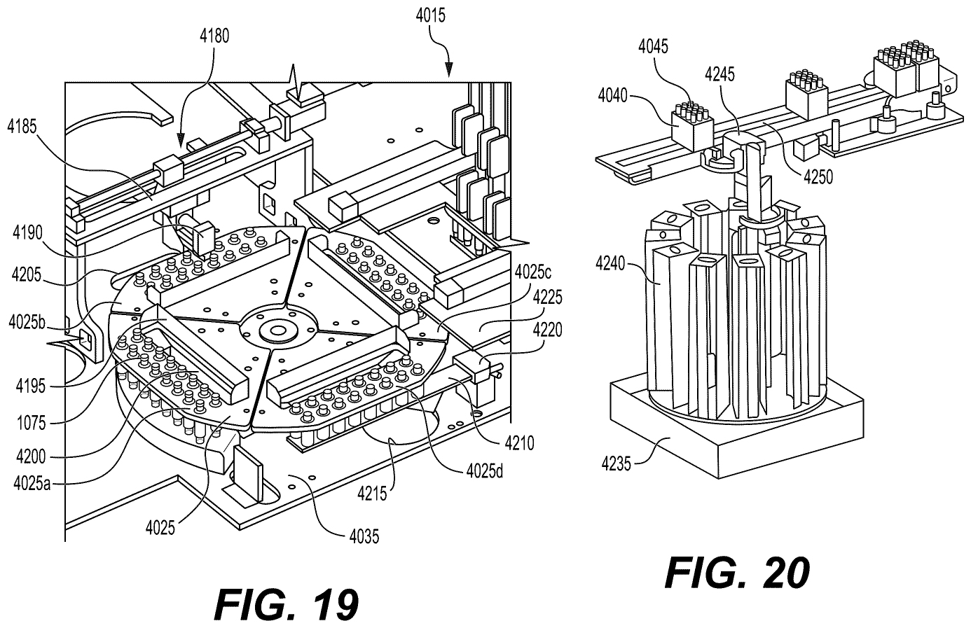

FIG. 19 is a schematic drawing of the first turntable 4025 and a decapping station 4180 of the third module 4000, and shows a third module decapping gantry robot 4185, a third module decapping end effector 4190, a cap stop 4195, a cap disposal opening 4200 in the first turntable 4025. A cap disposal opening 4205 is shown in the third module deck 4035, as well as a tube disposal opening 4215 in the third module deck 4035. FIG. 19 also shows a tube clear sensor 4220, a stay 4210, and the liquid handling station 4015. FIG. 19 also shows a drip tray 4225. FIG. 19 further depicts the positions of the first turntable 4025, through which the four portions of the first turntable 4025 rotate, namely, the loading position 4025a in which the first tubes 1005 are loaded into the first turntable 4025 by the excising robot 4010, as described above, a decapping position 4025b in which first tube caps 1075 are removed from the first tubes 1005, a liquid handling position 4025c in which plasma is aspirated from the opened (i.e., uncapped) first tubes 1005, and a tube disposal position 4025d in which the first tubes 1005 are moved to a first tube disposal container 4230 (shown in FIG. 42B), such as a sharps container or a biohazard disposal container.

The first turntable 4025 may be configured to rotate, so that the portion of the first turntable 4025 holding the first tubes 1005 is in the decapping position 4025b. Then, once the first tubes 1005 are in the decapping position 4025b, the third module decapping gantry robot 4185 may move the decapping end effector 4190 first to a central position, in between a pair of first tubes 1005 on the portion of the first turntable 4025, then in a first direction, for example, outward from a center of the first turntable 4025, and then in a second direction, opposite to the first direction, for example, inward towards the center of the first turntable 4025, to push out/off the first tube caps 1075 (for example, rubber stoppers) in the first tubes 1005. The decapping end effector 4190 may then move back to the central position and subsequently move in between the next adjacent pair of first tubes 1005 on the portion of the first turntable 4025, and may repeat the movements in the first direction and the second direction to uncap the next pair of first tubes 1005. The decapping end effector 4190 may sequentially move in between adjacent pair of first tubes 1005 and then in the first direction and the second direction, until all first tube caps 1075 of the first tubes 1005 in that portion of the first turntable 4025 in the decapping position 4025b have been removed. The decapping end effector 4190 may, however, move in different directions and/or in a different order, in order to remove the first tube caps 1075 from the first tubes 1005. For example, the decapping end effector 4190 may move in the second direction and then the first direction, or may move from one end of the rows of first tubes 1005 to the other, or vice versa, or in any other suitable order. Additionally or alternatively, the decapping end effector 4190 may be wide enough so that a single actuation in the first direction or the second direction is able to decap multiple adjacent first tubes 1005.

Movement of the decapping end effector 4190 between pairs of first tubes 1005 and then inward and outward movement of the decapping end effector 4190 to remove the first tube caps 1075 may inhibit removed first tube caps 1075 from landing in between the pairs of first tubes 1005, where they may be harder to clear. Pushing the first tube caps 1075 towards or over the edge of the first turntable 4025 in the first direction to remove the first tube caps 1075 may facilitate disposal of the removed first tube caps 1075 in the cap disposal opening 4205 in the third module deck 4035. Pushing the first tube caps 1075 towards the center of the first turntable 4025 in the second direction to remove the first tube caps 1075 may facilitate disposal of the removed first tube caps 1075 in the cap disposal opening 4200 in the first turntable 4025. Further, movement of the decapping end effector 4190 between the pairs of first tubes 1005 and then outwards and inwards may provide for more efficient movement and may reduce the time needed for the decapping end effector 4190 to maneuver into position and push out first tube caps 1075. That said, the decapping end effector 4190 may move in any suitable manner to remove the first tube caps 1075 from each of the first tubes 1005.

Sensors (not shown) may be included and positioned relative to the first tubes 1005 to detect if any first tube caps 1075 remain on the first tubes 1005 once the decapping end effector 4190 has passed through each pair of first tubes 1005 in that portion of the first turntable 4025. If a first tube cap 1075 is detected on one of the first tubes 1005, a signal may be output to the controller 7000 to notify an operator that one or more first tube caps 1075 need to be removed from one or more of the first tubes 1005. The same sensor(s) or different sensor(s) may be configured to detect the presence of once or more first tube caps 1075 located on the turntable 4025, e.g., in between or to a side of first tubes 1005. In a case in which a first tube cap 1075 is detected by a sensor to a side of or in between first tubes 1005, a signal may be output to the controller 7000 to notify an operator that one or more first tube caps 1075 need to be removed from the portion of the first turntable 4025.

The removed first tube caps 1075 should, however, fall into either the cap disposal opening 4200 in the first turntable 4025 or into the cap disposal opening 4205 in the third module deck 4035 during the uncapping process. In addition, a wing piece (not shown) of the decapping station 4180, located under the first turntable 4025 may be configured to make multiple passes along that portion of the first turntable 4025 during or subsequent to operation of the decapping end effector 4190 to sweep any removed first tube caps 1075 into the cap disposal opening 4205 in the third module deck 4035. Incorporation of the cap disposal openings 4200 and 4205 and the wing piece may facilitate clearing of the removed first tube caps 1075 from the third module deck 4035 and from the first turntable 4025. Once the first tubes 1005 have been decapped, they may be ready to be moved to the third module liquid handling station 4015.

### 3. Supply and Loading of Third Module Aspirator Tips

FIG. 20 is a schematic drawing of a detail view of a third module tip rack hotel 4235 used to supply third module aspirator tips 4045 to components of the third module liquid handling station 4015. In particular, FIG. 20 shows the third module tip rack hotel 4235 holding a plurality of third module aspirator tip rack supports 4240, each of which may hold a third module aspirator tip rack 4040 containing a plurality of third module aspirator tips 4045 to be picked up by the third module liquid handling spanner 4020 (FIG. 23). In addition, FIG. 20 shows a third module aspirator tip rack loading mechanism 4245, and a third module aspirator tip conveyor belt 4250.

The third module aspirator tips 4045 may be, e.g., 5 mL, 4-inch aspirator tips, for example, however, aspirator tips 4045 of greater or lesser volumes or sizes may be used. The volume or size of the aspirator tips 4045 used in the third module liquid handling station 4015 may be selected based, at least in part, on a size of the first tubes 1005, a quantity of the first tubes 1005 loaded into the first turntable 4025, and/or a number of passes or liquid transfer to be performed by the third module liquid handling station 4015. Building on the specific example with the first tubes 1005, the 5 mL, 4-inch aspirator tips 4045 may reduce a number of passes to be made by the third module liquid handling spanner 4020, between the first turntable 4025 and the second turntable 4030, which in turn may reduce an amount of time required for transfer of liquid from the first tubes 1005 in the first turntable 4025 to second tubes 1010 in the second turntable 4030.

The third module aspirator tip rack hotel 4235 may be located in a bottom portion of the third module 4000, under the opening 4110 in the third module deck 4035 through which third module aspirator tips 4045 are supplied to the third module deck 4035, shown in FIG. 12. The third module aspirator tip racks 4040 stored in the third module tip rack hotel 4235 may be transferred by the third module aspirator tip rack loading mechanism 4245, from the third module aspirator tip rack supports 4240, onto the third module aspirator tip rack conveyor belt 4250. The third module aspirator tip rack conveyor belt 4250 may be an indexing conveyor belt, however, other types of conveying mechanisms may be used.

FIG. 21 is a schematic drawing of an upper portion of the third module tip rack hotel 4235 and the third module aspirator tip rack conveyor belt 4250. Specifically, FIG. 21 shows the third module aspirator tip rack loading mechanism 4245, the third module aspirator tip rack conveyor belt 4250, third module aspirator tip racks 4040 with third module aspirator tips 4045 loaded thereon, and a conveying direction of the third module aspirator tip racks 4040. In FIG. 21, the third module aspirator tip racks 4040 may be moved from the third module aspirator tip rack hotel 4235 to the third module aspirator tip rack conveyor belt 4250 by the third module aspirator tip rack loading mechanism 4245. Then, the third module aspirator tip racks 4040 may be moved in a conveying direction, shown by the arrow, toward the third module liquid handling station 4015.

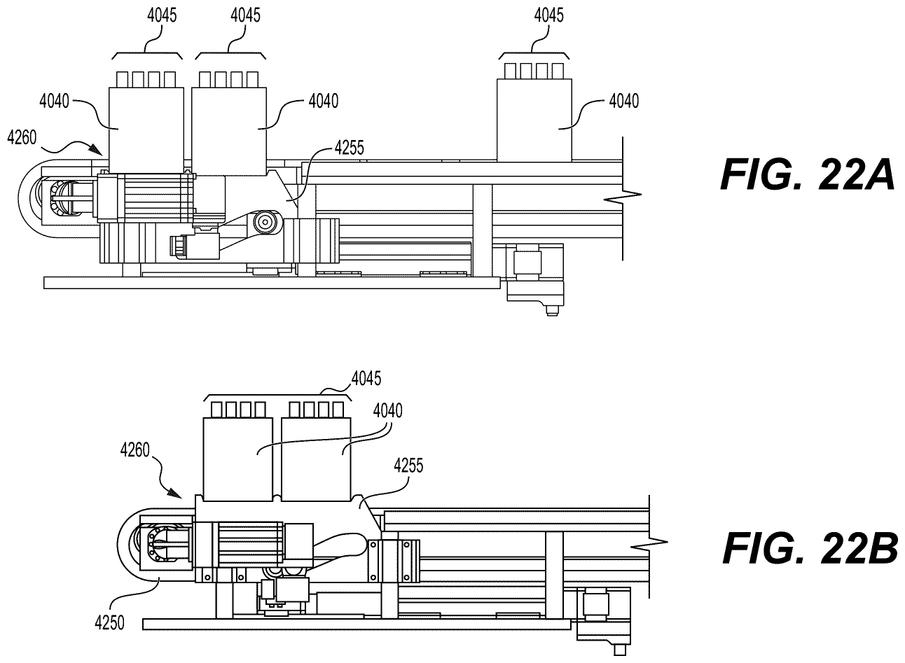

FIGS. 22A and 22B are schematic drawings of the third module aspirator tip racks 4040 carrying the third module aspirator tips 4045 on the third module aspirator tip conveyor belt 4250, within the third module 4000. In particular, FIG. 22A shows the third module aspirator tip racks 4040 on the third module aspirator tip rack conveyor belt 4250, on a lift 4255 at an output end 4260 of the third module aspirator tip rack conveyor belt 4250 that is in a low position, in which the third module aspirator tip racks 4040 are received, and FIG. 22B shows the lift 4255 in a raised position, in which the third module aspirator tip racks 4040 are lifted toward the third module liquid handling spanner 4020. The location at which the third module aspirator tip racks 4040 are lifted by the lift 4255, that is, the location of the output end 4260 of the third module aspirator tip rack conveyor belt 4250, may be in the aspirator tip loading and disposal opening 4120 in the third module deck 4035, shown in FIG. 12. This location is between the first turntable 4025 and the second turntable 4030 of the third module 4000, and the third module liquid handling spanner 4020 may pick up one or a plurality of the third module aspirator tips 4045 at or near this opening 4120, and dispose of used third module aspirator tips 4045 through the same opening 4120, or a different opening.

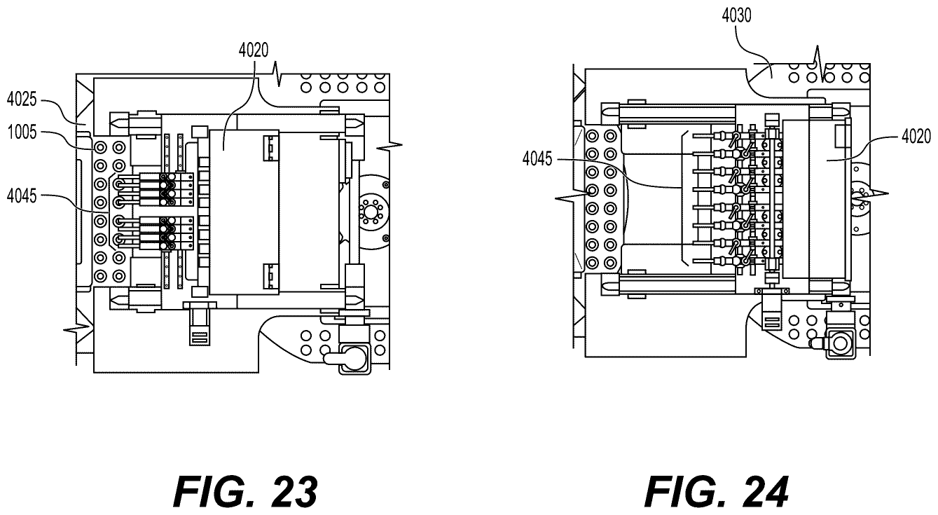

FIG. 23 is a schematic drawing of spacing between the third module aspirator tips 4045 once picked up by the third module liquid handling spanner 4020 of the third module liquid handling station 4015. In particular, FIG. 23 shows the third module aspirator tips 4045 loaded into the liquid handling spanner 4085, in a first spacing configuration after being picked up from the third module aspirator tip racks 4040 by the liquid handling spanner 4085, and positioned over the first tubes 1005 in the liquid handling position 4025c on the first turntable 4025. FIG. 24 is a schematic drawing of spacing between the third module aspirator tips 4045 within the third module liquid handling station 4015, and in particular, shows the third module aspirator tips 4045 in a second spacing configuration, for aspirating and dispensing plasma, as the third module aspirator tips 4045 move between the first turntable 4025 and the second turntable 4030. In the second spacing configuration, the third module aspirator tips 4045 may be spaced to correspond in position to the first tubes 1005 on the first turntable 4025 and second tubes 1010 loaded on the second turntable 4030, for aspirating and dispensing plasma from those tubes, respectively. In some aspects, the spacing between the third module aspirator tip racks 4040 and the spacing of the slots 4075 may be the same, and no movement or adjustment may be needed.

### 4. Supply of Second Tubes

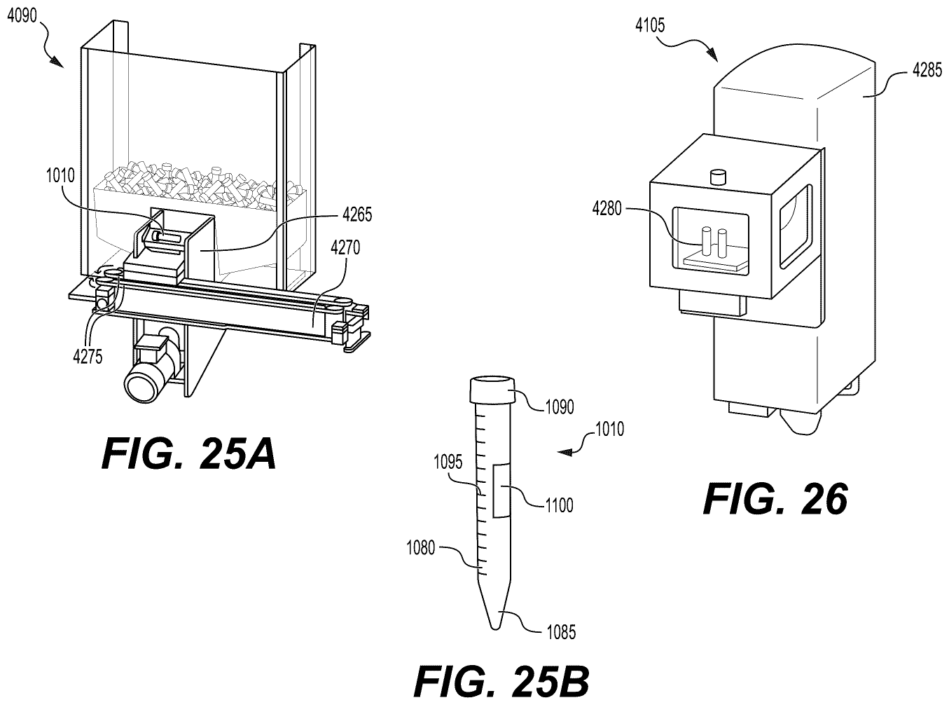

The supply and loading of second tubes 1010 will be described with reference to FIGS. 25A and 25B. FIG. 25A is a schematic drawing of the hopper 4090, a step feeder 4265, and a second tube conveyor 4270, for supplying second tubes 1010 to the third module liquid handling station 4015, and FIG. 25B is a schematic drawing of a second tube 1010. In particular, FIG. 25A shows the hopper 4090 with second tubes 1010 loaded therein, the step feeder 4265, and the second tube conveyor 4270, including two conveyor belts 4275, and two second tubes 1010 as they are dispensed by the step feeder 4265 into and oriented vertically by the two second tube conveyor belts 4275. And FIG. 25B shows the second tubes 1010, which have a tube body 1080 with a conical tip 1085 at a bottom thereof, a second tube cap 1090 at a top thereof, markings 1095 to indicate fill levels of liquids contained by the second tubes 1010, and a white space 1100. The second tubes 1010 may be, for example, 15 mL, 4-inch conical tubes, although other volumes and sizes of tubes may be used. The second tubes 1010 may be a different size relative to the first tubes 1005. For example, the second tubes 1010 may be relatively larger in volume or capacity as compared to the first tubes 1005. In the specific example referenced above, the second tubes 1010 have a greater volume than the first tubes 1005.

The hopper 4090 may be configured to receive the second tubes 1010 in bulk, and the step feeder 4265 may be configured to feed the second tubes 1010, one by one, from the hopper 4090 into the second tube conveyor 4270. The second tubes 1010 may be output by the step feeder 4265 in any orientation, but as the second tube 1010 reaches the two conveyor belts 4275 of the second tube conveyor 4270, the two conveyor belts 4275 may be configured to catch the second tube cap 1090 of each second tube 1010, thereby holding the second tube 1010, while the tube body 1080 falls downward in between the two conveyor belts 4275. A spacing between the two conveyor belts 4275 may be determined based on a maximum diameter of the tube body 1080 and a diameter of the second tube cap 1090. That is, the two conveyor belts 4275 may be spaced to allow the tube body 1080 to drop from the step feeder 4265 into the space between the two conveyor belts 4275, while the two conveyor belts 4275 hold the second tube cap 1090. By this arrangement, each second tube 1010 dispensed from the step feeder 4265 may fall in between the two conveyor belts 4275, into a vertical orientation, while the two conveyor belts 4275 hold the second tube 1010 by its cap 1090. Then, the second tube 1010 may be conveyed toward the gripping and marking device 4105.

### 5. Decapping and Marking of Second Tubes

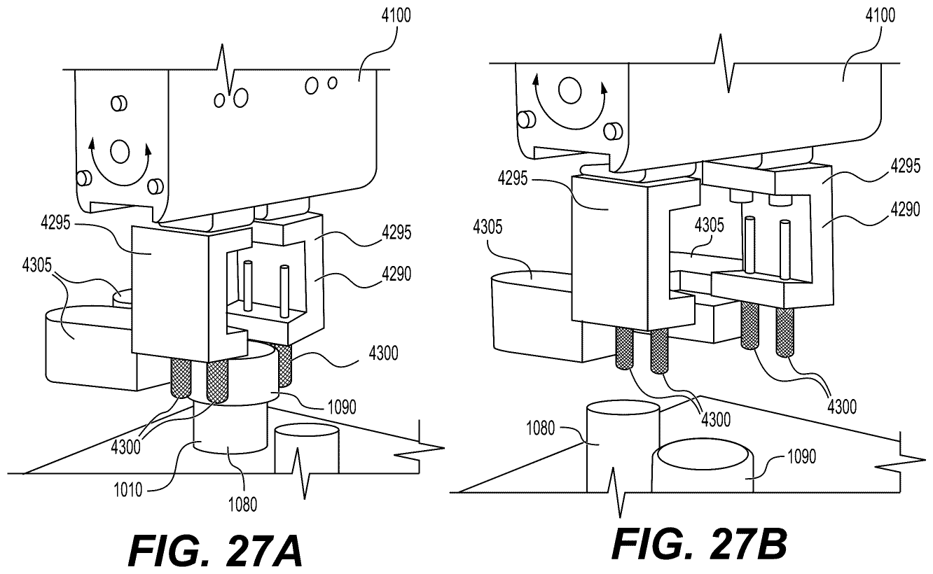

The decapping and marking of the second tubes 1010 will be described with reference to FIGS. 26, 27A, and 27B. FIG. 26 is a schematic drawing of the gripping and marking device 4105 of the third module 4000. The gripping and marking device 4105 has a tube grip 4280 configured to hold the tube bodies 1080 of the second tubes 1010, in conjunction with the second tube transfer robot 4100. The gripping and marking device 4105 also has a marking device 4285. FIGS. 27A and 27B are schematic drawings of a second tube transfer robot end effector 4290. The second tube transfer robot end effector 4290 may have a plurality, e.g., two, arm portions 4295, and each arm portion 4295 may have a plurality, e.g., two cap grip portions 4300 and one or more tube grip portions 4305. FIG. 27A shows the second tube transfer robot end effector 4290 in a closed position, gripping a second tube cap 1090 of a second tube 1010, and FIG. 27B shows the second tube transfer robot end effector 4290 in an open position, after the second tube cap 1090 has been removed from the second tube 1010.

In one embodiment, the second tube transfer robot 4100 may be configured to pick up one second tube 1010 by the cap 1090, using the cap grip portions 4300 of the second tube transfer robot end effector 4290, and place the tube body 1080 in a slot (not shown) within the third module deck 4035 that grips the tube body 1080 so that it cannot rotate within the slot. The second tube transfer robot 4100 then may be configured to rotate the cap 1090 in a counterclockwise direction to unscrew the cap 1090 and then lift the unscrewed cap 1090 upward. The second tube transfer robot 4100 may be configured to then rotate and lower to pick up the tube body 1080 from the slot, using the tube grip portions 4305 of the second tube transfer robot end effector 4290. In this embodiment, the cap 1090 may have an inner threaded surface, and a top end of the tube body 1080 may have an outer threaded surface. The inner threaded surface of the cap 1090 and the outer threaded surface of the tube body 1080 are engaged, that is, the cap 1090 and tube body 1080 are threadably connected, and the cap 1090 can be removed from the tube body 1080 by rotating or “unscrewing” the cap 1090.

After decapping of the second tube 1010, the second tube transfer robot 4100 may be configured to hold the tube body 1080 in front of a sensor (not shown) near the marking device 4285, and rotate the tube body 1080 until the sensor detects the free space on the tube body 1080, such as the white space 1100. Once the sensor detects the white space 1100, the second tube transfer robot 4100 may stop rotating the tube body 1080, and may lower the tube body 1080 into the tube grip 4280 of the marking device 4285. The marking device 4285 may then add identifying information to the white space 1100 on the tube body 1080 held in the tube grip 4280. As an example, the sensor may be a camera, and the marking device 4285 may be an etcher configured to etch a barcode onto the white space 1100 of each of the tube bodies 1080. Other types of marking devices, such as devices that print and apply labels with glue or other adhesive may be used. In addition, other types of identifying information other than barcodes may be used (e.g., applied, etched, or otherwise provided onto the tube bodies 1080), such as QR codes, alphanumeric symbols, sequences, identification chips, colors, or any other suitable label for identification. As noted above, the marking device 4285 may add barcodes, as an example of the identifying information, however the identifying information may be other types of information.

After the second tubes 1010 have been marked, the second tube transfer robot end effector 4290 may be configured to lift each tube body 1080 out of the tube grip 4280 of the gripping and marking device 4105, and move and transfer the tube body 1080 and the respective cap 1090 to the second turntable 4030 for liquid handling. The marking device 4285 may output the added identifying information for each second tube 1010 to the controller 7000, and based on this output and the subsequent movement/positioning of the second tube transfer robot 4100, the controller 7000 may be configured to register and/or track and store the location of each labeled second tube 1010 in the second turntable 4030.

Although the decapping and marking of the second tubes 1010 is described above in the order of decapping then marking, the process may be switched, in that the second tubes 1010 may first be marked and then decapped. In still other aspects, the second tubes 1010 received by the third module 4000 may be pre-labeled and scanned instead of labeled as described above. In other aspects, the second tubes 1010 may be received by the third module 4000 already uncapped, and the third module 4000 may not perform uncapping.

### 6. Loading of Second Tubes

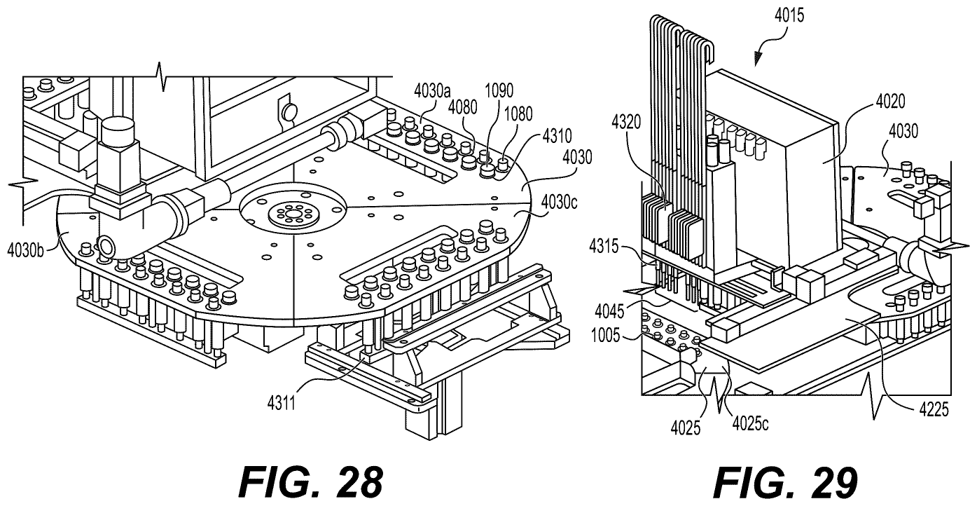

FIG. 28 is a schematic drawing of the second turntable 4030 of the third module 4000, and shows positions through which four portions of the second turntable 4030 rotate, namely, a loading position 4030a, in which the second tubes 1010 and caps 1090 are loaded into the second turntable 4030, a liquid handling position 4030b, in which the plasma held by the third module aspirator tips 4045 is dispensed (or deposited) into the second tubes 1010, and which is shown in FIG. 31, and a recapping position 4030c, in which the caps of the second tubes 1010 are placed back on the second tubes 1010. FIG. 28 also shows an actuating tube holder 4311, near the portion of the second turntable 4030 in the recapping position 4030c, and discussed in more detail below with respect to the fourth module 5000.

The second turntable 4030 has a plurality of tube slots 4080 and a plurality of cap slots 4310 or carve outs, which are relatively shallow compared to the tube slots 4080, and which are adjacent to and spaced radially inside of the tube slots 4080, relative to a center of the second turntable 4030. The tube slots 4080 are configured to receive the tube bodies 1080 of the second tubes, and the cap slots 4310 are configured to receive caps 1090 of the second tubes 1010. The tube slots 4080 and the cap slots 4310 are collectively arranged in a 2 by X configuration, where X is an integer, with a tube body 1080 and a cap placed in 2 adjacent slots, and other tube bodies 1080 and corresponding caps 1090 placed similarly, in a line. In the embodiment shown in FIG. 28, the tube slots 4080 and cap slots 4310 are collectively in a 2 by 8 configuration.

As noted above, the controller 7000 is configured to store the locations of each labeled second tube 1010. Using this information, the controller 7000 may be configured to associate each second tube 1010 placed on the second turntable 4030 with a pair of first tubes 1005 loaded into the first turntable 4025. As an example, each pair of first tubes 1005 in a portion of the first turntable 4025 may be associated with one second tube 1010 in a portion of the second turntable 4030 by the controller 7000. In a case in which the portion of the first turntable 4025 has eight pairs of first tubes 1005, in pairs of slots 4075 designated one through eight, and the portion of the second turntable 4030 has eight second tubes 1010, designated one through eight, the controller 7000 associates the pair of first tubes 1005 in the first slots 4075 on the first turntable 4025 with the second tube 1010 in the first slot 4310 on the second turntable 4030, the pair of first tubes 1005 in the second slots 4075 on the first turntable 4025 with the second tube 1010 in the second slot 4310 on the second turntable 4030, and so on.

And, based on the verification process of the first tubes 1005 at the pairing station 4050 and/or based on the image analysis of the first tubes 1005 at the imaging station 4160, the controller 7000 may be configured to determine whether a second slot 4310 on the second turntable 4030 should remain empty (that is, no second tube 1010 will be placed in that second slot 4310). This may be the case where the verification process and/or the image analysis identifies an unpaired first tube 1005 (i.e., a single first tube 1005) that is placed in a first slot 4075 of the first turntable 4025, or in a case in which a dummy tube 1005 is placed in a first slot 4075 of the first turntable 4025, or in a case in which a first tube 1005 or was otherwise sequestered earlier in the process. By this arrangement, second tubes 1010 may only be provided for collecting plasma from pairs of first tubes 1005. In some embodiments, however, a second tube 1010 may be placed in a corresponding slot 4310 for an unpaired first tube 1005 in the first turntable 4025, and by this arrangement, second tubes 1010 may only be provided for collecting plasma from first tubes 1005, and will not be provided in slots 4310 on the second turntable 4030 corresponding to locations of dummy tubes 1005.

7. Aspiration from First Tubes

FIG. 29 is a schematic drawing of a detail view of the third module liquid handling station 4015, and shows the liquid handling spanner 4020 holding a plurality of third module aspirator tips 4045 over the first tubes 1005 in the portion of the first turntable 4025 in the liquid handling position 4025c. The third module liquid handling spanner 4020 may have a plurality of third module aspirator mounting portions 4315, which may be inserted into the third module aspirator tips 4045 on the third module aspirator tip racks 4040 (shown in FIGS. 20, 21, 22A, and 22B). The third module aspirator mounting portions 4315 may be sized to create a press fit within upper ends of the third module aspirator tips 4045.

The third module liquid handling spanner 4020 may also have a flowmeter 4320 above each third module aspirating mounting portion 4315, and each flowmeter 4320 may be configured to detect flow of a liquid as it is drawn into a corresponding third module aspirator tip 4045. If the flowmeter 4320 of a third module aspirator tip 4045 detects that no liquid is being drawn or suctioned into a given third module aspirator tip 4045, the flowmeter 4320 may be configured to output a notification to the controller 7000, which in turn may issue an error notification to an operator. As an example, the flowmeter 4320 may output such a notification when the flowmeter 4320 does not detect suction of liquid and instead, air is suctioned into the third module aspirator tip 4045. In other aspects, the flowmeter 4320 may output such a notification when the flowmeter 4320 detects insufficient flow of liquid into the third module aspirator tip 4045, or if both liquid and air are detected flowing into the third module aspirator tip 4045. Further, the third module liquid handling spanner 4020 may include connections (or connectors) between each of the third aspirator mounting portions 4315 and a suction source, such that a suction generated by the suction source is generated within the mounted third module aspirator tips 4045.

The liquid handling spanner 4020 may be configured to move the third module aspirator tips 4045 over a first row of first tubes 1005 in the portion of the first turntable 4025, and then the third module aspirator tips 4045 may be lowered into the first tubes 1005 of the first row. Then, based on instructions from the controller 7000 and the image analysis of the captured image 4175 of the first tubes 1005 in the first row showing a height of the various liquid layers within the first tubes 1005, the third module aspirator tips 4045 may aspirate a volume of an isolated liquid component, e.g., plasma, from each first tube 1005. The liquid handling spanner 4020 then may move the third module aspirator tips 4045 to the second turntable 4030, for dispensing of the aspirated plasma into second tubes 1010, as described in more detail below. The liquid handling spanner 4020 may then return the third module aspirator tips 4045 to the first turntable 4025, and lower them into the first tubes 1005 in the second row so that each third module aspirator tip 4045 is lowered into the first tube 1005 in the second row that is the pair of the first tube 1005 in which that third module aspirator tip 4045 was previously lowered into in the first row.

The same third module aspirator tips 4045 can be used in the associated pairs of first tubes 1005, without cross-contamination among the aspirator tips 4045, because the pairs of first tubes 1005 contain blood samples from the same patient and because the spacing of the third module aspirator tips 4045 is matched to that of each pair of first tubes 1005. That is, by moving the third module aspirator tips 4045 into the second spacing configuration shown in FIG. 24, the third module aspirator tips 4045 align with one pair of first tubes 1005 in the first turntable 4025 and one second tube 1010 in the second turntable 4030, and therefore do not pass over other first tubes 1005 or other second tubes 1010 with samples from different patients, which inhibits or prevents cross-contamination of the blood samples and the isolated liquid components, e.g., plasma.

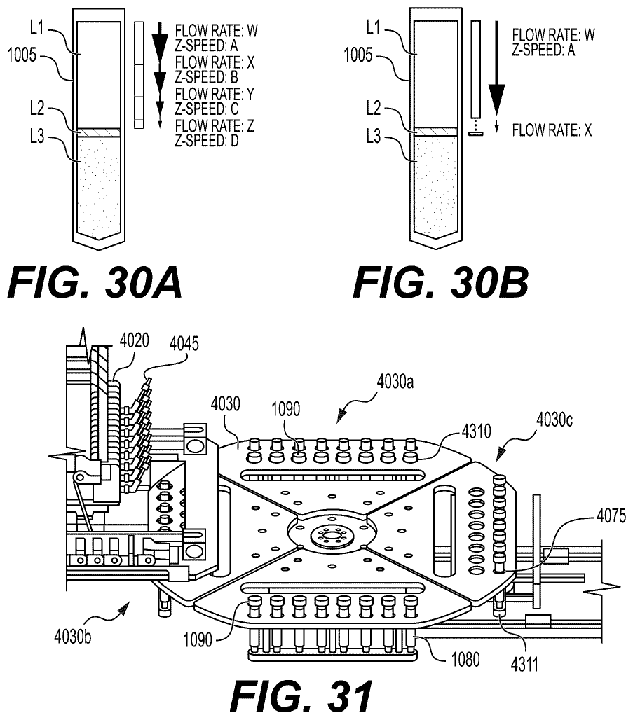

Based on instructions from the controller 7000, the third module aspirator tips 4045 may withdraw a volume of isolated liquid component, in this example, plasma, from each first tube 1005, the volume being determined by the controller 7000 based on the image analysis of the captured image 4175 of the first tubes 1005 in both the first row and the second row. FIGS. 30A and 30B are schematic drawings of first tubes 1005 and exemplary flow rates and z-speeds (the rate at which the third module aspirator tips move in a z, or vertical, direction within the first tubes 1005) for aspirating liquid from the first tubes 1005 using the third module liquid handling station 4015.

The flow rate of aspiration and the z-speed of the third module aspirator tips 4045 may be individually controllable, based on one or more of the image analyses of the captured images 4175 of the first tubes 1005 and the determined z-heights of the plasma layer L1, the buffy coat red layer L2, and the red blood cell layer L3, a diameter of an orifice size of the third module aspirator tips 4045, through which the plasma is to be aspirated, a density of the blood sample and/or of the plasma (for example, blood samples from different human or animal sources may have different densities), and/or the power of the suction source connected to the third module liquid handling station 4015 via a connector. One or both of the flow rate and the z-speed may be constant or varied. In addition or alternatively, the controller 7000 may also determine an amount (that is, a volume) of plasma to be aspirated from each first tube 1005 based on the z-heights of the plasma layer L1, the buffy coat red layer L2, and the red blood cell layer L3, determined from the image analysis, in order to set the flow rates and z-speeds.

FIG. 30A shows the plasma layer L1, the buffy coat red layer L2, and the red blood cell layer L3 of a first tube 1005, as determined based on the image analysis, as well as the determined varied flow rates at which the plasma in the first tube 1005 is to be aspirated, and the varied z-speeds at which the third module aspirator tip 4045 is to be moved down into the first tube 1005 to aspirate the plasma, with both the flow rates and the z-speeds being incrementally decreased as the third module aspirator tip 4045 is lowered into the first tube 1005. That is, in the embodiment shown in FIG. 30A, the third module aspirator tips 4045 may be moved at a varying speeds and may suction at varying speeds, relatively fast at first and slower and slower as the third module aspirator tips 4045 move further down in the z-direction, into the first tubes 1005. Although four different flow rates and four different movement speeds in the z-direction are shown in FIG. 30, fewer or more decreases in flow rates and movement speeds may be used. Further, because each first tube 1005 may contain different heights of layers L1, L2, and L3, the controller 7000 may be able to control the flow rate and/or speed in a z-direction of each of the third module aspirator tips 4045 individually. That is, individual third module aspirator tips 4045 may aspirate liquid from individual first tubes 1005 at distinct flow rates and/or may move at distinct speeds in the z-direction from the other third module aspirator tips 4045 loaded onto the third module liquid handling spanner 4020. In other aspects, each of the third module aspirator tips 4045 may not be individually controlled, and, for example, each of the third module aspirator tips 4045 may be set to the same suction force and/or speed in the z-direction, and the suction force and/or speed in the z-direction may be determined based at least in part on the smallest (shortest) plasma layer among the first tubes 1005 in one row of the first turntable 4025.

In the variable speed embodiment of FIG. 30A, the first flow rate W and first z-speed A may be relatively fast, while the last flow rate Z and last z-speed D may be relatively slow. Starting with a fast flow rate W and z-speed A may promote efficient aspiration, while ending with a slower flow rate Z and z-speed D may inhibit or prevent disruption of the buffy coat red blood layer L2 or the red blood cell layer L3.

FIG. 30B shows the plasma layer L1, the buffy coat red layer L2, and the red blood cell layer L3 of a first tube 1005, as determined based on the image analysis, as well as the determined varied flow rates at which the plasma in the first tubes 1005 is aspirated and the determined z-speed at which the third module aspirator tips 4045 are moved down into the first tubes 1005 to aspirate the plasma. That is, in the embodiment shown in FIG. 30B, the third module aspirator tips 4045 are moved in a z-direction at a constant speed, while the flow rate at which the plasma is suctioned up by the third module aspirator tips 4045 may vary. The controller 7000 may determine the z-heights at which distinct flow rates for each individual first tube 1005 start and stop (that is, the height at which one of the third module aspirator tip 4045 is placed, a specific flow rate of suction is administered), based on the image analysis of each individual first tube 1005. This may be done using an offset value of a height above the determined height of the buffy coat red layer L2, to perform aspiration (for example, a final or subsequent aspiration) at a relatively lower flow rate, so as not to disturb the buffy red coat layer L2 or the red blood cell layer L3. In addition or alternatively, the controller may determine z-heights and/or z-speed values and individually control movement of the third module aspirator tip 4045 for each first tube 1005 to move at those determined values, to withdraw as much of the isolated plasma in each first tube 1005 as possible, without significantly disturbing the buffy coat red blood layer L2 or the red blood cell layer L3.

Based on instructions from the controller 7000, the third module aspirator tips 4045 may withdraw a first volume or a first portion of isolated liquid component, in this example, plasma, from each first tube 1005 in a first pass, the volume being determined by the controller 7000 based on the image analysis of the captured image 4175 of the first tubes 1005 in both the first row and the second row, and then withdraw a second volume or a second portion of isolated liquid component, again in this example, plasma, from each first tube 1005 in a second pass. That is, the liquid handling spanner 4020 may aspirate the isolated liquid component from the first row of first tubes 1005 twice and from the second row of first tubes 1005 twice. Although the liquid handling spanner 4020 is described as performing multiple passes when aspirating from each pair of tubes, in other aspects, a single volume or a single portion of the isolated liquid component may be aspirated at once from each first tube 1005, so that the third module liquid handling spanner 4020 makes only two passes total (i.e., one for the first tube 1005, of a pair of tubes, in the first row, and one for the second tube 1005, of the pair of tubes, in the second row). In still other aspects, the isolated liquid component from both first tubes 1005 of a pair of tubes may be aspirated within a single pass.

In each pass, the controller 7000 may vary one or both of the flow rate at which the isolated liquid component is aspirated from the first tubes 1005 and the z-speed at which the third module aspirator tips 4045 are moved downward within the first tubes 1005. As one example, the flow rate may be constant (e.g., relatively high) when aspirating the first volume from each of the first tubes 1005, and the flow rate may be varied to decrease when aspirating the second volume from the same first tubes 1005 in the second pass. Alternatively, as another example, the flow rate may be variable when aspirating both the first volume and the second volume from each of the first tubes 1005, or the flow rate may be constant when aspirating both the first volume and the second volume from each of the first tubes 1005.

After aspirating the plasma from the first row of first tubes 1005 or the second row of first tubes 1005, the third module liquid handling spanner 4020 may be configured to move over the drip tray 4225, shown in FIGS. 19 and 29. The drip tray 4225 may be included to protect consumables 1035 that may be stored below the third module liquid handling station 4015 from contamination, e.g., if liquid drips or leaks from one or more of the third module aspirator tips 4045. Then liquid handling spanner 4085 may then move the third module aspirator tips 4045 to the second turntable 4030, for dispensing of the aspirated plasma into second tubes 1010.

8. Dispensing into Second Tubes

FIG. 31 is a schematic drawing of the second turntable 4030 of the third module 4000, with second tubes 1010 loaded into the tube slots 4075 and caps 1090 loaded into the cap slots 4310 in the loading position 4030a. FIG. 31 also shows the actuating tube holder 4311 adjacent to second tubes 1010 in the portion of the second turntable 4030 in the recapping position 4030c, and discussed in detail below with respect to the fourth module 5000.

The portion of the second turntable 4030 containing these second tubes 1010 and caps 1090 may be rotated, in a counter-clockwise direction in FIG. 31, to the liquid dispensing position, and the third module aspirator tips 4045 may be moved by the third module liquid handling spanner to be positioned over the second tubes 1010. Then, the plasma from the first pass of first tubes 1005 held by the third module aspirator tips 4045 may be dispensed into the second tubes 1010. The third module aspirator tips 4045 may be first lowered into an upper region of the second tubes 1010 to inhibit or prevent splatter and/or loss of any of the aspirated plasma. This process may be repeated with plasma from the second pass of first tubes 1005, so that the plasma from both first tubes 1005 of each pair of first tubes 1005 is combined into one second tube 1010 on the second turntable 4030. By this arrangement, a relatively large volume of isolated plasma from two blood samples of a single patient may be combined into the second tube 1010 for further processing.

Building on the example of using 5 mL aspirator tips and 15 mL tubes, as described above, the estimated volume of plasma dispensed into each 15 mL tube may be approximately 10 mL. Using estimated values, as an example of the liquid handling process, the third module aspirator tips 4045 may aspirate 2.5 mL of plasma from a first tube 1005 in the first row on the first turntable 4025, and then perform a second 2.5 mL aspiration of plasma from the second row first tube 1005, and transfer and dispense the aspirated 5 mL into the 15 mL tube. Thus, the 15 mL tube may contain an estimated 2.5 mL of plasma from the first tube 1005 in each row. In the first pass, the third module aspirator tips 4045 may be controlled to aspirate the plasma at a relatively high flowrate and a relatively high z-speed, capturing isolated plasma in the upper portion of the first tubes 1005.

And, in the second pass, the third module aspirator tips 4045 may be controlled to aspirate the plasma at a relatively low flowrate and a relatively low z-speed, to capture the remaining 2.5 mL isolated plasma in the first tubes 1005 without disturbing the buffy coat red layer L2 or the red blood cell layer L3. Thus, the 15 mL tube may contain an estimated 10 mL of plasma total, from a single patient's combined blood samples.

After the plasma has been dispensed into the second tubes 1010, the portion of the second turntable 4030 may rotate, in a counter-clockwise direction in FIG. 31, to the recapping position, where the fourth module robot 5015 may be configured to pick up and place the caps 1090 back onto the second tubes 1010 (i.e., to recap the second tubes 1010), pick up the recapped second tubes 1010, and move them into the fourth module 5000. Alternatively, if the third module 4000 is a stand-alone module, the first tubes 1005 may be received from or input by an operator, and/or the second tubes 1010 may be output to an operator.

### E. Disposal of First Tubes

Disposal of the first tubes 1005 will be described with reference to FIG. 19. After the plasma has been withdrawn from each of the first tubes 1005 in the liquid handling position of the first turntable 4025, the first turntable 4025 may rotate, in a clockwise direction in FIG. 19, to the tube disposal position 4025d. The stay 4210 may be included and may support the first tubes 1005 while the first turntable 4025 rotates to the tube disposal position 4025d. The stay 4210 may then move or retract to allow the first tubes 1005 to fall through the tube slots 4075 in the first turntable 4025, and through the tube disposal opening 4215 into the first tube disposal container 4230 under the third module deck 4035, as shown in FIG. 42B and described below. The tube clear sensor 4220, at one end of the stay 4210, may be configured to detect whether any first tubes 1005 remain in the slots 4075 of the portion of the first turntable 4025. If no first tubes 1005 are detected by the tube clear sensor 4220, the portion of the first turntable 4025 may be free to rotate to the loading position 4025a to receive new first tubes 1005 to repeat this process again. If first tubes 1005 are detected by the tube clear sensor 4220, a signal may be sent to the controller 7000, which may in turn issue an error notification to an operator. This arrangement may provide for automated disposal of the first tubes 1005 without the need for an operator to manually pick up the first tubes 1005 and place them in the first tube disposal container 4230.

### F. Disposal of Third Module Aspirator Tips

With reference to FIG. 12, after the third module liquid handling process has completed, the third module liquid handling spanner 4020 may move the third module aspirator tips 4045 over the aspirator tip disposal opening 4120 in the third module deck 4035. Then, the third module aspirator tips 4045 may be removed, passively or actively (e.g., forcibly ejected) from the aspirator tip mounting portions 4315 of the third module liquid spanner 4085, and may fall through the aspirator tip disposal opening 4120 into a third module aspirator tip disposal container 4325 located under the third module deck, as shown in FIG. 42B and described below.

### V. Fourth Module

The fourth module 5000 will be described with reference to FIGS. 32 to 35. FIG. 32 is a schematic drawing of a fourth module 5000 of the automated liquid processing system 1000. As noted above, the fourth module 5000 may be configured to spin the plasma in the second tubes 1010 to isolate the plasma a second time, e.g., from any residual red blood cells or contents of white blood cells and platelets. The fourth module 5000 may also be referred to as a centrifuging module. As also noted above, the fourth module 5000 includes fourth module centrifuges 5010, a fourth module robot 5015, and a fourth module pallet conveyor system 5020. FIG. 32 also shows a fourth module deck 5025, an upper door 1045 and lower doors 1050 of the fourth module 5000, and the openings 5005 in the fourth module deck 5025 to the fourth module centrifuges 5010. FIG. 33 is a schematic drawing of a top view of processing portions of the fourth module 5000 (with a roof of the fourth module 5000 being removed), and shows the fourth module robot 5015, two fourth module scanners 5030, the pallet conveyor system 5020, the openings 5005 in the fourth module deck 5025 to the fourth module centrifuges 5010, and a fourth module gantry robot 5035 having a fourth module gantry robot frame 5040 and a fourth module gantry robot end effector 5045.

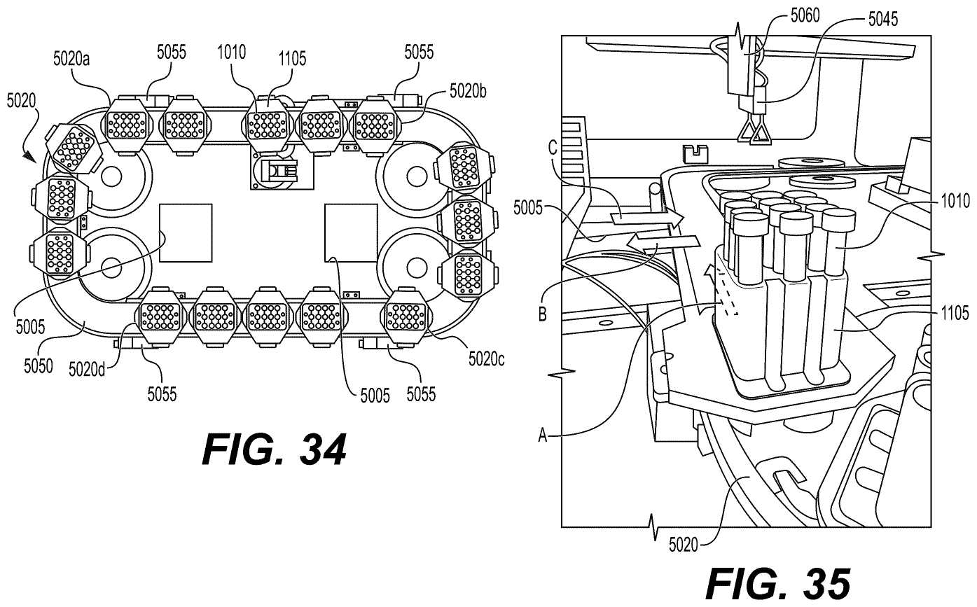

FIG. 34 is a schematic drawing of a top view of the pallet conveyor system 5020 of the fourth module 5000, as well as two of the openings 5005 to the fourth module centrifuges 5010. Specifically, FIG. 34 shows the pallet conveyor system 5020 including a fourth module conveyor belt 5050, a plurality of second inserts 1105 configured to hold the second tubes 1010, for example, the 15 mL tubes, and a plurality of pallet stops 5055, and FIG. 34 also shows various positions along the pallet conveyor system 5020 at which the second inserts 1105 are processed in a loop, namely, a loading position 5020a in which the second tubes 1010 are loaded into the second inserts 1105, an insert pick up position 5020b in which the fourth module gantry robot end effector 5045 picks up the second inserts 1105 and places them into one of the fourth module centrifuges 5010 via the openings 5005, an insert placing position 5020c, in which the fourth module gantry robot end effector 5045 places the second inserts 1105 following a spin cycle by one of the fourth module centrifuges 5010, and an unloading position 5020d, in which the second tubes 1010 are unloaded by the fifth module turntable load robot 6005.

FIG. 35 is a schematic drawing of the second insert with the second tubes 1010, as examples of the second tubes 1010, placed therein. FIG. 35 also shows a fourth module gantry robot arm 5060 as well as the fourth module gantry robot end effector 5045, a portion of the pallet conveyor system 5020, and arrows indicating movement directions of the second inserts 1105.

The fourth module robot 5015 is configured to pick up the caps 1090 on the portion of the second turntable 4030 in the third module 4000 in the recapping position 4030c, place the caps 1090 on the tops of the adjacent tube bodies 1080 in the same portion of the second turntable 4030, and rotate the caps 1090 to secure the caps 1090 to the tube bodies 1080, thus recapping the second tubes 1010. In addition, the actuating tube holder 4311 is configured to actuate to grip the tube bodies 1080 of the second tubes 1010 on the portion of the second turntable 4030 in the recapping position 4030c, to secure the tube bodies 1080 as the fourth module robot 5015 rotates the caps 1090 onto the tube bodies 1080. Although screw-on caps 1090 are described herein, other suitable caps, such as those that attach by friction fit, may be used, in which case the movements of the fourth module robot 5015 may be changed accordingly. The fourth module robot 5015 may then pick up the recapped second tubes 1010, and move and place them into a second insert 1105 located in the loading position 5020a on the conveyor belt 5050 of the pallet conveyor system 5020. The controller 7000, having stored locations of specific second tubes 1010 within the second turntable 4030, may register and/or track the placement of the specific second tubes 1010 into a specific second insert 1105.

Empty slots on the portion of the second turntable 4030 in the recapping position 4030c may result from the sequestration of unpaired first tubes 1005, dummy tubes 1005, and/or broken first tubes 1005 or second tubes 1010, in the third module 4000, and the fourth module robot 5015 will, therefore, only pick up and move second tubes 1010 containing plasma. The fourth module robot 5015 may fill each of the second inserts 1105 with second tubes 1010 containing plasma. That is, no empty second tubes 1010 are placed into the second inserts 1105, and any gaps that may have resulted from the identification of unpaired first tubes 1005 or dummy first tubes 1005 or broken first tubes 1005 in the third module 4000 may be omitted at this step.

The pallet stops 5055 of the pallet conveyor system 5020 may be designed to stop or hold positions of the second inserts 1105 for an amount of time, so that processes, such as loading of second tubes 1010 into second inserts 1105 in the loading position 5020a, may be completed. In other aspects, pallet stops 5055 may not be needed, and the conveyor system 5020 may stop moving until all processes at each position of the pallet conveyor system 5020 are complete. When a second insert 1105 is filled with second tubes 1010, the pallet conveyor system 5020 may move the second insert 1105 to the insert pick up position 5020b, where the fourth module gantry robot end effector 5045 may pick up the second inserts 1105, one at a time or, optionally, multiple at a time, and place the second inserts 1105 into the fourth module centrifuges 5010. As discussed previously, any suitable number of fourth module centrifuges 5010 may be included in fourth module 5000, and the number of centrifuges included may depend, at least in part, on the maximum intended processing volume of liquid samples through the system 1000.

With reference to FIG. 35, the second inserts 1105 may be first conveyed in a direction shown by a first arrow A, to a position that aligns with one of the openings 5005 in the fourth module deck 5025. Then the fourth module gantry robot end effector 5045 may pick up the second insert 1105 and hold it in front of one of the fourth module scanners 5030, for scanning and storing of identifying information of the second insert 1105, prior to placement into one of the fourth module centrifuges 5010. The fourth module scanners 5030 may be configured to read identifying information on the second inserts 1105, and this reading may be output to the controller 7000. The controller 7000 may be configured to store the received identifying information into the memory 7005, and may instruct the fourth module gantry robot 5035 to place the scanned second insert 1105 into one of the fourth module centrifuges 5010 via one of the aligned openings 5005 in the fourth module deck 5025. In the example shown in FIG. 35, the fourth module gantry robot end effector 5045 may move the second insert 1105 in a second direction, shown by a second arrow B, and lower it into the fourth module centrifuge 5010 below the opening. The controller 7000 may be configured to receive and/or store information regarding into which centrifuge, of the fourth module centrifuges 5010, the scanned second insert 1105 is placed. By virtue of tracking the second tubes 1010 and their placement into particular second inserts 1105, the controller 7000 may be able to track the second tubes 1010 through the fourth module 5000, as well.

In the embodiment shown in FIGS. 32 to 35, the fourth module 5000 has four fourth module centrifuges 5010, with each of the fourth module centrifuges 5010 holding four second inserts 1105 per spin cycle. The number of fourth module centrifuges 5010 may be greater than or less than four, and the number of second inserts 1105 that can be loaded into the fourth module centrifuges 5010 per spin cycle may be greater than or less than four. After a fourth module centrifuge 5010 is filled (in this example, after four second inserts 1105 have been loaded into a fourth module centrifuge 5010), the fourth module centrifuge 5010 performs a spin cycle, which further isolates plasma in the second tubes 1010. The timing of the spin cycles and control of the fourth module centrifuges 5010 may be similar to that described in reference to centrifuges 3010 of the second module 3000.

The inclusion of two sets of centrifuges (that is, one set of centrifuges 3010 in the second module 3000 and another set of centrifuges 5010 of the fourth module 5000) in the automated liquid processing system 1000 may allow samples processed by the automated liquid processing system 1000 to even further isolate components of the processed liquid. In the examples herein, this may mean that in the case of blood plasma isolation, two centrifugation cycles may allow for the pull down of a bit of extra sediment that may not be fully separated out with only one centrifugation cycle. This may facilitate the running of any downstream tests, etc., that may be performed on the isolated plasma.

After the spin cycle is completed, the second inserts 1105 may be picked up by the fourth module gantry robot end effector 5045 through the openings 5005 in the fourth module deck 5025, and placed back onto the conveyor belt 5050 of the pallet conveyor system 5020, at the insert placing position 5020c. With reference to FIG. 35, the fourth module gantry robot end effector 5045 may pick up the second inserts 1105 and move them in the direction of a third arrow C, placing them back onto the conveyor belt 5050.

In some embodiments, an end-of-day process may be performed, in which an operator may introduce second tubes 1010 containing another liquid (for example, water), into the second inserts 1105, in a case in which the last set of second tubes 1010 coming into the fourth module 5000 for spinning do not completely fill a second insert 1105 and/or additional second inserts 1105 need to be filled with second tubes 1010 and loaded into one of the fourth module centrifuges 5010 for load balancing. The operator may introduce the second tubes 1010 filled with the other liquid by opening the upper door 1045 of the fourth module 5000, and placing the second tubes 1010 into one or more second inserts 1105.

Following completion of the spin cycle and placement of the second inserts 1105 back onto the conveyor belt 5050, the second inserts 1105 may be conveyed to the unloading position 5020d, where the fifth module turntable load robot 6005 may pick up the second tubes 1010 one at a time or, optionally, multiple at a time, and move them into the fifth module 6000 for further processing. Alternatively, if the fourth module 5000 is a stand-alone module, the second tubes 1010 may be received from or input by an operator, and/or the second inserts 1105 may be output to an operator.

### VI. Fifth Module

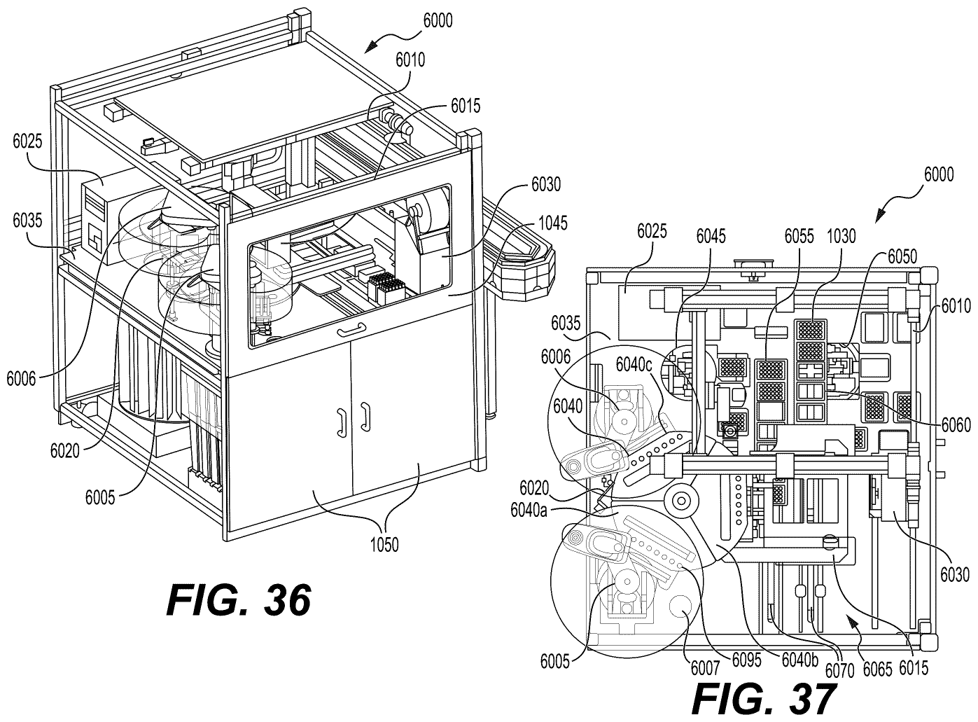

The fifth module 6000 will be described with reference to FIGS. 36 to 41. FIG. 36 is a schematic drawing of the fifth module 6000 of the automated liquid processing system 1000. As noted above, the fifth module 6000 is configured to batch and output the twice-isolated plasma (or other liquid component) into one or more output containers 1030, for subsequent processing. The fifth module 6000 may also be referred to as a batching module. As an example, the output containers 1030 may include one or both of micronic tubes 1015 and deep well plates (DWPs) 1025, although other types of containers may be used as the output containers 1030. In one exemplary use case described further below, a liquid patient sample may be aspirated into a DWP 1025 for further processing. If sufficient amounts of the liquid patient sample are available, then a portion of the liquid patient sample may also be aspirated into a micronic tube 1015, which may be set aside or stored (e.g., in cold storage) in the event that the liquid dispensed in the DWPs 1025 fails quality testing during subsequent processing, or back-up liquid patient sample is needed for any reason. In general, assuming that there is a sufficient amount of liquid to be divided between DWPs 1025 and micronic tubes 1015 (or other output containers 1030), then as much liquid as possible may be dispensed into the DWPs 1025, while reserving enough liquid for allocation to a micronic tube 1015 for back-up storage as would be useful, e.g., for re-processing a sample. As with the aspiration that occurs in the third module 4000, aspiration in the fifth module 6000 may occur in one pass or in multiple passes. For example, a first pass may allocate liquid to a first output storage container 1030 (e.g., DWP 1025), and a second pass may allocate liquid to a second storage container 1030 (e.g., micronic tube 1015).

FIG. 36 shows the fifth module turntable load robot 6005, the fifth module turntable unload robot 6006, a fifth module scanner 6020, a capping and decapping device 6025, the fifth module gantry robot 6010, the fifth module liquid handling station 6015, a plate sealer 6030, a fifth module deck 6035, and the upper door 1045 and the lower doors 1050 of the fifth module 6000. FIG. 37 is a schematic drawing of a top view of processing portions of the fifth module 6000 (with a roof of the fifth module 6000 removed), shown in FIG. 36, and shows the fifth module turntable load robot 6005, the fifth module turntable unload robot 6006, an actuating tube holder 6007, the fifth module scanner 6020, a fifth module turntable 6040, the fifth module liquid handling station 6015, the plate sealer 6030, the fifth module gantry robot 6010, the fifth module deck 6035 with an opening 6045 to a supply of output containers 1030, and another opening 6050 to a supply of fifth module aspirator tips 6055, the capping and decapping device 6025, plate shuttles 6060, and a plate shuttle conveyor system 6065 on which the plate shuttles are conveyed. FIG. 37 also shows slots 6095 on the fifth module turntable 6040, and the positions through which portions of the fifth module turntable 6040 rotate, namely, a loading position 6040a, a liquid handling position 6040b, and a disposal position 6040c.

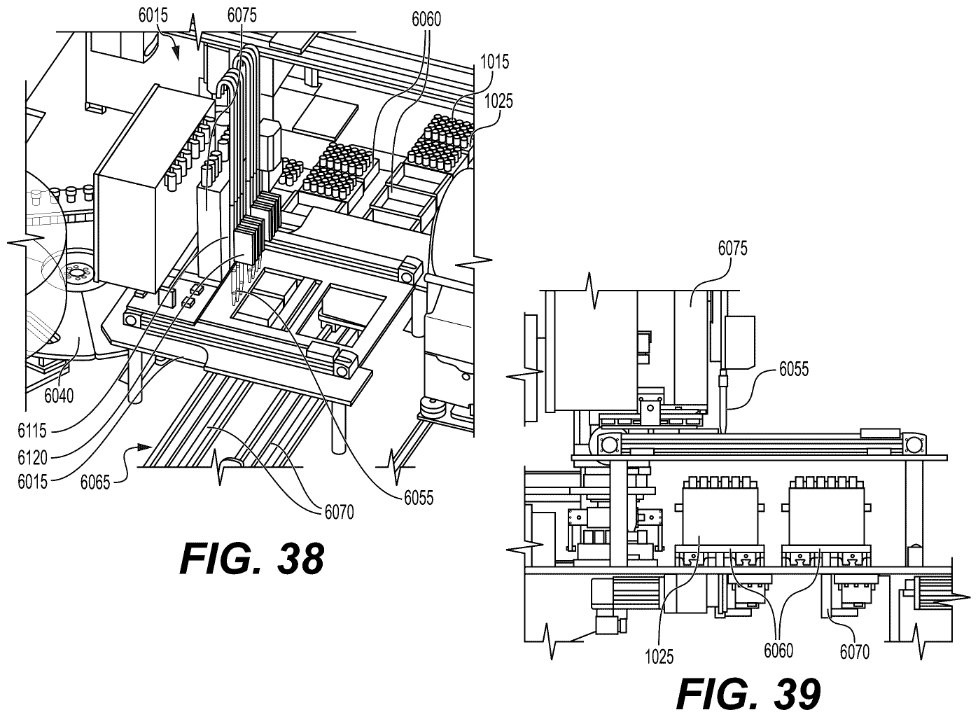

FIG. 38 is a schematic drawing of a detail view of the fifth module liquid handling station 6015, and in particular, shows DWPs 1025, as examples of output containers 1030, on plate shuttles 6060. FIG. 38 also shows plate shuttle tracks 6070 of the plate shuttle conveyor system 6065, the fifth module turntable 6040, a fifth module liquid handling spanner 6075, and a plurality of fifth module aspirator tips 6055 loaded into the fifth module liquid handling spanner 6075. FIG. 39 is a schematic drawing of a detail view of the DWPs 1025 on the plate shuttles 6060, and in particular, shows the fifth module liquid handling spanner 6075, one of the fifth module aspirator tips 6055 on the fifth module liquid handling spanner 6075, the plate shuttle tracks 6070, and the DWPs 1025 on the plate shuttles 6060.

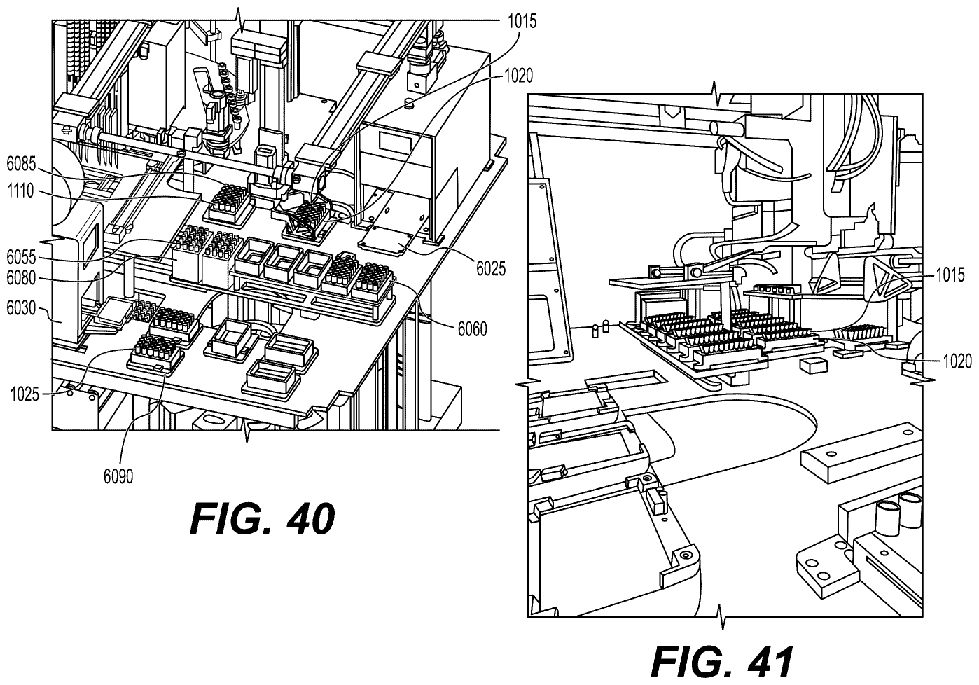

FIG. 40 is a schematic drawing of a detail view of tray handling in the fifth module 6000, and in particular, shows the fifth module aspirator tips 6055 on fifth module aspirator tip racks 6080, the capping and decapping device 6025, the plate shuttles 6060, a cap hold 6085, the plate sealer 6030, and holding nests 6090, which hold the DWPs 1025 and racks 1020 of micronic tubes 1015 following liquid handling in the fifth module 6000. FIG. 41 is a schematic detail view of the capping and decapping device 6025, and in particular, shows the micronic tubes 1015 on micronic tube rack 1020.

### A. Loading of Fifth Module Turntable

The fifth module turntable load robot 6005 may be configured to pick up the second tubes 1010 one at a time, or, optionally, multiple at a time, from the second inserts 1105 on the pallet conveyor system 5020 of the fourth module 5000, and move them into the fifth module 6000. Each second tube 1010 may be scanned by the fifth module scanner 6020, which may output the identifying information for each second tube 1010 to the controller 7000. Building on the example above, in a case in which barcodes are etched onto the second tubes 1010 by the marking device 4285 of the third module 4000, the etched barcodes may be scanned by the fifth module scanner 6020. By this arrangement, the controller 7000 may register and/or track the second tubes 1010 entering the fifth module 6000. That is, the controller 7000 may receive the scanned identifying information for each second tube 1010 and verify that the second tube 1010 is one that was scanned in prior modules and in upstream processing, such that the controller 7000 may expect the second tube 1010 to arrive at the fifth module 6000. If, for any reason, the received identifying information is not information that the controller 7000 expected, the controller 7000 may issue an error notification to an operator to remove the second tube 1010 from the fifth module 6000 and/or to confirm whether the second tube 1010 should be processed in the fifth module 6000. An error notification may also be communicated to an operator if, e.g., the fifth module turntable load robot 6005 encounters a missing or unidentifiable second tube 1010.

Once scanned, the second tubes 1010 may be placed into slots 6095 on a portion of the fifth module turntable 6040 where they are decapped by the fifth module turntable load robot 6005. The caps 1090 may be removed by placing the second tubes 1010 into the actuating tube holder 6007 (FIG. 37), which may be configured to hold and grip the tube bodies 1080, and rotating the caps 1090 in a direction (e.g., a counter-clockwise direction). Once removed, the caps 1090 may be disposed into a second tube disposal container 6100 below the fifth module deck 6035, shown in FIG. 42B.

In some aspects, similar to the decapping station 4180 of the third module 4000, the fifth module 6000 may include one or more sensors (not shown) to detect if any second tube caps 1090 remain on the second tubes 1010 once the decapping is completed. If a second tube cap 1090 is detected on one of the second tubes 1010, a signal may be output to the controller 7000 to notify an operator that one or more second tube caps 1090 need to be removed from one or more of the second tubes 1010. Alternatively, the controller 7000 may instruct the fifth module turntable load robot 6005 to remove the second tube caps 1090 remaining on the second tubes 1010.

In the embodiment shown in FIGS. 36 to 41, the fifth module turntable 6040 has three portions, and each portion has a row of eight slots 6095, for holding the second tubes 1010. Although eight slots 6095 are shown, any suitable number of slots 6095 may be used. The fifth module turntable 6040 may rotate each portion through the loading position 6040a, in which the second tubes 1010 are loaded into the slots 6095 and decapped by the fifth module turntable load robot 6005, the liquid handling position 6040b, in which the plasma in the second tubes 1010 is aspirated by the fifth module aspirator tips 6055, and the disposal position 6040c, in which the second tubes 1010 are disposed by the fifth module turntable unload robot 6006, following completion of the liquid handling process. That is, the fifth module turntable unload robot 6006 may pick up each second tube 1010 from the portion of the fifth module turntable 6040 in the disposal position 6040c, and move it over a disposal opening within the fifth module deck 6035. After the loading and decapping of the second tubes 1010, the portion of the fifth module turntable 6040 may be rotated to the liquid handling position 6040b.

### B. Supply and Loading of Fifth Module Aspirator Tips

With reference to FIGS. 37 and 38, a plurality of fifth module aspirator tips 6055 are supplied from a fifth module tip rack hotel 6105 under the fifth module deck 6035, as shown in FIG. 42A. The fifth module tip rack hotel 6105 may be similar to or the same as the third module tip rack hotel 4235 shown in FIG. 20. The fifth module tip rack hotel 6105 has a plurality of fifth module aspirator tip rack supports 6110 holding fifth module aspirator tip racks 6080 (shown in FIG. 40), which in turn hold the fifth module aspirator tips 6055. The fifth module aspirator tip racks 6080 may be lifted up to the fifth module deck 6035 by a lifting mechanism (not shown), similar to the third module aspirator tip rack loading mechanism 4245.

Similar to the third module liquid handling spanner 4020, the fifth module liquid spanner 6075 may have a plurality of aspirator mounting portions 6115 (shown in FIG. 38), which are inserted into the fifth module aspirator tips 6055 on the fifth module aspirator tip racks 6080. The aspirator mounting portions 6115 may be sized to create a press fit within upper ends of the fifth module aspirator tips 6055. The fifth module liquid handling spanner 6075 may also have flowmeter 6120 above each aspirating mounting portion 6115, and each flowmeter 6120 may be used to detect flow of a liquid as it is withdrawn into a corresponding fifth module aspirator tip 6055. If the flowmeter 6120 of a fifth module aspirator tip 6055 detects that no liquid is being withdrawn or suctioned into the fifth module aspirator tip 6055, the flowmeter 6120 may output a notification to the controller 7000, which in turn may issue an error notification to an operator. In other aspects, the flowmeter 6120 may output such a notification when the flowmeter 6120 detects insufficient flow of liquid into the fifth module aspirator tip 6055, or if both liquid and air are detected flowing into the third module aspirator tip 6055. As an example, the flowmeter 6120 may output such a notification when the flowmeter 6120 does not detect suction of liquid and instead, air is suctioned into the fifth module aspirator tip 6055. Further, the fifth module liquid handling spanner 6075 may include connections (or connectors) between each of the aspirator mounting portions 6115 and a suction source, such that a suction generated by the suction source is generated within the mounted third module aspirator tips 6055.

The fifth module liquid handling spanner 6075 may be configured to move to a position over the opening in the fifth module deck 6035, and pick up the fifth module aspirator tips 6055 from the fifth module aspirator tip racks 6080 using the aspirator mounting portions 6115. In the embodiment shown in FIG. 37, the fifth module liquid handling spanner 6075 picks up eight fifth module aspirator tips 6055 at a time, to correspond to the eight slots 6095 holding the second tubes 1010 on the fifth module turntable 6040, although any number of aspirator tips 6055 may be picked up at a time, depending on the number of slots 6095 and aspirator mounting portions 6115 are present in a given embodiment.

As with the third module liquid handling spanner 4020, the fifth module liquid handling spanner 6075 may be configured to pick up the fifth module aspirator tips 6055 at a first spacing, based on the spacing of the fifth module aspirator tips 6055 in the fifth module aspirator tip racks 6080, and then move the fifth module aspirator tips 6055 to a second spacing, based on the spacing of the slots 6095 holding the second tubes 1010 in the fifth module turntable 6040. In some aspects, the spacing between the fifth module aspirator tip racks 6080 and the spacing of the slots 6095 may be the same, and no movement or adjustment may be needed.

C. Supply and Loading of Output containers

With reference to FIGS. 37 to 42A, the supply of DWPs 1025 and micronic tubes 1015, as examples of output containers 1030, will be described. A DWP hotel 6125 and a micronic tube rack hotel 6130 may be located under the fifth module deck 6035, as shown in FIG. 42A. The DWPs 1025 and the micronic tube racks 1020 may be lifted up to the fifth module deck 6035 by a lifting mechanism (not shown), and may be picked up by the fifth module gantry robot 6010 (FIG. 37) and placed onto plate shuttles 6060 on the plate shuttle tracks 6070. Each DWP 1025 and micronic tube rack 1020 (and/or the micronic tubes 1015 thereon) loaded onto the fifth module deck 6035 (or any other output container 1030) may be scanned by a fifth module scanner 6020, shown in FIG. 36. More specifically, the micronic tube rack 1020 may be brought to a designated location (shown in FIG. 37 but not labeled) where a barcode reader may scan and identify downward-facing, two-dimensional labels on the micronic tubes 1015. The identifiers of the micronic tubes 1015 and their positions within the micronic tube rack 1020 may then be associated with identifying information of the micronic tube rack 1020. That information may then be stored in the memory 7005 of the controller 7000. The plate shuttles 6060 containing the micronic tubes 1015 on the micronic tube rack 1020 may then be conveyed to the capping and decapping device 6025, for removal of caps 1110 from the micronic tubes 1015. After the micronic tubes 1015 are decapped, the plate shuttles 6060 containing the micronic tube racks 1020 may be conveyed to the liquid handling station 6015, back to the capping and decapping device 6025 for recapping, and then to the holding nests 6090. Plate shuttles 6060 containing the DWPs 1025 may be conveyed to the fifth module liquid handling station 6015, to the plate sealer 6030, and then to the holding nests 6090.

FIG. 41, in particular, shows the micronic tubes 1015 positioned in the capping and decapping device 6025. The capping and decapping device 6025 may include an end effector (not shown) configured to remove the caps 1110 from the micronic tubes 1015, place the caps 1110 on the cap hold 6085 (FIG. 40), and place the caps 1110 back onto the micronic tubes 1015. In one embodiment, each cap 1110 has an inner threaded surface, and a top end of the micronic tubes 1015 has an outer threaded surface. The inner threaded surface of the cap 1110 and the outer threaded surface of the micronic tubes 1015 are engaged, that is, the cap 1110 and micronic tubes 1015 are threadably connected, and the cap 1110 can be removed from the micronic tubes 1015 by rotating in one direction (e.g., a counter-clockwise direction), based on the arrangement of the threads, and placed back on the micronic tube 1015 by rotating an opposite direction (e.g., a clockwise direction).

Once the micronic tubes 1015 have been decapped, the micronic tube racks 1020 may be conveyed on the plate shuttles 6060 to the liquid handling station 6015. Or, in a case in which DWPs 1025 are used, the DWPs 1025 do not require decapping and may simply be conveyed to the liquid handling station 6015.

### D. Liquid Handling Station of Fifth Module

The fifth module liquid handling spanner 6075 may hold the fifth module aspirator tips 6055 in the second spacing, and may move the fifth module aspirator tips 6055 over the opened second tubes 1010 in the portion of the fifth module turntable 6040 in the liquid handling position 6040a. Then, the fifth module liquid handling spanner 6075 may lower the fifth module aspirator tips 6055 into the second tubes 1010, and the plasma (or other isolated liquid component) may then be aspirated from the second tubes 1010 into the fifth module aspirator tips 6055. As with the aspirating process in the third module 4000, the amount of plasma (or other isolated liquid component) aspirated from each second tube 1010 may be controlled by the controller 7000. The amounts aspirated may be predetermined by the controller 7000 and/or based on amounts of plasma obtained during the liquid handling process in the third module 4000. The controller 7000 may determine the flow rate(s) for aspiration and/or z-speed(s) of movement of the fifth module aspirator tips 6055 for each individual second tube 1010 and may individually control movement of the fifth module aspirator tip 6055 for each second tube 1010 to aspirate liquid and to move at those determined values, to withdraw as much of the isolated plasma in each second tube 1010 as possible, without disturbing a buffy coat red blood layer L2 or a red blood cell layer L3 that may have been produced by the second centrifugation process in the fourth module 5000. In other aspects, the same z-speed(s) of movement and/or flow rate(s) of aspiration may be used for each of the fifth module aspirator tips 6055.

In some aspects, the fifth module liquid handling spanner 6075 may include one or more liquid level sensors for determining the liquid level in each of the second tubes 1010. If the one or more liquid level sensors detects that one or more of the second tubes 1010 contains less liquid than is anticipated, then a signal may be sent to the controller 7000, and an error notification may be sent to the operator. In some aspects, the z-speed(s) and/or the flow rate(s) of the fifth module aspirator tips 6055 may be determined, at least in part, based on a liquid level detected by the one or more liquid level sensors.

After aspirating the plasma from the second tubes 1010, the fifth module liquid handling spanner 6075 may move the fifth module aspirator tips 6055 over to the DWPs 1025 and micronic tubes 1015 located in the liquid handling station 6015, and may dispense the plasma (or other isolated liquid component) into the DWPs 1025 and/or micronic tubes 1015.

The amount of plasma (or other isolated liquid component) dispensed into wells of the DWPs 1025 and/or into the micronic tubes 1015 may be controlled by the controller 7000. The amount aspirated in a given pass, and/or the output container 1030 into which the liquid is allocated may be determined based on the volume of isolated liquid sample component (in this example, plasma) in each second tube 1010. A logic sequence may be used to determine volumes of plasma to be dispensed into DWPs 1025 and/or into micronic tubes 1015.

For example, if a total volume of plasma in a second tube 1010 is less than a first threshold, then all of the plasma may be dispensed into one output container 1030 (e.g., a DWP 1025), and none of the plasma may be dispensed into another output container 1030. In some aspects, the first threshold may be 0.5 mL, 1 mL, 2 mL, 3 mL, 4 mL, or 5 mL, although any suitable threshold may be used, depending on the amount of liquid available, the type of liquid, the size of the output containers 1030, the size of the second tubes 1010, and/or the size of the fifth module aspirator tips 6055. If a total volume of plasma in a second tube 1010 is greater than or equal to the first threshold but less than a second threshold, then the volume of plasma may optionally be divided between two different output containers 1030 (e.g., a DWP 1025 and one or more micronic tubes 1015), with a volume of plasma being dispensed into a first output container 1030 (e.g., a DWP 1025), and the remaining plasma being dispensed into a second output container 1030 (e.g., one or more micronic tubes 1015). In some aspects, the second threshold may be 3 mL, 4 mL, 5 mL, 6 mL, 7 mL, or 8 mL, although as stated previously, any suitable threshold may be used. If a total volume of plasma in a second tube 1010 is greater than or equal to the second threshold, then the volume of plasma may be divided for dispensing between two different output containers 1030 (e.g., a DWP 1025 and one or more micronic tubes 1015). The division may be weighted toward one of the two different output containers 1030, for example based on the intended use of the particular output container 1030 (e.g., testing or long-term storage), with the weights further based on the volume already distributed between the output containers 1030 and the volume remaining, or may be divided equally.

Although two thresholds are described in the previous example, in other aspects, only one threshold may be used. For example, if a total volume of plasma in a second tube 1010 is less than or equal to a first threshold, then all of the plasma may be dispensed into one output container 1030 (e.g., a DWP 1025), and none of the plasma may be dispensed into another output container 1030. If a total volume of plasma in a second tube 1010 is greater than the threshold, then the volume of plasma may be divided for dispensing between two different output containers 1030 (e.g., a DWP 1025 and one or more micronic tubes 1015), with a volume of plasma being dispensed into a first output container 1030 (e.g., a DWP 1025), and the remaining plasma being dispensed into a second output container 1030 (e.g., one or more micronic tubes 1015).

In some aspects, if the plasma in a second tube 1010 is derived from an unpaired first tube 1005, meaning there was only one liquid sample available from a patient instead of two, then, in some aspects, controller 7000 may determine that the plasma sample should not be split, and all plasma may be aspirated into one output container 1030 (e.g., a DWP 1025). In such a scenario, it is possible that a total volume of plasma obtained from the unpaired first tube 1005 would be less than the threshold amount and therefore, there may not be a sufficient amount of plasma for splitting between two output containers, e.g., DWPs 1025 and micronic tubes 1015. In other embodiments, however, even plasma in a second tube 1010 derived from an unpaired first tube 1005 may be assessed and allocated according to the logic described above (e.g., according to the single threshold or multiple threshold logic).

In some embodiments, the plasma may be dispensed into a DWP 1025, leaving one or more wells aside as a control (for example, 22 of 24 wells of a DWP 1025 may be filled with plasma, the 23rd may be filled with a control, and the 24th well may be left empty). Leaving an empty well in a DWP 1025, or dispersing a control at this stage, may save a step of emptying one or more wells of a DWP 1025 as part of downstream processing. For example, the empty well may be used for a control in downstream processing. In addition or alternatively, the micronic tubes 1015 may only be filled with plasma if the DWP 1025 is filled (filled meaning, for example, all wells are filled leaving one well empty as a control), in which case the plasma may be dispensed into one or more micronic tubes 1015 for cold storage and for use as a back-up if the plasma dispensed in the DWPs 1025 fails quality testing during subsequent processing. Which well is left empty may vary and may be determined by randomization by controller 7000 and/or the LIMS controller 9000.

### E. Sealing and Outputting of DWPs and Recapping and Outputting of Micronic Tubes

After the liquid handling process is completed, the plate shuttles 6060 holding the DWPs 1025 may be conveyed to the plate sealer 6030. The DWPs 1025 may be loaded into the plate sealer 6030, where they may be sealed. Then, the sealed DWPs 1025 may be output by the plate sealer 6030 back onto a plate shuttle 6060, and conveyed to the holding nests 6090, where they may be picked up by a robot or transferred onto a downstream conveyor system, for subsequent processing or storage. As one example of subsequent processing, the DWPs 1025 may be output for extraction and processing of cfDNA contained within the plasma. The sealed DWPs 1025 may be transferred or output without operator intervention (that is, without manual intervention). In other aspects, an operator may pick up the DWPs 1025.

After the liquid handling process is completed, the plate shuttles 6060 holding the micronic tube racks 1020 may be conveyed back to the capping and decapping device 6025. The caps 1110 may be placed back onto the micronic tubes 1015, as described above, and the micronic tube rack 1020 may be placed back onto a plate shuttle 6060 and conveyed to the holding nests 6090, where they can be picked up by a robot or transferred onto a downstream conveyor system, for subsequent processing or storage. As one example of subsequent storage, the plasma in the micronic tubes 1015 may be output for long-term cold storage. The recapped micronic tubes 1015 may also be transferred or output without operator intervention.

The holding nests 6090 may include sensors for detecting the presence of the DWPs 1025 and/or the micronic tube rack 1020, and the sensor may output notifications to the controller 7000 which may, in turn, notify the LIMS controller 9000 that one or more sealed DWPs 1025 and/or micronic tube racks 1020 are ready for subsequent processing and/or storage. The LIMS controller 9000 may coordinate automatic unloading of the sealed DWPs 1025 and/or micronic tube rack 1020. For example, the gantry robot 6010 may pick up the sealed DWPs 1025 and/or micronic tubes 1015 from the holding nests 6090, and place them onto a track, which may convey them to other systems for the processing and/or storage. As another example, the LIMS controller 9000 may control a robot, outside of the automated liquid processing system 1000, which may pick up the sealed DWPs 1025 and/or micronic tubes 1015 from the holding nests 6090, and place them onto a track, which may convey them to other systems for the processing and/or storage. Alternatively, if the fifth module 6000 is a stand-alone module, the second tubes 1010 may be received from or input by an operator, and/or the output containers 1030 may be output to an operator.

### F. Disposal of Second Tubes and Fifth Module Aspirator Tips

After the liquid handling process has been completed for a set of eight second tubes 1010 and fifth module aspirator tips 6055, the second tubes 1010 and the fifth module aspirator tips 6055 may be disposed. The fifth module turntable unload robot 6006 retrieves each tube body 1080 of the second tubes 1010 from the portion of the fifth module turntable 6040 in the disposal position 6040c, and moves and disposes of the tube body 1080 into an opening in the fifth module deck 6035 to the second tube disposal container 6100, shown in FIG. 42B. In another embodiment, the portion of the fifth module turntable 6040 holding the second tubes 1010 may be rotated to the disposal position 6040c, and, in a similar manner to the disposal of the first tubes 1005 in the third module 4000, a stay (not shown) under the second tubes 1010 in the disposal position 6040c may be moved, allowing the second tubes 1010 to fall through an opening to the second tube disposal container 6100, shown in FIG. 42B, under the fifth module deck 6035. The fifth module aspirator tips are also disposed into a fifth module aspirator tip disposal container 6135, also shown in FIG. 42B, located under the fifth module deck 6035. As with the third module aspirator tips 6055, the fifth module aspirator tips 6055 may be removed by the fifth module liquid handling spanner 6075 through an opening in the fifth module deck 6035 between the fifth module turntable 6040 and the end of the plate shuttle tracks 6070.

### VII. Consumable Storage and Disposal

Storage of consumables 1035 supplied to the third module 4000 and the fifth module 6000 and storage of disposal from the third module 4000 and the fifth module 6000 will be described with reference to FIGS. 42A, 42B, 43, and 44.

FIG. 42A is a schematic diagram showing consumable supply storage in the third module 4000 and the fifth module 6000 of the automated liquid processing system 1000. FIG. 42A shows a back side of the automated liquid processing system 1000, with the fifth module 6000 on the left side of the figure. FIG. 42A shows the third module aspirator tip hotel 4235, located under the third module deck 4035, and which supplies the third module aspirator tips 4045 on the third module aspirator tip racks 4040, for the third module liquid handling process. FIG. 42A also shows a DWP 1025 and micronic tube rack 1020 supply of the fifth module 6000, located under the fifth module deck 6035, and which supply the DWPs 1025 and micronic tube rack 1020 for the fifth module liquid handling process. Further, FIG. 42A shows the fifth module tip rack hotel 6105, also located under the fifth module deck 6035, and which supplies the fifth module aspirator tips 6055 on the fifth module aspirator tip racks 6080, for the fifth module liquid handling process. Each of the third module aspirator tip hotel 4235 and the fifth module aspirator tip hotel 6105 may be a rotating carousel that is configured to rotate at intervals, and lift third module aspirator tip racks 4040 and fifth module aspirator tip racks 6080 up to the third module deck 4035 and the fifth module deck 6035, respectively. The DWP 1025 and micronic tube rack 1020 supply of the fifth module 6000 may also include a carousel for supplying DWPs 1025 and a carousel for supplying the micronic tube rack 1020, each carousel rotating in intervals and lifting up DWPs 1025, one or multiple at a time, and micronic tube rack 1020, one or multiple at a time, onto the fifth module deck 6035.

FIG. 42B is a schematic diagram showing consumable disposal containers of the third module 4000 and the fifth module 6000 of the automated liquid processing system 1000. FIG. 42B shows a front side of the automated liquid processing system 1000, with the fifth module 6000 on a right side of the figure. FIG. 42B shows the first tube and cap disposal container 4230, located under the third module deck 4035, and which receives first tubes 1005 and first tube caps 1075 following the third module liquid handling process. In addition, FIG. 42B shows the third module aspirator tip disposal container 4325, also located under the third module deck 4035, which receives the third module aspirator tips 4045 following the third module liquid handling process.

FIG. 42B also shows the second tube and cap disposal container 6100 of the fifth module 6000, under the fifth module deck 6035, and which receives the second tubes 1010 and the caps 1090 following the fifth module liquid handling process. Further, FIG. 42B shows the fifth module aspirator tip disposal container 6135, also located under the fifth module deck 6035, and which receives the fifth module aspirator tips 6055 following the fifth module liquid handling process.

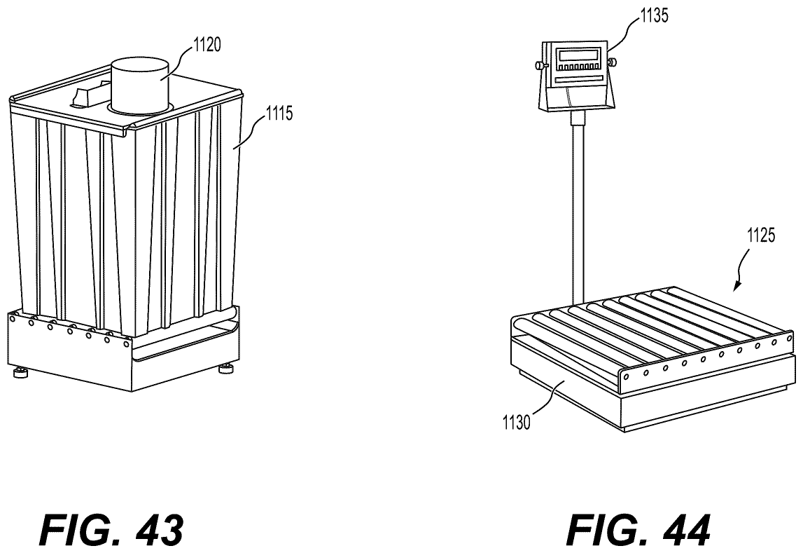

FIG. 43 is a schematic drawing of a disposal container 1115, which may be used as one or more of the first tube can cap disposal container 4230, the third module aspirator tip disposal container 4325, the second tube and cap disposal container 6100, or the fifth module aspirator tip disposal container 6135, provided within the automated liquid processing system 1000. The disposal container 1115 has an opening 1120 on a top for receiving liquid containers, such as first tubes 1005 or second tubes 1010, caps, and aspirator tips.

FIG. 44 is a schematic drawing of a disposal scale 1125 provided within the third module 4000 and the fifth module 6000 of the automated liquid processing system 1000. In particular, the disposal scale 1125 has a platform 1130 that is configured to hold a container 1115, and may have a weight measurement display 1135 for displaying a measured weight of the container 1115. A disposal scale 1125 may be provided under one or more (or all) of the consumable disposal containers 1115 of the third module 4000 and the fifth module 6000, namely, the first tube and cap disposal container 4230 and the third module aspirator tip disposal container 4325 of the third module 4000, and the second tube and cap disposal container 6100 and the fifth module aspirator tip disposal container 6135 of the fifth module 6000. If included, the disposal scale 1125 may be configured to send a signal to controller 7000 when a weight of a consumable disposal container 1115 indicates that it may be full or nearing full. Controller 7000 may, in response to receiving a signal from the disposal scale 1125, output a notification to an operator or another control system that one or more consumable disposal containers 1115 is full or needs to be emptied. In some aspects, the notification may include specific information about which consumable disposal container 1115 is full. In some aspects, the disposal scale 1125 may continuously or intermittently send information to the controller 7000 regarding the weight of the consumable disposal container 1115. In such an aspect, a fill level of one or more consumable disposal containers may be made available to the operator so that fill levels may be monitored during processing.

### VIII. Automated Liquid Isolation Process

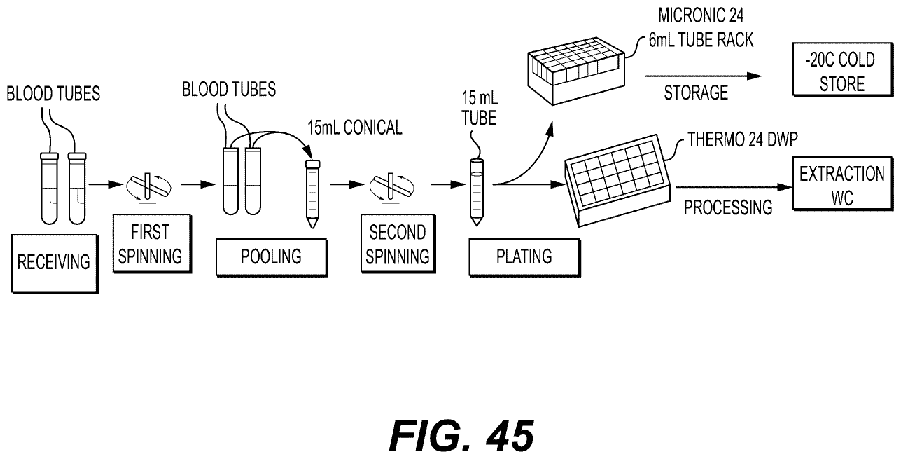

FIG. 45 is a schematic drawing of an automated plasma isolation process, as an example of an automated liquid isolation process performed by the automated liquid processing system 1000 described herein. In a first step of the process, first tubes 1005 containing liquid (e.g., blood) samples from a patient may be received by the first module 2000 of the automated liquid processing system 1000. Two first tubes 1005 per patient are received by the first module 2000 in this example. As described above, however, in some aspects, only one first tube 1005 sample may be received for a given patient. In a second step, the received first tubes 1005 may undergo a first spinning process, using centrifuges 3010, in the second module 3000. The first spinning process may separate the liquid samples, e.g., blood samples, into a plurality of layers to isolate one or more components. In the example of a blood sample, the plurality of layers may include a plasma layer L1 at a top of the first tubes 1005, a red blood cell layer L3 at a bottom of the first tubes 1005, and a buffy coat red layer L2 in between the plasma layer L1 and the red blood cell layer L3. The first tubes 1005 may then undergo pooling, or liquid handling, in the third module 4000, where the isolated liquid component, e.g., plasma, is aspirated from the pairs of first tubes 1005 from the same patient and pooled together in a second tube 1010. The pooled plasma in the second tubes 1010 may then move to the fourth module 5000 and undergo a second spinning process, where the liquid component, e.g., plasma, is further isolated from other components of the blood samples that may remain. The second tubes 1010 may then move to the fifth module 6000, where the isolated liquid component, e.g., plasma, is aspirated from the second tubes 1010 and dispensed into output containers 1030, e.g., DWPs 1025 for processing, such as an extraction process, and/or into micronic tubes 1015 for storage. This is one example of an automated liquid isolation process that the automated liquid processing system 1000 may perform, but other types of liquids may be processed for isolation of one or more components thereof.

Further, although the disclosure above describes the automated liquid processing system 1000 as having certain functions being performed by one of a series of five modules, it is possible that the same functions may be performed by any suitable number of modules. For example, the functions and features of one module may be combined with the functions or features of another module, or the functions and features of one module may be split apart amongst other modules, so long as the functions and features described herein are performed by the automated liquid processing system 1000 as a whole. Additionally, it is possible that any given module may exist independently, in which case the input or outputs of a given module may interface with an operator.

### IX. Control Method

Control methods performed by the controller 7000 of the automated liquid processing system 1000 will be described with reference to FIG. 2 and FIGS. 46A to 53C.

### A. First Module Control

FIGS. 46A and 46B show a flowchart of a first module control method 10000. With reference to FIG. 46A, the method 10000 includes a step 10005 of receiving, from the first module scanner 2040, identifying information of each of the first inserts 1055 to be inserted into the first module 2000 of the automated liquid processing system 1000. The method 10000 may further include a step 10010 of storing the received identifying information of each of the first inserts 1055 in the memory of the controller 7000. The method 10000 may also include a step 10015 of determining, based on the identifying information, whether the first insert 1055 is compatible with the second module centrifuges 3010, and therefore, whether the first insert 1055 may be input into the first module 2000. In a case in which the first insert 1055 is compatible (YES in step 10015), and may be input into the first module 2000, the method 10000 next includes a step 10020 of changing an input indicator light 2030 to indicate that the first insert 1055 may be input. On the other hand, in a case in which the first insert 1055 is not compatible (NO in step 10015), and may not be input into the first module 2000, the method 10000 includes a step 10025 of changing the input indicator light 2030 to indicate that the first insert 1055 may not be input. As an example, the input indicator light 2030 may be turned on to indicate that the first insert 1055 may be input into the first module 2000, or the input indicator light 2030 may be turned off to indicate that the first insert 1055 may not be input into the first module 2000. As another example, the input indicator light 2030 may be changed to a first color, e.g., a green color, to indicate that the first insert 1055 may be input into the first module 2000, and may be changed to a second color, e.g., a red color to indicate that the first insert 1055 may not be input into the first module 2000. Additionally, although a light indicator is discussed herein, any suitable indicator, such as a visual, auditory, or haptic indicator, may be used. Then, the method 10000 may return to the step 10005 of receiving identifying information of another first insert 1055 from the first module scanner 2040. Further, in some embodiments, an operator may need to intervene to clear the indicator, such as an auditory alarm, and thereafter, the method 10000 returns to step 10005, to await a new first insert 1055 to scan.

When it is determined that the first insert 1055 may be input into the first module 2000, the method 10000 may include a step 10030 of checking a low level sensor 2065 of a first module conveyor channel 2005, and a step 10035 of determining, based on an output from the low level sensor 2065, whether the first module conveyor channel 2005 can receive a first insert 1055. Specifically, in a case in which the low level sensor 2065 of the first module conveyor channel 2005 outputs an indication that no first insert 1055 is detected, the controller 7000 determines that the first insert may be placed on the first module conveyor channel 2005 (YES in step 10035), and the method 10000 proceeds to a step 10040, in which the indicator light is changed to indicate that the first insert may be placed on the first module conveyor channel 2005. And in a case in which the low level sensor 2065 of the first module conveyor channel 2005 outputs an indication that a first insert 1055 is detected (NO in step 10035), the method 10000 may include a step 10045 of checking the high level sensor 2060 of the first module conveyor channel 2005, and a step 10050 of determining, based on an output from the high level sensor 2060, whether the first module conveyor channel 2005 can receive the first insert 1055. In a case in which the high level sensor 2060 outputs an indication that no first insert 1055 is detected and a first insert can be placed on the first module conveyor channel 2005 (YES in step 10050), the method 10000 may proceed to the step 10040 of changing the indicator light 2030 to indicate that the first module conveyor channel 2005 can receive the first insert 1055. For example, the indicator light 2035 above the first module conveyor channel 2005 may be turned on, and/or changed to a green color.

On the other hand, in a case in which the high level sensor 2060 outputs an indication that a first insert 1055 is detected, and a first insert cannot be placed on the first module conveyor channel 2005 (NO in step 10050), the method 10000 may proceed to a step 10055 of changing the indicator light 2035 above that first module conveyor channel 2005 to indicate the first insert 1055 may not be placed in that first module conveyor channel 2005. For example, the indicator light 2035 above the first module conveyor channel 2005 may be turned off or, alternatively, changed to red. Then, the method 10000 may return to the step 10030 of checking a high level sensor 2060 and a low level sensor 2065 of a subsequent or adjacent first module conveyor channel 2005, and repeating the process until it is determined that one of those subsequent or adjacent first module conveyor channels 2005 can receive a first insert 1055.

In some embodiments, if all high level sensors 2060 of all first module conveyor channels 2005 indicate that they are all full and cannot receive first inserts 1055, the method 10000 may include outputting an error notification to an operator via the user interface 8000. This may occur, for example, if the second module gantry robot 3025 experiences a malfunction and is not picking up the first inserts 1055 from the output ends 2050 of the first module conveyor channels 2005.

With reference to FIG. 46B, the method 10000 may also include a step 10060 of checking output sensors 2055 at the output ends 2050 of the first module conveyor channels 2005 and a step 10065 of determining whether a first insert 1055 is ready to be picked up and transferred to the second module 3000. In one embodiment in which the first module conveyor belts 2015 continuously rotate, the output sensor 2055 may output a notification that a first insert 2055 is at the output end 2050 of a first module conveyor channel 2005 (YES in step 10065), and the method 10000 may include a step 10070 of instructing the second module gantry robot 3025 to pick up the first insert 1055 from the output end 2050 of the first module conveyor channel 2005 and hold it in front of one of the second module scanners 3050. This latter step may, however, be performed as part of the control method of the second module 3000. And, if the output sensor 2055 does not output a notification that a first insert 2055 is at the output end 2050 of a first module conveyor channel 2005 (NO in step 10065), the method 10000 may return to step 10060 of checking output sensors 2055.

In an embodiment in which the first module conveyor belts 2015 do not continuously rotate, the method 10000 may include a step, before step 10060, of instructing the first module conveyor belts 2015 to rotate to convey the first inserts 1055 to the output ends 2050 of the first module conveyor channels 2005, and, if the output sensor 2055 outputs a notification that no first insert 1055 is at the output end 2050 of a first module conveyor channel 2005 (NO in step 10065), then the method 10000 may return to the step of instructing the conveyor channel belts 2015 to rotate and carry any input first inserts 1055 to output ends 2050 of the first module conveyor channels 2005. Then, the output sensor 2055 outputs a notification that a first insert 1055 is at an output end 2050 of a first module conveyor channel 2005 (YES in step 10065), and the method 10000 may proceed to step 10070 of instructing the second module gantry robot 3025 to pick up the first insert 1055 from the first module conveyor channel 2005 and hold it in front of one of the second module scanners 3050.

### B. Second Module Control

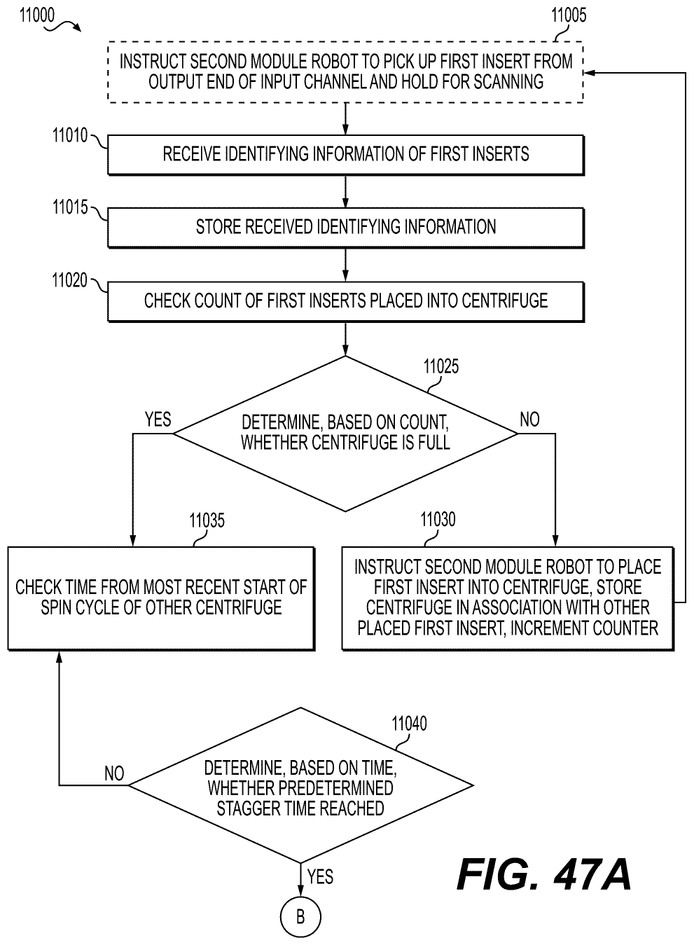

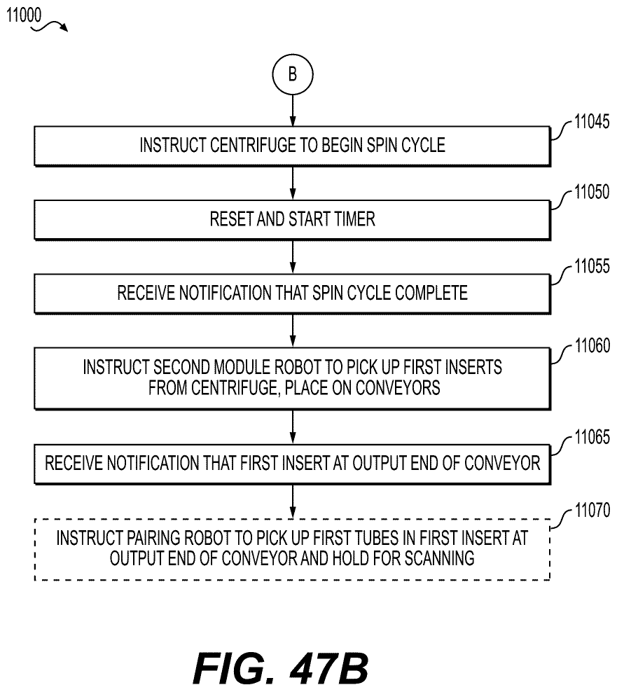

FIGS. 47A and 47B show a flowchart of a second module control method 11000. With reference to FIG. 47A, the method 11000 may include a step 11005 of instructing the second module gantry robot 3025 to pick up a first insert 1055 at an output end 2050 of one of the first module conveyor channels 2005, and to hold the first insert 1055 in front of one of the second module scanners 3050 for scanning. The method 11000 may also include a step 11010 of receiving, from one of the second module scanners 3050, identifying information of the first insert 1055, and a step 11015 of storing the received identifying information. In addition, the method 11000 includes a step 11020 of checking a count of a number of first inserts 1055 previously placed into a second module centrifuge 3010. The method 11000 also includes a step 11025 of determining, based on the count and a predetermined limit or capacity of the second module centrifuge 3010, if the predetermined limit has been reached, and, therefore, whether the first insert 1055 may be placed into the second module centrifuge 3010. In the example used above, the predetermined limit or capacity of the second module centrifuges 3010 may be four, or may be more or less, depending on the type and/or size of centrifuge 3010 used.

If the predetermined limit has not been reached (NO in step 11025), the method 11000 includes a step 11030 of instructing the second module gantry robot 3025 to place the first insert 1055 into the second module centrifuge 3010, storing in the memory 7005 the second module centrifuge 3010 in association with the first insert 1055 placed therein, and incrementing the count of first inserts 1055 that have been placed into the second module centrifuge 3010. Then, the method 11000 may return to the step 11005 of instructing the second module gantry robot 3025 to pick up a first insert 1055 from the first module 2000, to continue loading of the second module centrifuge 3010 until it reaches its capacity.

If, however, the limit has been reached (YES in step 11025), then the method 11000 may include a step 11035 of checking a time, using a timer, from a most recent start of a spin cycle of another second module centrifuge 3010. Then, the method 11000 includes a step 11040 of determining whether the time has reached a predetermined stagger time. If the timer has not yet reached the predetermined stagger time (NO in step 11040), the method 11000 may continue in a loop to check the time until it is determined that the predetermined stagger time has been reached. If the timer has reached the predetermined stagger time (YES in step 11040), then, with reference to FIG. 47B, the method 11000 includes a step 11045 of instructing the second module centrifuge 3010 filled with first inserts 1055 to begin a spin cycle.

The method 11000 also includes a step 11050 of resetting and starting the timer for the most recent start of the spin cycle, based on the starting of the spin cycle by the second module centrifuge 3010. The method 11000 may also include a step 11055 of receiving a notification from the second module centrifuge 3010 that the spin cycle has been completed, and instructing the second module gantry robot 3025 to pick up the first inserts 1055 in the second module centrifuge 3010 that has completed the spin cycle, and to place the first inserts 1055 on one of the second module conveyor belts 3015. Further, the method 11000 may include a step 11065 of receiving a notification from an insert sensor 3060 at an output end 3065 of one of the second module conveyor channels 3045, indicating the presence of a first insert 1055 at the output end of the one of the second module conveyor channels. The method 11000 may also include a step 11070 of instructing the pairing robot 4005 to pick up the first tubes 1005 in the first insert 1055 at the output end 3065 of the second module conveyor channel 3045. This latter step may be performed as part of the control method of the pairing station 4050 of the third module 4000.

### C. Third Module Control

### 1. Pairing Station Control

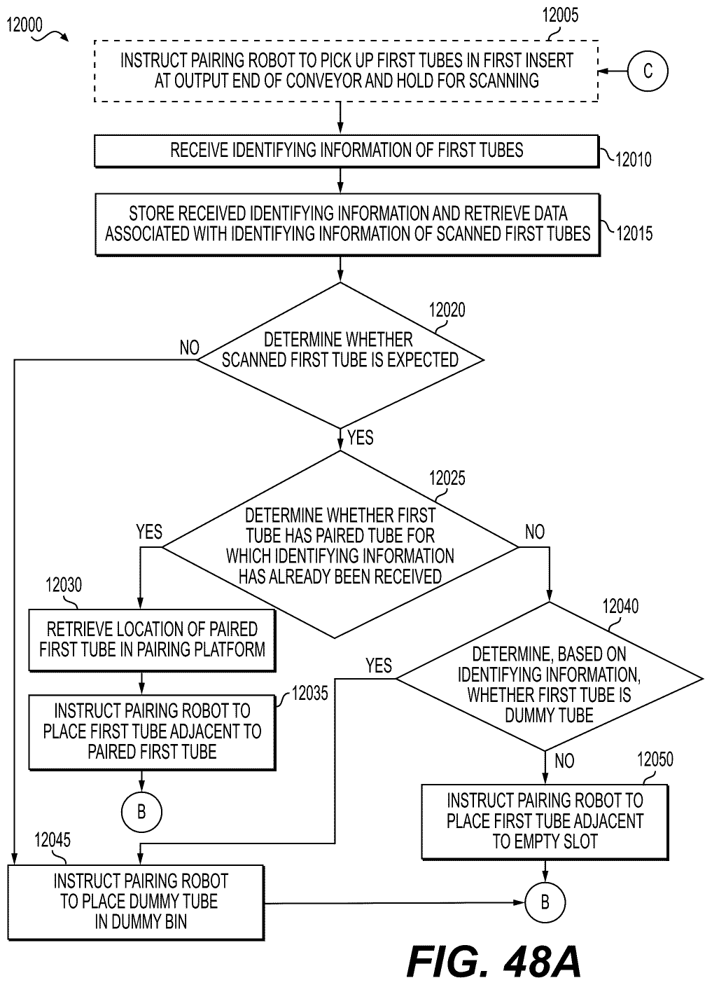

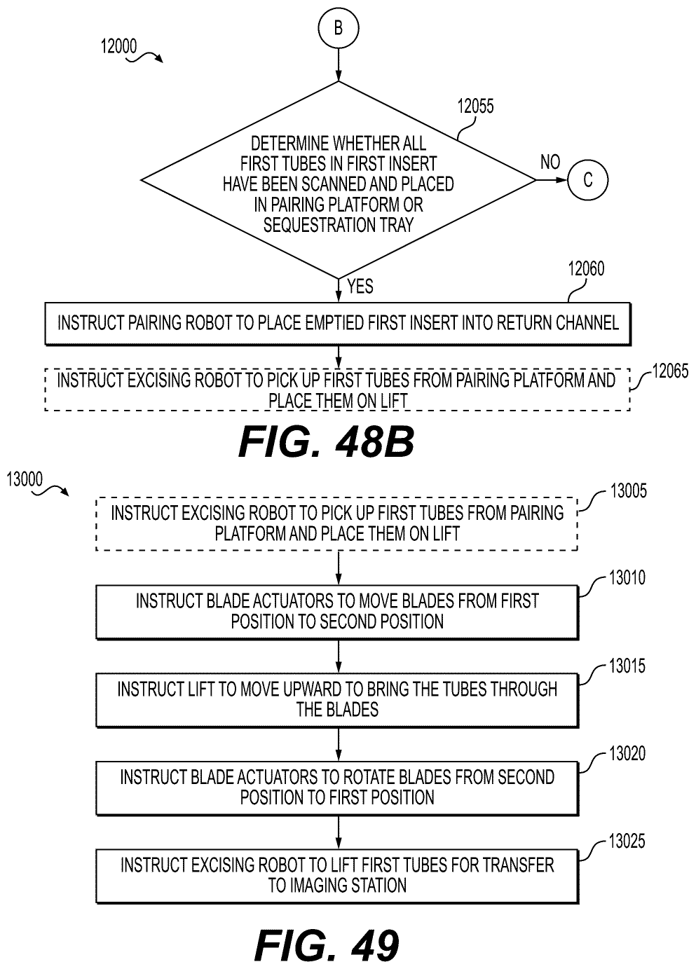

FIGS. 48A and 48B show a flowchart of a control method 12000 for the pairing station of the third module 4000. With reference to FIG. 48A, as noted above, the method 12000 may include a step 12005 of instructing the pairing robot 4005 of the pairing station 4050 to pick up a first tube 1005 in the first insert 1055 at the output end 3065 of one of the second module conveyor channels 3045, and to hold the first tube 1005 in front of a pairing scanner 4065. The method 12000 may include a step 12010 of receiving, from the pairing scanner 4065, identifying information of the first tube 1005, and a step 12015 of storing the received identifying information in the memory 7005, and, in some aspects, retrieving data associated with the received identifying information of the first tube 1005, as well as data associated with identifying information of previously scanned first tubes 1005, from the memory 7005. As an example, this data may include, for each first tube 1005 and its identifying information, a patient name, a patient ID number, and/or a patient date of birth.

Further, the method 12000 may include a step 12020 of determining whether a scanned first tube 1005 is expected, based on the identifying information retrieved for the scanned first tube 1005. If the scanned first tube 1005 is expected (YES in step 12020), the method may proceed to a step 12025 of determining, using a verification process, whether the first tube 1005, for which the identifying information has been received, has a paired tube for which data of the identifying information of the first tube 1005 matches data of identifying information of the paired tube 1005. If the scanned first tube 1005 is not expected (NO in step 12020), the method 12000 may proceed to a step 12045 of instructing the pairing robot 4005 to place the first tube 1005 into a dummy tube bin of the second module 3000, for disposal.

The determining step 12025 may include comparing the data of the first tube 1005 with the data of the previously scanned first tubes 1005 to determine if the data matches for the first tube 1005 and any of the previously scanned first tubes 1005. In a case in which the data of the first tube 1005 matches data of one of the previously scanned first tubes 1005, as a paired first tube, a determination is made that the first tube 1005 has a paired first tube that has already been placed in the pairing platform 4070 (YES in step 12025). Then, the method 12000 includes a step 12030 of retrieving a stored location of the paired first tube 1005 in one of the pairing platforms 4070, and a step 12035 of instructing the pairing robot 4005 to place the first tube 1005 in a slot adjacent to the location of the paired first tube 1005.

And, in a case in which the data of the one other tube does not match data of any other first tubes 1005 scanned up to that point in time (NO in step 12025), the method 12000 may then include a step 12040 of determining, based on the identifying information, whether the first tube 1005 is a dummy tube 1005. The identifying information of dummy tubes 1005 may be stored in a database and/or in the memory 7005, and the determination may include retrieving the identifying information of dummy tubes 1005, comparing the identifying information of the first tube 1005, and if the identifying information has a match in the retrieved identifying information (YES in step 12040), then the determination is made that the first tube 1005 is a dummy tube 1005. Then, the method 12000 may proceed to the step 12045 of instructing the pairing robot 4005 to place the dummy tube 1005 into the dummy tube bin for disposal.

If the identifying information of the first tube 1005 does not match identifying information of dummy tubes 1005 retrieved from the database (NO in step 12040), then the first tube 1005 is determined not to be a dummy tube 1005. Then, the method 12000 includes a step 12050 of instructing the pairing robot 4005 to place the first tube 1005 in the pairing platform 4070, adjacent to an empty slot 4075, to allow for placement of a paired tube if such a paired tube is identified during subsequent processing of the remainder of the first tubes 1005 in the first insert 1055. The location of the unpaired tube and the adjacent empty slot 4075 in the pairing platform 4070 may also be stored, and the first tube 1005 may be assigned a label of “unpaired tube.” If, during subsequent processing of the remainder of the first tubes 1005 in the first insert 1055, a first tube 1005 with matching data is scanned by the pairing scanner 4065, then the label of “unpaired tube” may be changed to “paired tube.”

With reference to FIG. 48B, after placing a first tube 1005 into one of the slots 4075 of the pairing platform 4070 or placing a dummy tube 1005 into the dummy tube bin, the method 12000 proceeds to a step 12055 of determining whether all first tubes 1005 in a first insert 1055 have been scanned and placed on the pairing platform 4070, the sequestration tray, or the dummy tube bin. This determination may be made by comparing a count of a number of first tubes 1005 picked up from a first insert 1055 to a predetermined total number of first tubes 1005 contained in the first insert 1055. When the count has not yet reached the predetermined total number of tubes (NO in step 12055), the method 12000 will return to the step 12005 of instructing the pairing robot 4005 to pick up another first tube 1005 from the first insert 1055. And, when the count has reached that predetermined total number (YES), this indicates that all first tubes 1005 have been scanned and placed in the second module 3000. The method 12000 may also include a step 12060 of instructing the pairing robot 4005 to place the emptied first insert 1055 into the second module return channel 3020 for disposal or reuse. The method 12000 shown in FIGS. 48A and 48B may be repeated each time the second module control method 11000 is performed and indicates a first insert 155 with first tubes 1005 is located at an output end 2050 of a second module conveyor channel 2005. The method 12000 may also include a step 12065 of instructing the excising robot 4010 to pick up the first tubes 1005 from the pairing platform 4070 and place them on the lift 4145. This latter step may be performed as part of the control method of the excising station 4055 of the third module 4000.

### 2. Excising Station Control

FIG. 49 is a flowchart of a control method 13000 for the excising station 4055 of the third module 4000. The method 13000 may include a step 13005 of instructing the excising robot 4010 to pick up first tubes 1005 from the pairing platform 4070 and place the first tubes 1005 on the lift 4145 of the excising station 4055. The method 13000 may further include a step 13010 of instructing the blade actuators 4155 to rotate or move the blades 4150 from the first position to the second position, or otherwise moving the blades 4150 to a position in which they are able to make contact with the first tubes 1005 in step 13015, if the blades 4150 are not in such a position. If the blades 4150 are in a position to contact the first tubes 1005 in step 13015, then step 13010 may be omitted from method 13000. Further, the method 13000 may include a step 13015 of instructing the lift 4145 to move upward, bringing the first tubes 1005 through the blades 4150 in the second position, for excising or scraping of material on exterior surfaces of the first tubes 1005. The method 13000 may also include a step 13020 of instructing the blade actuators 4155 to rotate the blades 4150 back to the first position, to be spaced relatively further apart from one another. Then, the method 13000 includes a step 13025 of instructing the excising robot 4010 to lift the first tubes 1005 from the lift 4145, for subsequent image processing.

In some embodiments, the excising station 4055 may not include a lift 4145 and instead, the method 13000 may include a step of instructing the excising robot 4010 to pick up the first tubes 1005 from the pairing platform 4070, and to lower the first tubes 1005 in between the blades 4150, while the blades 4150 are in the first position. Then, the method 13000 may include a step (not shown) of instructing the blade actuators 4155 to rotate the blades 4150 from the first position to the second position. Then, the method 13000 may include instructing the excising robot 4010 to move the first tubes 1005 upward or downward, between the blades 4150 in the second position. Then, the first tubes 1005 may be moved to the imaging station 4160 for imaging processing.

### 3. Imaging Station Control

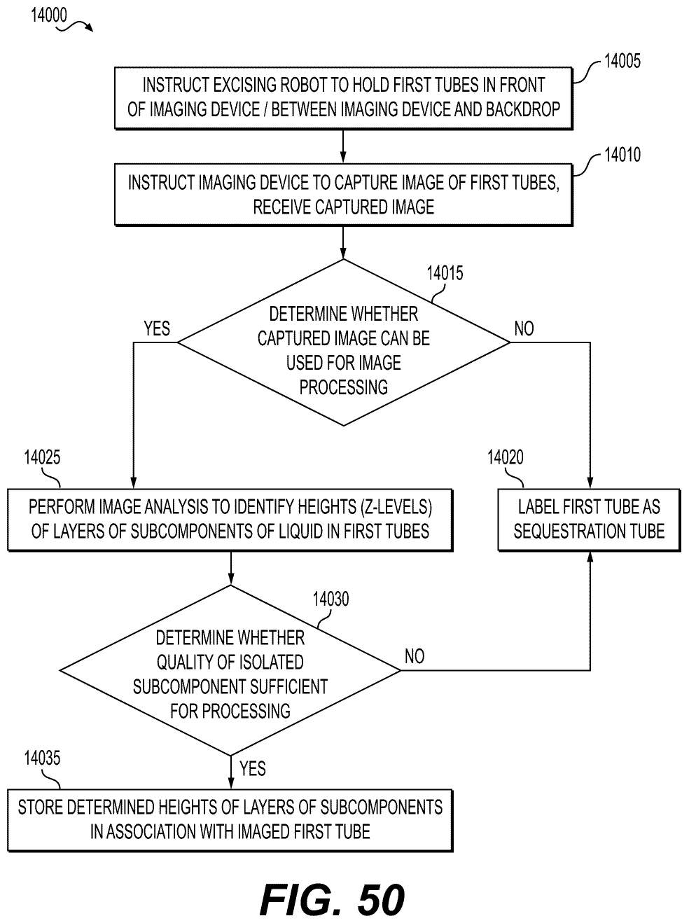

FIG. 50 is a flowchart of a control method 14000 for the imaging station 4160 of the third module 4000. The method 14000 may include a step 14005 of instructing the excising robot 4010 to pick up the first tubes 1005 from the lift 4145 of the excising station 4055 and move the first tubes 1005 to a location between the imaging device 4165 and the backdrop 4170. Then, the method 14000 includes a step 14010 of instructing the imaging device 4165 to capture an image 4175 of the first tubes 1005, and receiving the captured image 4175 from the imaging device 4165. Then, the method 14000 may include a step 14015 of determining whether the captured image 4175 can be used for image analysis. As an example, the captured image 4175 of one or more of the imaged first tubes 1005 may be used for image analysis in a case in which an image processing program can discern, from the captured image 4175 of a given first tube 1005, heights (z-heights) of layers of subcomponents of the liquid in the first tube 1005. If the heights of the layers of subcomponents can be discerned (YES in step 14015), then the captured image 4175 is considered usable for image analysis as to that first tube 1005. In a case in which the image processing program cannot discern z-heights of layers of subcomponents of the liquid in a given first tube 1005 (NO in step 14015), then the method 14000 includes a step 14020 of labelling the first tube 1005 as a tube to be sequestered, or as a “sequestration tube,” to be disposed of downstream in processing. As an example, heights of layers of subcomponents may not be discernable if portions of labels remain on an exterior surface of the first tube 1005 following the excising process. First tubes 1005 labelled for sequestration may then be placed into a sequestration rack (not shown) and may not get placed in the first turntable 4025. Further, if one first tube 1005 of a pair is labelled for sequestration, the other first tube 1005 of the pair is also labelled for sequestration, and both first tubes 1005 of the pair are placed into the sequestration rack. In some embodiments, the method 14000 may include a step (not shown) of outputting a notification to an operator to check the excising station 4055 for issues or malfunctions, such as damaged or worn blades, e.g., upon determining that layers of subcomponents are not discernable in one or more first tubes 1005.

In other aspects, in a case in which the image processing program cannot discern z-heights of layers of subcomponents of the liquid in a given first tube 1005 (NO in step 14015), then the excising robot 4010 may be instructed to rotate the first tube 1005, and the imaging device 4165 may be instructed to capture another image 4175 of the first tubes 1005, prior to labelling the tube as a “sequestration tube.” This may prevent a first tube 1005 from being labeled as a “sequestration tube” in the event that the window where labels had been excised on the tube simply hadn't aligned properly with the imaging device 4165.

Upon determining that the captured image 4175 can be used for image analysis (YES in step 14015), the method 14000 may further include a step 14025 of performing the image analysis, which may include analyzing the received image 4175 to determine a height of different layers of subcomponents of the liquid in the first tubes 1005. As an example, the image analysis may include identifying an individual first tube 1005 in the image, including a top end and a bottom end, and detecting points between the top end and the bottom end at which there is a color change, the color change indicating a height of one of the layers of the subcomponents, and storing, as information associated with the first tube 1005, these points as determined heights of layers of subcomponents of the liquid. As a specific example, the layers may be a red blood cell layer L3, a buffy coat red layer L2, and a plasma layer L1.

The method 14000 may also include a step 14030 of determining, using another image analysis, whether a quality of one of the layers of subcomponents is sufficient for downstream processing. As a specific example, in a case where one of the layers is a plasma layer L1, as a subcomponent of blood from a blood sample, the image analysis may include evaluating an amount of red within the plasma layer L1, by comparing a color of the plasma layer L1 to a color chart, stored in the memory 7005.

The output from the comparison to the color chart may be referred to as a “hemolysis grade.” In some embodiments, the hemolysis grade may also be a quantity of hemoglobin per mL (for example, X g of hemoglobin per mL of plasma), using the color chart a guide. The value of X can be predetermined and modified as needed. If the hemolysis grade is low, meaning the plasma layer L1 is darker than a predetermined limit on the color chart, the sample fails, and the first tube containing the too-red-plasma layer L1 is labeled as a sequestration tube.

If the plasma layer L1 is too red, that may indicate the blood sample is homolycized, and the quality of the plasma is determined to be not sufficient for processing (NO in step 14030). In that case, controller 7000 will store, as data associated with the first tube 1005 containing the blood sample, an indicator that the first tube 1005, and its pair, should be sequestered, as the blood sample will not be of sufficient quality for processing downstream of the automated liquid processing system 1000.

If the hemolysis grade is high, meaning the plasma layer L1 is lighter than the predetermined limit on the color chart, then the plasma of that first tube 1005 is determined to be of sufficient quality for subsequent processing (YES in step 14030), and the method 14000 includes a step 14035 of storing the determined heights of the layers of subcomponents of the liquid with that first tube 1005, in association with the imaged first tube 1005, in the memory 7005.

### 4. Liquid Handling Station Control

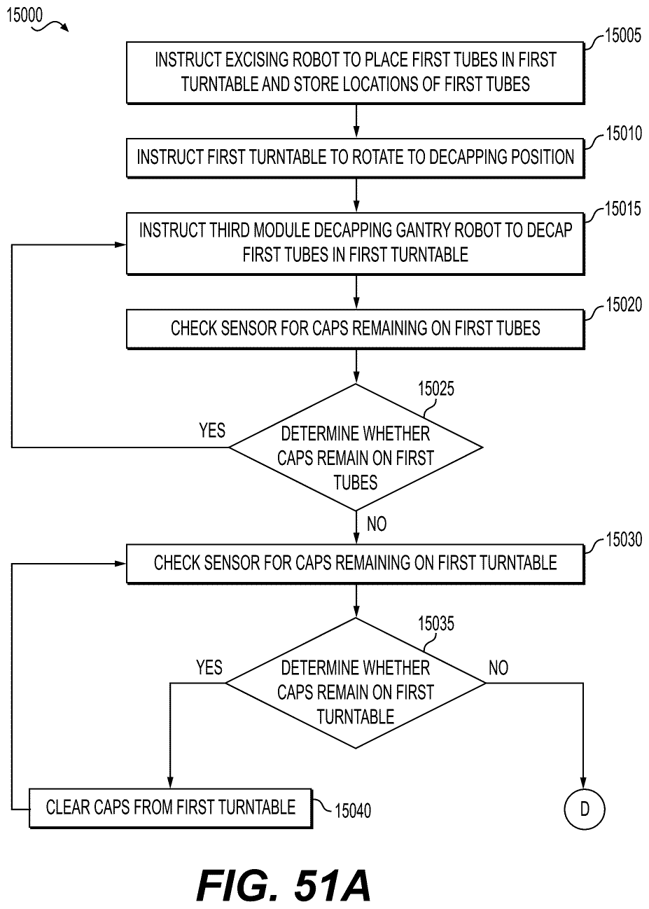

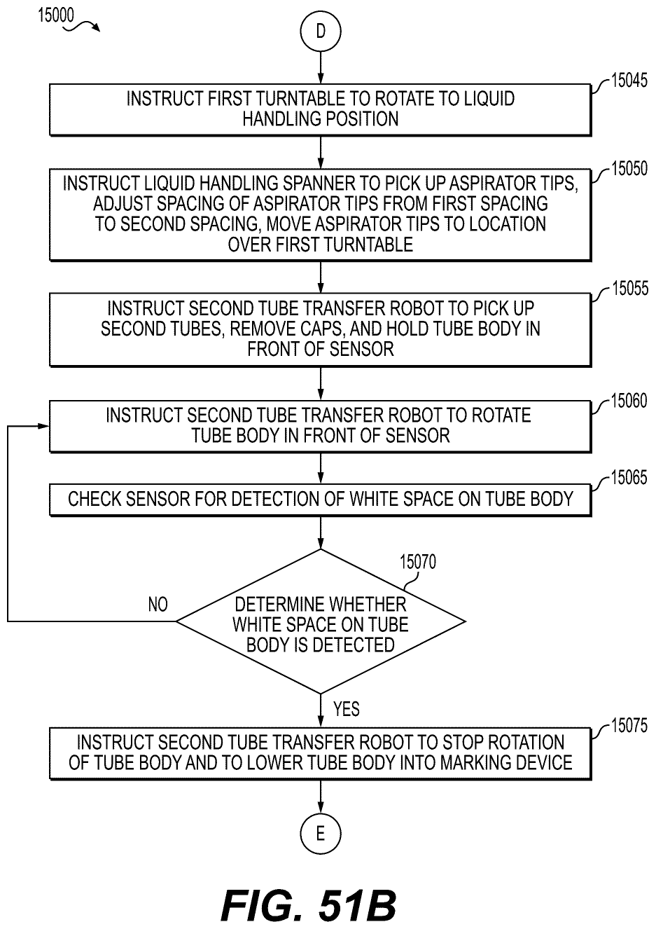

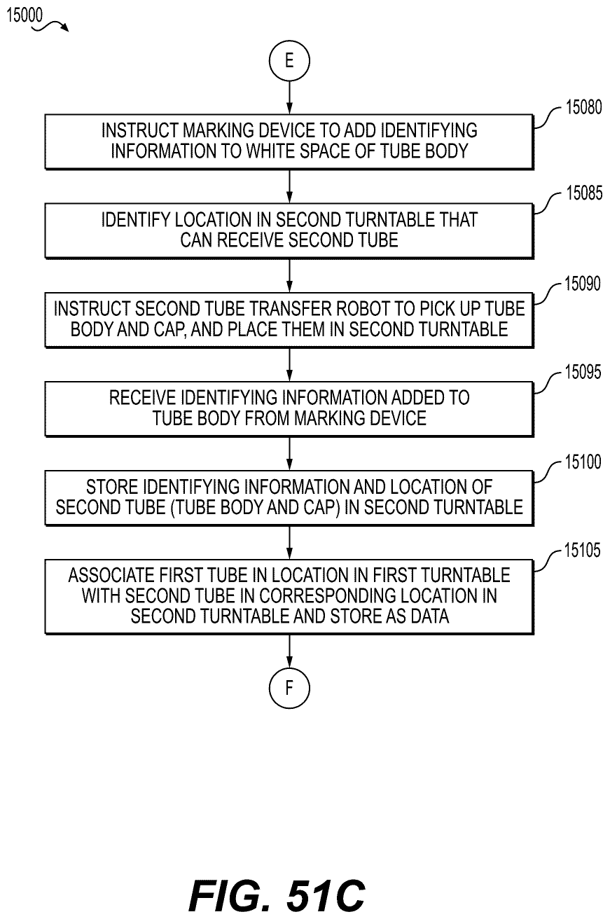

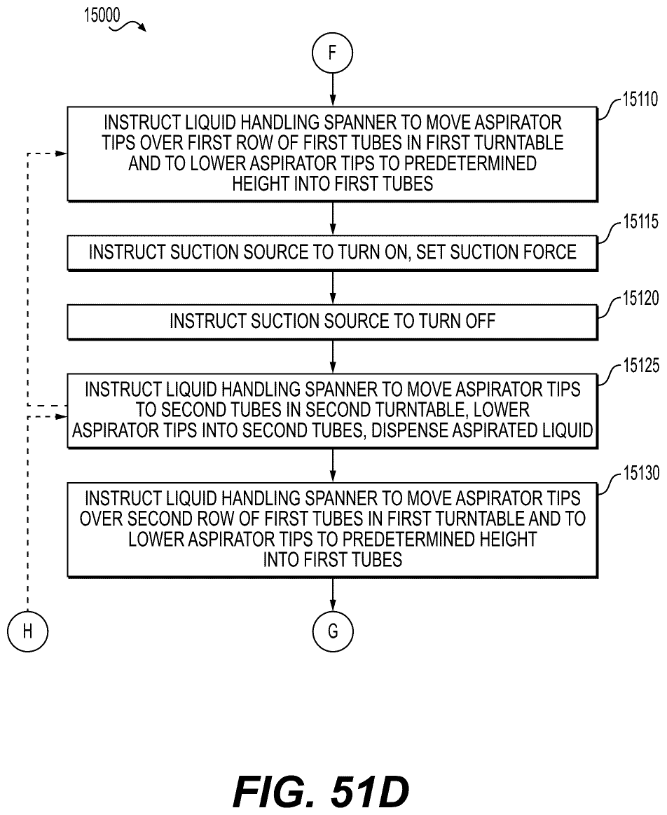

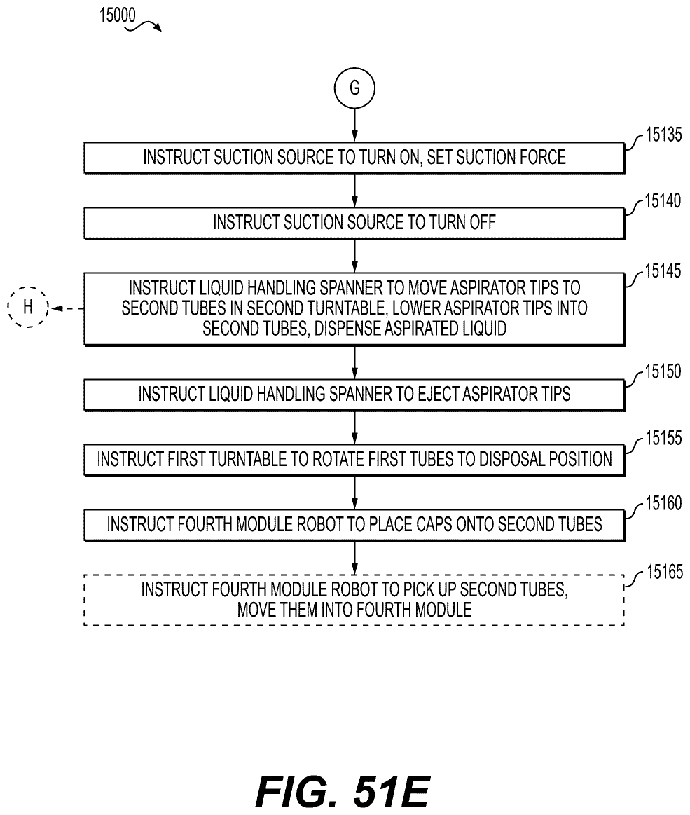

FIGS. 51A, 51B, 51C, 51D, and 51E show a flowchart of a control method 15000 for the liquid handling station 4015 of the third module 4000. With reference to FIG. 51A, the method 15000 may include a step 15005 of instructing the excising robot 4010 to place the first tubes 1005 in a portion of the first turntable 4025 in the loading position 4025a. The pairs of first tubes 1005 are placed in two adjacent slots 4075. Any unpaired first tubes 1005 may be placed in a first, inner row of slots 4075, and the adjacent outer slot 4075 may remain empty. The method 15000 may further include a step 15010 of instructing the first turntable 4025 to rotate the portion which received the first tubes 1005 to the decapping position 4025b, and a step 15015 of instructing the third module decapping gantry robot 4185 to remove the first tube caps 1075 from the first tubes 1005. This may include instructions to move to a position in between a first pair of the first tubes 1005 in the decapping position, then to move in a first direction, knocking a first tube cap 1075 out of one of the pair of the first tubes 1005, and then in a second, opposite direction, knocking a first tube cap 1075 out of the other of the pair of the first tubes 1005. This step 15015 may be repeated for each of the pairs of first tubes 1005 on the first turntable 4025 in the decapping position 4025b.

The method 15000 may also include a step 15020 of checking a sensor configured to detect the presence of first tube caps 1075 on the first tubes 1005, and determining, based on an output from the sensor, whether any first tube caps 1075 remain on the first tubes 1005. If it is determined that any first tube caps 1075 remain on the first tubes 1005 (YES in step 15025), then the method 15000 returns to the step 15015 of instructing the third module decapping gantry robot 4185 to remove the first tube caps 1075, and the process is repeated until it is determined that no first tube caps 1075 remain on the first tubes 1005. Then, when it is determined that no first caps 1075 remain on the tubes (NO), the method 15000 proceeds to a step 15030 of checking a sensor, located on the first turntable 4025, that is configured to detect the presence of first tube caps 1075 on the surface of the first turntable 4025, e.g., in between the rows of first tubes 1005. The method 15000 then includes a step 15035 of determining, based on an output from the sensor, whether any first tube caps 1075 remain on the surface of the first turntable 4025 in between the rows of first tubes 1005. If it is determined that any first tube caps 1075 remain on the first turntable (YES in step 15035), then the method 15000 includes a step 15040 of instructing the third module decapping gantry robot 4185 to sweep through the space between the rows of first tubes 1005, to clear the first tube caps 1075 from the first turntable 4025. With reference to FIG. 51B, after the first tube caps 1075 have been cleared from the first turntable 4025, and in a case in which no first tube caps 1075 are detected on the first turntable (NO in step 15035), the method 15000 includes a step 15045 of instructing the first turntable 4025 to rotate the portion of holding the decapped first tubes 1005 to the liquid handling position 4025c, for the liquid handling process.

Again, with reference to FIG. 51B, as part of the liquid handling process, the method 15000 includes a step 15050 of instructing the third module liquid handling spanner 4020 to pick up third module aspirator tips 4045 from the third module aspirator tip racks 4040 loaded onto the third module aspirator tip rack conveyor 4115. The step 15050 may also include instructing the third module liquid handling spanner 4020 to change a spacing (if needed) of the picked up third module aspirator tips 4045 from a first spacing, in which the third module aspirator tips 4045 were picked up, to a second spacing, which corresponds to a spacing of the first tubes 1005 in the slots 4075 on the first turntable 4025. In addition, the method 15000 may include instructing the third module liquid handling spanner 4020 to move the third module aspirator tips 4045 over the portion of the first turntable 4025 that is in the liquid handling position 4025c. In some aspects, the spacing between the third module aspirator tip racks 4040 and the spacing of the slots 4075 may be the same, and no movement or adjustment may be needed.

The method 15000 may further include a step 15055 of instructing the second tube transfer robot 4100 to pick up a second tube 1010 and place the tube 1010 in a slot on the third module deck 4035. The step 15055 may also include instructing the second tube transfer robot 4100 to remove the cap 1090 from the second tube 1010 in the slot, to pick up the tube body 1080 remaining in the slot, and to hold the tube body 1080 in front of a sensor on the gripping and marking device 4105. Further, the method 15000 includes a step 15060 of instructing the second tube transfer robot 4100 to rotate the tube body 1080 until the sensor detects the white space 1100 on the tube body 1080. The method 15000 may include a step 15065 of checking the sensor for detection of the white space 1100 on the tube body 1080, and a step 15070 of determining whether the white space 1100 on the tube body 1080 is detected. If the white space 1100 on the tube body 1080 is not detected (NO in step 15070), then the method 15000 returns to the step 15060 of instructing the second tube transfer robot 4100 to rotate the tube body 1080 in front of the sensor, and the process is repeated until the white space 1100 on the tube body 1080 is detected. Once the white space 1100 on the tube body 1080 is detected (YES in step 15070), the method 15000 includes a step 15075 of instructing the second tube transfer robot 4100 to stop rotation of the tube body 1080 and to lower the tube body 1080 into the marking device 4285. Then, with reference to FIG. 51C, the method 15000 includes a step 15080 of instructing the marking device 4285 to add identifying information to the white space 1100 on the tube body 1080.

Again, with reference to FIG. 51C, the method 15000 may also include a step 15085 of identifying a location in the second turntable 4030 that can receive a second tube 1010. This identifying process may include receiving locations of sequestration tubes identified based on the image analysis, shown in FIG. 50, and the stored locations of the first tubes 1005 in the first turntable 4025. Based on the locations of the sequestration tubes, the step 15085 may include designating slots in the second turntable 4030 which correspond in location in a grid, e.g., a one by eight grid, to slots on the first turntable 4025 that contain sequestration tubes, as “skip slots,” which the second tube transfer robot 4100 is to skip when placing second tubes 1010 into the second turntable 4030.

Then, the method 15000 includes a step 15090 of instructing the second tube transfer robot 4100 to pick up the tube body 1080 from the marking device 4285, and the cap 1090 for the tube body 1080, and to place the tube body 1080 and the cap 1090 in adjacent slots 4080 on a portion of the second turntable 4030 in the loading position 4080a. The method 15000 may also include a step 15095 of receiving the added identifying information for a second tube 1010 from the marking device 4285, and a step 15100 of storing, as data associated with the second tube 1010, the received identifying information and a location of the second tube 1010 once placed in the second turntable 4030. The method 15000 may also include a step 15105 of associating the second tube 1010 and its location with a first tube 1005 in a corresponding location on the first turntable 4025, and storing this association in the memory 7005.

With reference to FIG. 51D, next, the method 15000 includes a step 15110 of instructing the third module liquid handling spanner 4020 to move the third module aspirator tips 4045 over the first row of the first tubes 1005 in the portion of the first turntable 4025 in the liquid handling position 4025c. Then, the third module liquid handling spanner 4020 may lower the third module aspirator tips 4045 into the first tubes 1005 in the first row. The method 15000 also includes a step 15115 of instructing the suction source to turn on, thereby providing a suction force to aspirate plasma from the first tubes 1005. As described above, a flowrate and/or a z-speed of the third module aspirator tips 4045 may be set to variable or constant values, based on the image analysis and a determined volume (or height) of plasma in each first tube 1005. The flowrate and the z-speed may also be based on the determined heights of the layers of the blood samples, a diameter of an orifice size of the third module aspirator tips 4045, a density of the blood sample and/or of the plasma, and the power of the suction source. Once the plasma has been aspirated, the method 15000 includes a step 15120 of turning the suction source off. This step 15120 may include closing an opening at a top of the third module aspirator tips 4045 through which suction may be communicated, so that the plasma aspirated into the third module aspirator tips 4045 is held in the third module aspirator tips 4045 for the next step of the method 15000.

Then, the method 15000 includes a step 15125 of instructing the third module liquid handling spanner 4020 to move the third module aspirator tips 4045 to the second turntable 4030. By moving the third module liquid handling spanner 4020 to the second turntable 4030, the controller 7000 moves the third module aspirator tips 4045 to be above the second tubes 1010. This step 15125 may also include instructing the third module liquid handling spanner 4020 to lower the third module aspirator tips 4045 into the second tubes 1010, and to dispense the plasma held in each of the second tubes 1010. The instruction to dispense the plasma may include opening a top (or unsealing an opening at a top) of the third module aspirator tips 4045, to allow the plasma to fall into the second tubes 1010.

The method 15000 may include a step 15130 of instructing the third module liquid handling spanner 4020 to return to the first turntable 4025, and to position the third module aspirator tips 4045 over first tubes 1005 in a second row on the first turntable 4025, and to lower the third module aspirator tips 4045 into the first tubes 1005 in the second row. With reference to FIG. 51E, the method 15000 may further include a step 15135 of instructing the suction source to begin suction of plasma from the first tubes 1005 in the second row, a step 15140 of instructing the suction force to turn off and/or closing the opening at the top of the third module aspirator tips 4045 to hold the aspirated plasma within the third module aspirator tips 4045, and a step 15145 of instructing the third module liquid handling spanner 4020 to move the third module aspirator tips 4045 to the second turntable 4030, to lower the third module aspirator tips 4045 into the second tubes 1010, and to dispense the plasma into the second tubes 1010. In some embodiments, the method may include instructing the liquid handling spanner 4085 to repeat the steps relating to aspirating plasma from the first row of first tubes 1005 and dispensing the plasma into the second tubes 1010, and instructing the liquid handling spanner 4085 to also repeat the steps relating to aspirating plasma from the second row of first tubes 1005 and dispensing the plasma into the second tubes 1010.

The method 15000 may also include a step 15150 of instructing the third module liquid handling spanner 4020 to eject the third module aspirator tips 4045 after completing the transfer of plasma from one or more pairs of first tubes 1005 on the first turntable 4025 to corresponding second tube 1010 on the second turntable 4030. Further, the method 15000 may include a step 15155 of instructing the first turntable 4025 to rotate to the tube disposal position 4025d, such that the first tubes 1005 fall through the slots 4075 on the first turntable 4025, through the first tube disposal opening 4215, and into a first tube disposal container 4325. The method 15000 may also include a step 15160 of instructing a fourth module robot 5015 to pick up the caps 1090 on the second turntable 4030 and place the caps 1090 back onto the second tubes 1010. The method 15000 may also include a step 15165 of instructing the fourth module robot 5015 to pick up and move the recapped second tubes 1010 into the fourth module 5000. This latter step may be included as part of the control method of the fourth module 5000.

### D. Fourth Module Control

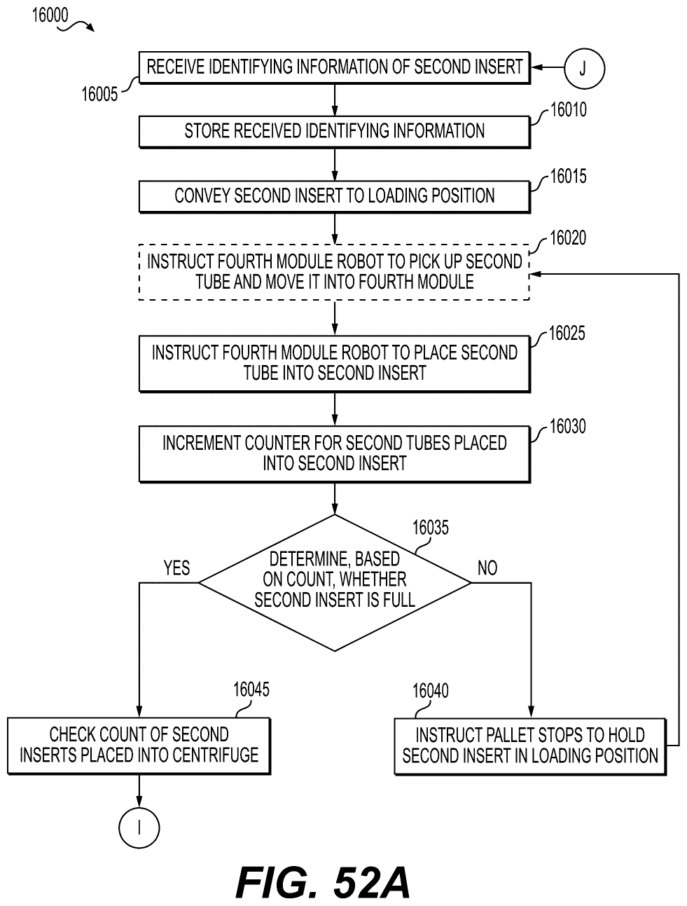

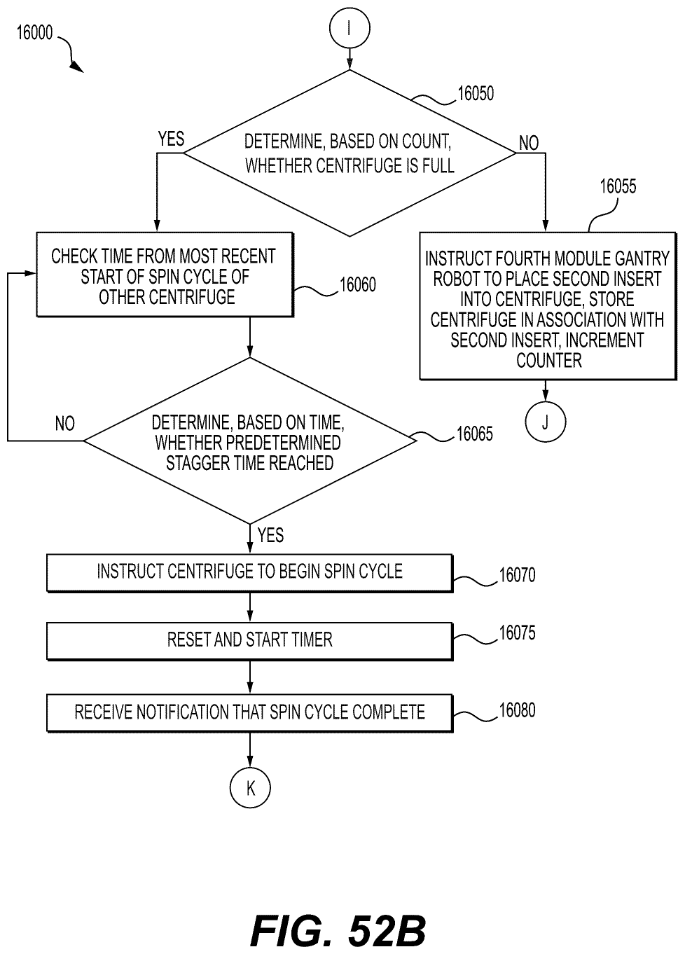

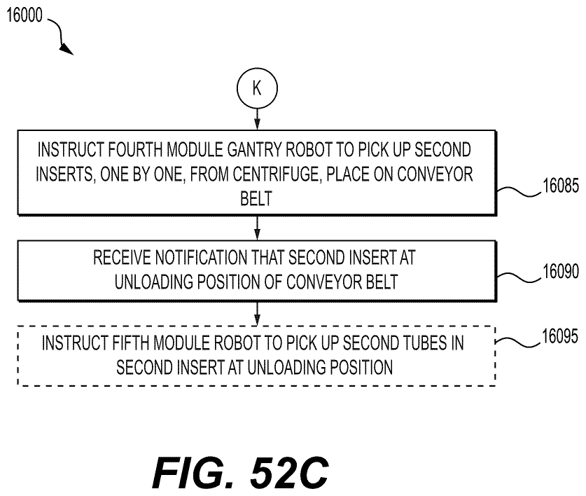

FIGS. 52A, 52B, and 52C show a flowchart of a control method 16000 for the fourth module 5000. With reference to FIG. 52A, the method 16000 may include a step 16005 of receiving, from one of the fourth module scanners 5030, a second insert 1105 loaded onto the pallet conveyor system 5020, and a step 16010 of storing identifying information of the scanned second inserts 1105 in memory 7005 of controller 7000. Then, the method 16000 may include a step 16015 of conveying the second insert 1105 to a loading position 5020a. Then, the method 16000 may include a step 16020 of instructing the fourth module robot 5015 to pick up the second tubes 1010 from the second turntable 4030 in the third module 4000, and a step 16025 of instructing the fourth module robot 5015 to place the second tubes 1010 into slots in the second insert 1105 located in the loading position 5020a. The step 16025 may also include storing, in the memory 7005, the identifying information of the second tubes 1010 picked up from the second turntable 4030 in association with the second insert 1105 into which the second tubes 1010 are placed, thus registering and/or tracking the second tubes 1010 entering the fourth module 5000. Then, the method 16000 may include a step 16030 of incrementing a counter for each second tube 1010 placed into the second insert 1105. Then, the method 16000 includes a step 16035 of determining, based on a total count of the counter, whether the second insert 1105 is full. If the second insert 1105 is not full (NO in step 16035), the method 16000 may include a step 16040 of instructing pallet stops 5055 of the pallet conveyor system 5020 to hold the second inserts 1105 in position, and then returning to the step 16020 of instructing the fourth module robot 5015 to pick up second tubes 1010 from the second turntable 4030. Upon determining that the second inserts are full (YES in step 16035), the method 16000 includes a step 16045 of instructing the conveyor belt 5050 of the pallet conveyor system 5020 to rotate, thereby moving the full second insert 1105 to the pick-up position 5020b.

The method 16000 may then include a step 16045 of checking a count of second inserts 1105 placed into the fourth module centrifuges 5010. With reference to FIG. 52B, the method 16000 may then include a step 16050 of determining, based on the count, whether the fourth module centrifuge 5010 is full. If the fourth module centrifuge 5010 is not full (NO in step 16050), then the method 16000 may include a step 16065 of instructing the fourth module gantry robot 5035 to pick up the second insert 1105 and place it into one of the fourth module centrifuges 5010. This step may include storing in memory 7005, as information associated with the second insert 1105, an identifier of the fourth module centrifuge 5010 into which the second insert 1105 was placed. This step may also include incrementing a count of a number of second inserts 1105 placed into the fourth module centrifuge 5010.

Again, with reference to FIG. 52B, if it is determined that the fourth module centrifuge 5010 is full (YES in step 16050), then, in one embodiment, the method 16000 may also include a step 16060 of checking a time from a most recent start of a spin cycle of another one of the fourth module centrifuges 5010, and a step 16065 of determining, based on the time, whether a predetermined stagger time has been reached. If the predetermined stagger time has not been reached (NO in step 16065), then the method 16000 returns to the step 16060 of checking the time from the most recent start of the spin cycle of another fourth module centrifuge 5010. If the predetermined stagger time has been reached (YES in step 16065), then the method 16000 may include a step 16070 of instructing the full fourth module centrifuge 5010 to begin the spin cycle. Then, the method 16000 includes a step 16075 of resetting and starting the timer. The method 16000 may also include a step 16080 of receiving a notification from the fourth module centrifuge 5010 that the spin cycle has been completed. In other embodiments, e.g., if the timing of the fourth module centrifuges is not staggered, then the method 16000 may proceed from the step 16050 directly to step 16070, and from 16070 directly to step 16080.

With reference to FIG. 52C, the method 16000 may include a step 16085 of instructing the fourth module gantry robot 5035 to pick up the second inserts 1105 in the fourth module centrifuge 5010 that has completed the spin cycle, and to place the second inserts 1105 on the pallet conveyor belt 5050. The second inserts 1105 are then conveyed to the unloading position 5020d of the pallet conveyor system 5020. The method 16000 may also include a step 16090 of receiving a notification that a second insert 1105 is located in the unloading position 5020d of the conveyor belt 5050. The method 16000 may then include a step 16100 of instructing the fifth module turntable load robot 6005 to pick up the second tubes 1010 from the fourth module 5000 and place the second tubes 1010 into a fifth module turntable 6040. The latter step may be part of the control method of the fifth module 6000, described below.

### E. Fifth Module Control

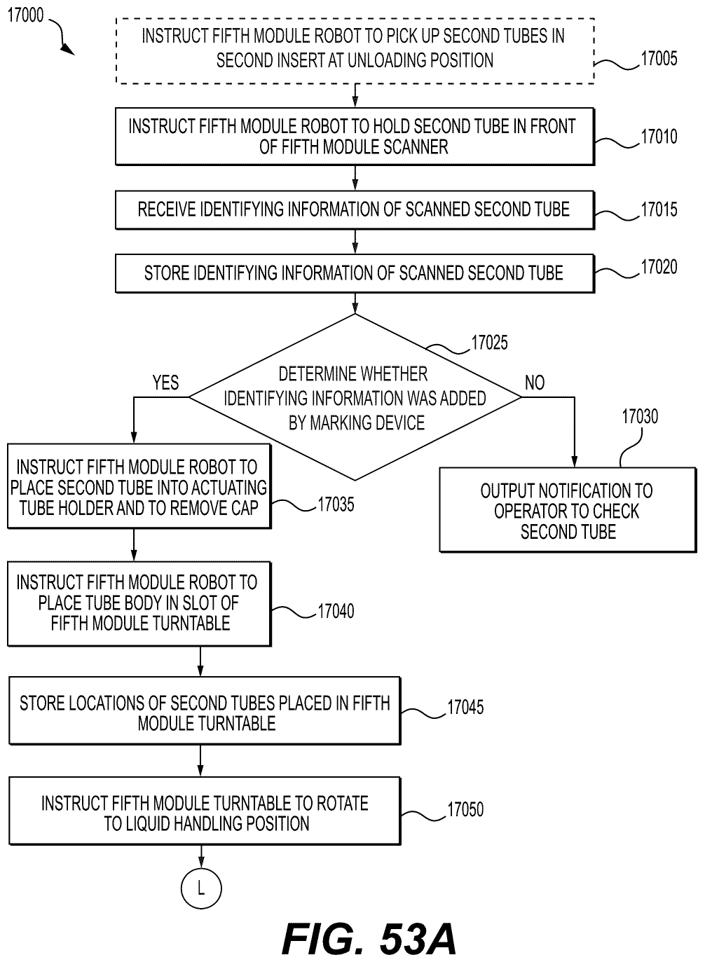

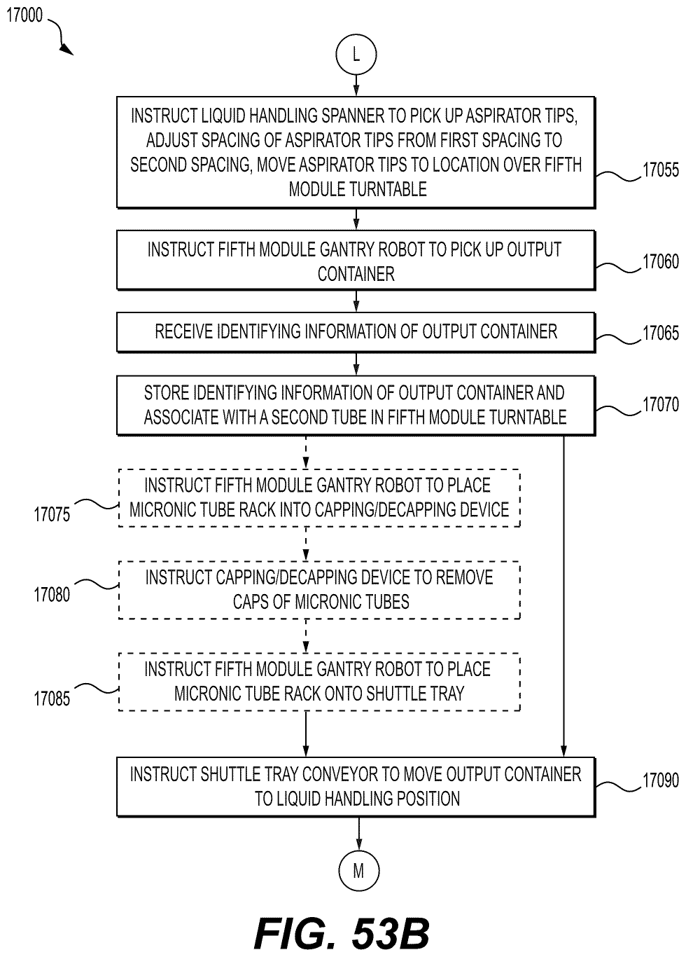

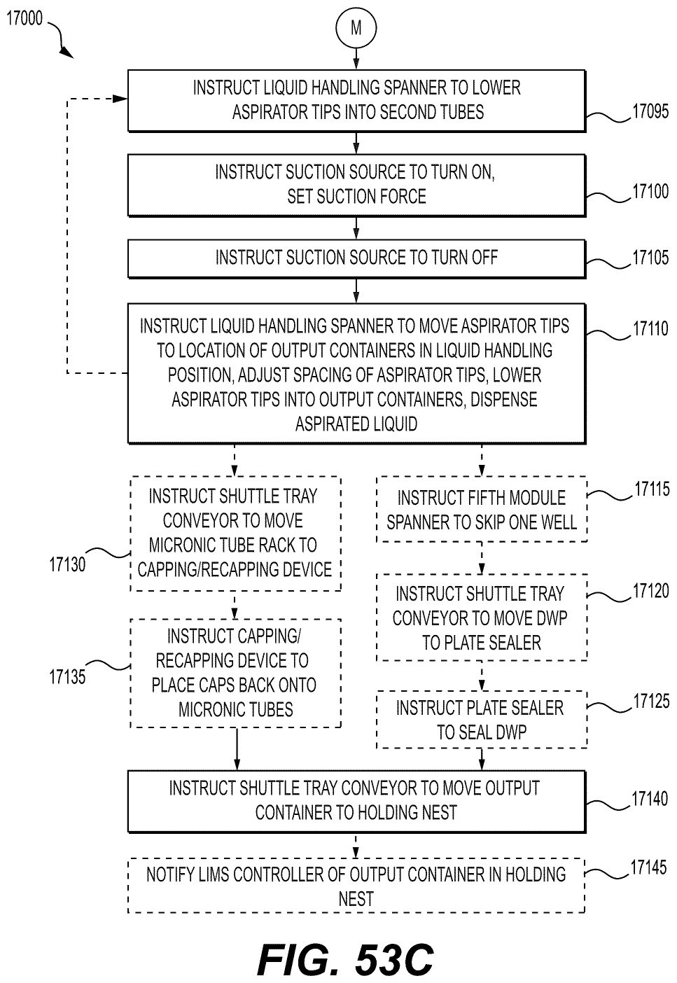

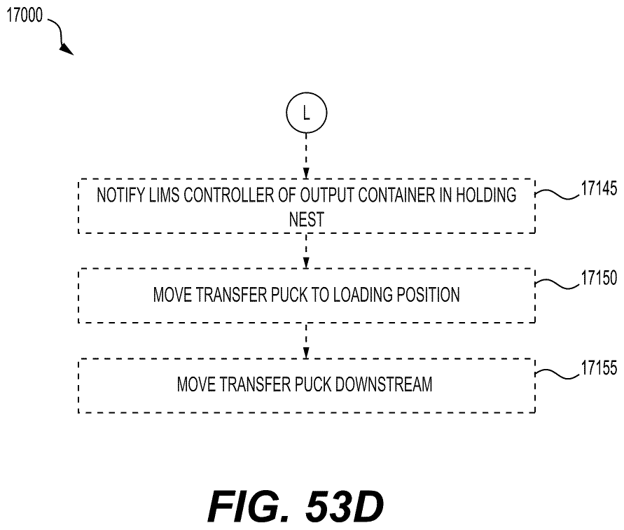

FIGS. 53A, 53B, 53C, and 53D show a flowchart of a control method 17000 for the fifth module 6000. The method 17000 may include a step 17005 of instructing the fifth module turntable load robot 6005 to pick up the second tubes 1010, one at a time or multiple at a time, from the second inserts 1105 in the unloading position 5020d of the pallet conveyor system 5020. The method 17000 may further include a step 17010 of holding each picked up second tube 1010 in front of the fifth module scanner 6020 and a step 17015 of receiving, from the fifth module scanner 6020, identifying information for the second tube 1010. The method 17000 may also include a step 17020 of storing, in the memory 7005, the received identifying information of the second tube 1010, to register and/or track the location of that second tube 1010 as it enters the fifth module 6000. The method 17000 may also include a step 17025 of determining whether the identifying information of the scanned second tube 1010 corresponds to identifying information that was added to the second tube 1010 by the marking device 4285 in the third module 4000. In a case in which the identifying information of the second tube 1010 does not correspond to identifying information added to any second tube 1010 by the marking device 4285 (NO in step 17025), the method 17000 may include a step 17030 of outputting a notification to prompt the operator to confirm whether the second tube 1010 should continue being processed. If it is determined that the identifying information of the second tube 1010 does correspond to identifying information added by the marking device 4285 (YES in step 17025), the method 17000 then includes a step 17035 of instructing the fifth module turntable load robot 6005 to place the second tubes 1010 into the actuating tube holder 6007, and to remove the cap 1090 from the tube body 1080. Then, the method 17000 includes a step 17040 of instructing the fifth module turntable load robot 6005 to place the tube body 1080 into a slot 6095 on a portion of the fifth module turntable 6040 that is in the loading position 6040a. The method 17000 may also include a step 17045 of storing, in the memory 7005, the locations of the slots 6095 into which each tube body 1080 of each scanned second tube 1010 is placed, in order to register and/or track the location of each tube body 1080 of the scanned second tube 1010 in the fifth module 6000. In some embodiments, the fifth module turntable load robot 6005 may be instructed to remove the caps 1090 of the second tubes 1010 after the second tubes 1010 have been placed in the fifth module turntable 6040. After the slots 6095 on the portion of the fifth module turntable 6040 are filled with tube bodies 1080 of second tubes 1010, the method includes a step 17050 of instructing the fifth module turntable 6040 to rotate the portion containing the tube bodies 1080 (that is, the decapped second tubes 1010) to the liquid handling position 6040b.

With reference to FIG. 53B, the method 17000 may further include a step 17055 instructing the fifth module liquid handling spanner 6075 to pick up fifth module aspirator tips 6055 from the fifth module aspirator tip racks 6080 loaded onto plate shuttles 6060 on the fifth module deck 6035, to adjust (if needed) a spacing of the picked up fifth module aspirator tips 6055 from a first spacing, in which the fifth module aspirator tips 6055 were picked up, to a second spacing, which corresponds to a spacing of the second tubes 1010 in the slots 6095 on the fifth module turntable 6040, and to move the aspirator tips 6055 to a location over the uncapped second tubes 1010 in the portion of the fifth module turntable 6040 in the liquid handling position 6040b.

The method 17000 may also include a step 17060 of instructing the fifth module gantry robot 6010 to pick up an output container 1030, for example, a DWP 1025 and/or a micronic tube rack 1020, loaded onto the fifth module deck 6035. The method 17000 may also include a step 17065 of receiving, from the fifth module scanner 6020, identifying information of the picked up DWP 1025 and/or the micronic tube rack 1020, and a step 17070 of storing the received identifying information. In a case in which a micronic tube rack 1020 is picked up, the method 17000 may include a step 17075 of instructing the fifth module gantry robot 6010 to place the micronic tube rack 1020 into the capping and decapping device 6025, and a step 17080 of instructing the capping and decapping device 6025 to remove the caps 1110 from the micronic tubes 1015 on the micronic tube rack 1020. Then, the method 17000 includes a step 17085 of instructing the fifth module gantry robot 6010 to place the micronic tube rack 1020 with the decapped micronic tubes 1015 onto the plate shuttles 6060 on the plate shuttle tracks 6070, and a step 17090 of instructing the plate shuttle conveyor system 6065 to move the plate shuttles 6060 to a liquid handling position.

With reference to FIG. 53C, the method 17000 includes a step 17095 of instructing the fifth module liquid handling spanner 6075 to lower the fifth module aspirator tips 6055 into the second tubes 1010. Then, the method 17000 may include a step 17100 of instructing the suction source to begin suction of plasma from the second tubes 1010. As described above, an amount of plasma aspirated from each second tube 1010 may be determined by the controller 7000 based on amounts of plasma obtained and pooled during the liquid handling process in the third module 4000. Once the plasma has been aspirated, the method 17000 includes a step 17105 of instructing the suction force to turn off. This step may include instructing the suction source to stop suction and/or to close an opening at a top of the fifth module aspirator tips 6055 through which suction may be communicated, so that the plasma aspirated into the fifth module aspirator tips 6055 is held in the fifth module aspirator tips 6055 as the fifth module liquid handling spanner 6075 moves to the liquid dispensing position. Then, the method includes a step 17100 of instructing the fifth module liquid handling spanner 6075 to remove the fifth module aspirator tips 6055 from the second tubes 1010 and to move the aspirator tips 6055 to a location over the DWPs 1025 and/or micronic tubes 1015 located at the liquid handling position. This step may also include instructing the fifth module liquid handling spanner 6075 to adjust (if needed) a spacing of the fifth module aspirator tips 6055 to correspond to a spacing of wells within the DWP 1025 or to a spacing of micronic tubes 1015 in the micronic tube rack 1020, depending on which type of output container 1030 is located in the liquid dispensing position, and instructing the fifth module liquid handling spanner 6075 to lower the fifth module aspirator tips 6055 into the DWP 1025 or the micronic tubes 1015, and to dispense the plasma. The instruction to dispense the plasma may include opening a top (or unsealing an opening at a top) of the fifth module aspirator tips 6055, to allow the plasma to fall into the wells of the DWP 1025 or into the micronic tubes 1015.

In some embodiments, the method 17000 may include instructing the fifth module liquid handling spanner 6075 to repeat the steps relating to aspirating plasma from the second tubes 1010 and dispensing the plasma into wells of the DWP 1025 or into micronic tubes 1015.

In some embodiments, the step 17110 includes receiving at controller 7000, from the liquid handling spanner 6075 of the third module 4000, a value of an amount of plasma dispensed into a second tube 1010, and determining, based on the received value of the amount of plasma, an amount of plasma to be dispensed into each well of the DWP 1025, into each micronic tube 1015, and/or into the DWP 1025 and into the micronic tubes 1015. That is, this step may include applying logic (described previously in section D. Liquid Handling Station of Fifth Module) to determine (1) an amount of plasma to be dispensed into each well of a DWP 1025, (2) an amount of plasma to be dispensed into each micronic tube 1015, or (3) amounts of plasma to be dispensed into the wells of the DWP 1025 and into micronic tubes 1015, for splitting of the plasma between the two types of output containers 1030.

In a case in which the plasma is dispensed into a DWP 1025, the method 17000 may include a step 17115 of instructing the fifth module liquid handling spanner 6075 to skip one well of the DWP 1025, which is to be a control. The determination of which well is to be skipped (that is, left empty) may be randomly determined by the controller 7000, for example, as a part of this control method 17000. Then, the method 17000 may include a step 17120 of instructing the plate shuttle conveyor system 6065 to move the DWP 1025 to the plate sealer 6030, and a step 17125 of instructing the plate sealer 6030 to seal the filled DWP 1025.

In a case in which the plasma is dispensed into micronic tubes 1015, the method 17000 may include a step 17130 of instructing the plate shuttle conveyor system 6065 to move the micronic tube rack 1020 to the capping and decapping device 6025, and a step 17135 of instructing the capping and decapping device 6025 to place the caps 1110 back onto the filled micronic tubes 1015. Then, the method may include a step 17140 of instructing the plate shuttle conveyor system 6065 to move the output container 1030, e.g., the DWP 1025 or the micronic tube rack 1020, to the holding nest 6090.

Then, with reference to FIG. 53D, the method 17000 may also include a step 17145 of notifying the LIMS controller 9000 that an output container 1030 is located in one of the holding nests 6090 and is ready for pick up and downstream processing. Further, the method 17000 may also include a step 17150 of moving a transfer puck on an adjacent track system to a loading position, in which the output container may be placed on the transfer puck by the fifth module gantry robot 6010, and a step 17155 of moving the transfer puck downstream on that adjacent track system to another location.

Although the control methods for each of the modules is described as a separate control method above, the control methods may be combined as a singular control method to control the entire automated liquid processing system 1000.

Further, although the control methods are described as including the steps noted above, the methods may include all or some of the steps described above. That is, the control method for each module may include a subset of the steps described above, or may include additional steps. Further one or more steps may be repeated, as needed, or may be performed in a different order that what is specifically described above.

In addition to the control methods described above, the controller 7000 may control intercommunication among the first to fifth modules and communication between the automated liquid processing system 1000 and the LIMS controller 9000.

### X. Benefits

The automated liquid processing system 1000 and related control method described herein may be capable of processing a relatively greater quantity of liquid samples, for example, blood samples, as compared to known systems and methods. Specifically, the automated liquid processing system 1000 and related control method may be capable of processing liquid samples taken on a population level, rather than just a sample of individuals. In some aspects, automated liquid processing systems of the present disclosure may be designed to process up to 500 tubes per 1 hour, which correlates to processing first tubes 1005 for up to one million patients per year. Using more than one automated liquid processing system 1000 correspondingly increases these estimated processing throughput quantities. The automated liquid processing system 1000 may also be capable of processing both single tubes and pairs of tubes simultaneously, which may eliminate the need for separate systems for processing single tubes versus pairs of tubes.

The ability of the automated liquid processing system 1000 to keep together and process two different patient samples in two different sample tubes, and then pool together isolated components from each liquid patient sample tube, may result in the ability to output from the automated liquid processing system 1000 more of the isolated component of interest than traditional processing systems. Depending on the type of liquid being processed, this may be important and may mean that downstream processing of the samples may be more accurate as a result of a larger amount of the relevant sample component may be available. In the example of a blood sample, the component of interest may be plasma. Certain components, such as plasma, may be difficult to extract sufficient quantities of from a single blood sample using traditional processing systems. In one aspect, if downstream testing and processing requires the analysis of cell free DNA (cfDNA), it may be difficult to have sufficient amounts of cfDNA in the plasma, or other liquid biopsy sample, to test, because of the low concentration of cfDNA available in a liquid biopsy sample. Accordingly, when an assay is performed on blood plasma, it may be difficult to generate sufficient signal to provide accurate test results to a patient. Automated liquid processing systems and methods provided herein may thus result in pooled sample components that may provide for more reliable assay results in downstream testing, and thus more accurate information to relay to the patient.

By virtue of controlling movement and aspiration of each third module aspirator tip 4045 for each first tube 1005, based on the image analysis of a captured image 4175 of the first tube 1005, it may be possible to withdraw as much of the isolated plasma in each first tube 1005 as possible, without disturbing the buffy coat red blood layer L2 or the red blood cell layer L3. This, in turn, may allow for extraction of relatively greater quantities of plasma from blood samples, whether the samples come from a single first tube 1005 or a pair of tubes 1005, on the order of milliliters, compared to the quantities obtained using other systems, which are on the order of hundreds of micrometers. This arrangement also ensures that genomic components of the cfDNA are collected in the plasma.

By virtue of spinning blood samples to isolate plasma, and then transferring the isolated plasma and spinning that plasma a second time, it is possible to refine the quality of the plasma isolated from the blood sample, by minimizing the presence of red blood cells or buffy coat red matter (e.g., contents of white blood cells and platelets) in the plasma output to the output containers 1030. This may promote the accuracy of subsequent processing and/or testing.

The automated liquid handling system 1000 may additionally or alternatively provide for continued processing that does not require human intervention, or requires little human intervention. This may inhibit the risk of contamination and/or misplacement of samples, which may occur when samples are handled and/or transferred manually. Further, the automated systems described herein may provide in-line quality control that may otherwise be difficult and/or time consuming with traditional liquid processing. In other words, the automated liquid processing system 1000 may avoid human error in the liquid handling processes described herein. The automated liquid handling system 1000 may also provide traceability of blood samples and plasma through the entire system 1000. That is, the precise location of any blood sample and/or volume of isolated plasma from a blood sample may be determined by the controller 7000, if needed.

Specifically with regards to the excising station 4055, the relative arrangement of the first tubes 1005 on the lift 4145 and the blades 4150 on blade actuators 4155, and the relative motion of the lift 4145 to the blades 4150, may allow for removal of any material, such as labels, on an exterior surface of the first tube 1005, and for promoting consistency in creating a “window” through each first tube 1005 for viewing layers of subcomponents of a liquid within the first tube 1005. That is, opposing exterior sides of the first tube 1005 are scraped and cleared of material, and as a result, a level or a height of each separated layer of liquid in the first tubes 1005 may be visible through the window. More specifically, building on the example of blood samples noted above, the window of each first tube 1005 may allow for clear and consistent visual inspection of a height of a plasma layer L1, a height of a red blood cell layer L3, a height of a buffy coat red layer L2 in between the plasma layer L1 and the red blood cell layer L3, these layers resulting from the first spin carried out in the second module 3000. Further, the excising station 4055 may create a consistent viewing window on the first tubes 1005 regardless of the number of labels on the first tubes 1005 or the locations of the labels on the first tubes 1005.

In addition, by virtue of the lift 4145 holding the first tubes 1005 steady and moving in a single, upward direction, while the blades 4150 move to scrape the material off the first tubes 1005, and then imaging the first tubes 1005 immediately thereafter, as described herein, the first tubes 1005 may be maintained in the same orientation throughout the excising process (that is, the first tubes 1005 remain upright), to inhibit or prevent disturbance of the separated subcomponents of the liquid in the first tubes 1005. Further, by pushing the lift 4145 up from a bottom thereof, a sufficient pushing force may be generated, without jeopardizing the integrity of the first tubes 1005 or causing misalignment or tilting of the first tubes 1005. Accordingly, this arrangement may inhibit breakage of the first tubes 1005.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as “about,” “approximately,” “substantially,” and “generally,” are used to indicate a possible variation of +10% of a stated or understood value. In addition, the term “between” used in describing ranges of values is intended to include the minimum and maximum values described herein. The use of the term “or” in the claims and specification is used to mean “and/or” unless explicitly indicated to refer to alternatives only if the alternatives are mutually exclusive, although the disclosure supports a definition that refers to only alternatives and “and/or.” As used herein “another” may mean at least a second or more.

As used herein, the term “user” generally encompasses any person or entity, such as a researcher and/or a care provider (e.g., a doctor, etc.), that may desire information, resolution of an issue, or engage in any other type of interaction with a provider of the systems and methods described herein (e.g., via an application interface resident on their electronic device, etc.). The term “electronic application” or “application” may be used interchangeably with other terms like “program,” or the like, and generally encompasses software that is configured to interact with, modify, override, supplement, or operate in conjunction with other software.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

It should be understood that although the present disclosure has been made with reference to preferred embodiments, exemplary embodiments, and optional features, modifications and variations of the concepts herein disclosed may be resorted to by those skilled in the art, and that such modifications and variations are considered to be within the scope of this disclosure as defined by the appended claims. The specific embodiments and examples provided herein are examples of useful embodiments of the present disclosure and are non-limiting and illustrative only. It will be apparent to one skilled in the art that the present disclosure may be carried out using a large number of variations of the devices, device components, methods, and steps set forth in the present description. As will be recognized by one of skill in the art, methods and devices useful for the present methods can include a large number of various optional compositions and processing elements and steps.

1. A method of processing liquid samples, the method comprising:
receiving a plurality of liquid samples, each liquid sample being contained within a sample collection tube, and wherein the plurality of liquid samples include either or both of (i) two liquid samples from the same individual, or (ii) one liquid sample from an individual;
centrifuging the plurality of liquid samples a first time to separate out a subcomponent of interest;
imaging the plurality of liquid samples to determine a height of the subcomponent of interest in each sample collection tube;
aspirating out the subcomponent of interest from the plurality of sample collection tubes and dispensing the aspirated subcomponent of interest into a plurality of processing tubes, wherein all of the aspirated subcomponent of interest for the same individual is deposited into one processing tube, such that the subcomponent of interest from the two liquid samples from the same individual are deposited into one processing tube, and the subcomponent of interest from the one liquid sample from the individual is deposited into one processing tube;
centrifuging the plurality of liquid samples in the plurality of processing tubes a second time to further separate out the subcomponent of interest; and
outputting the separated subcomponent of interest from each of the plurality of liquid samples in the plurality of processing tubes into a plurality of output containers.

2. The method of claim 1, wherein the plurality of liquid samples are blood samples.

3. The method of claim 2, wherein the subcomponent of interest is plasma.

4. The method of claim 1, wherein the plurality of liquid samples are urine samples.

5. The method of claim 1, wherein the plurality of output containers includes at least one of deep well plates or micronic tubes.

6. The method of claim 5, wherein the plurality of output containers includes deep well plates, and when the separated subcomponent of interest is output into a deep well plate, one or more wells of the deep well plate is left empty.

7. The method of claim 5, wherein the plurality of output containers includes both deep well plates and micronic tubes.

8. The method of claim 7, wherein the outputting step further comprises determining a total volume of the subcomponent of interest in a given processing tube of the plurality of processing tubes relative to a first threshold or a second threshold, wherein:
if the total volume of the subcomponent of interest is less than the first threshold, then all of the subcomponent of interest is deposited into a deep well plate,
if the total volume of the subcomponent of interest is greater than or equal to the first threshold and less than the second threshold, then a predetermined volume of the subcomponent of interest is deposited into the deep well plate, and a remaining volume of the subcomponent of interest is deposited into a micronic tube, and
if the total volume of the subcomponent of interest is greater than or equal to the second threshold, then the volume of the subcomponent of interest is divided between the deep well plate and the micronic tube.

9. The method of claim 7, wherein the outputting step further comprises determining whether the total volume of the subcomponent of interest in a given processing tube of the plurality of processing tubes is greater than or less than a threshold, wherein:
if the total volume of the subcomponent of interest is less than or equal to a threshold, then all of the subcomponent of interest is deposited into a deep well plate, and
if the total volume of the subcomponent of interest is greater than the threshold, then a predetermined volume of the subcomponent of interest is deposited into the deep well plate, and a remaining volume of the subcomponent of interest is deposited into a micronic tube.

10. The method of claim 1, further comprising excising portions of a label on opposite outer surfaces of each of the sample collection tubes prior to the imaging step.

11. The method of claim 1, wherein after the imaging step, the method further comprises performing a color analysis on a portion of a captured image showing the subcomponent of interest to determine whether a quality of the subcomponent of interest is sufficient for processing.

12. The method of claim 11, wherein performing the color analysis comprises comparing the portion of the captured image to a color chart, and assessing a color of the subcomponent of interest relative to the color chart.

13. The method of claim 11, wherein performing the color analysis comprises assessing a color of the subcomponent of interest relative to a stored color value.

14. A label excising station, comprising:
a pair of blades spaced apart from one another and located opposite from one another;
a pair of blade actuators, wherein each blade of the pair of blades is rotatably mounted on one of the pair of blade actuators; and
a platform positioned below the pair of blades, wherein the platform is configured to receive a sample collection tube, wherein the platform is configured to move between a first position and a second position, wherein in the first position, the platform is spaced relatively further away from the pair of blades, and wherein in the second position, the platform is spaced relatively closer to the pair of blades.

15. The label excising station of claim 14, wherein the pair of blade actuators is configured to move between a first spacing and a second spacing, wherein in the first spacing, a first blade of the pair of blades is spaced apart from a second blade of the pair of blades a distance that is approximately equal to a width of the sample collection tube to be received on the platform, and wherein in the second spacing, the first blade of the pair of blades is spaced apart from the second blade of the pair of blades a distance that is greater than the first spacing.

16. The label excising station of claim 14, comprising a plurality of pairs of blades and a plurality of pairs of blade actuators.

17. The label excising station of claim 14, further comprising a force sensor operably coupled to at least one of the blade actuators or the platform.

18. The label excising station of claim 14, further comprising an excising robot having an end effector, wherein the end effector is configured to grip the sample collection tube, and the excising robot is configured to move the sample collection tube onto the platform while the end effector grips the sample collection tube.

19. The label excising station of claim 18, wherein the end effector comprises a set of tube grips configured to grasp a top of the sample collection tube.

20. A method of excising a label from a sample collection tube, the method comprising:
placing the sample collection tube on a platform;
moving a pair of blade actuators so as to position blades rotatably mounted on the pair of actuators apart from one another a distance approximately equal to a width of the sample collection tube; and
moving the platform towards the blades so that the sample collection tube is pushed upwards between the blades mounted on the pair of actuators while the blades contact opposing sides of the sample collection tube.

21. The method of claim 20, further comprising rotating the blades on the pair of blade actuators so that different portions of the blades are configured to contact a subsequent sample collection tube passing therebetween.
